(19) United States
(12) Patent Application Publication
(10) Pub. No.: US 2023/0276801 A1
(43) Pub. Date: Sep. 7, 2023

(54) METHODS AND COMPOSITIONS TO IMPROVE PLANT HEALTH AND PROTECTION

(71) Applicants: UNIVERSIDAD POLITECNICA DE MADRID, Madrid (ES); PLANT RESPONSE, INC., Durham, NC (US)

(72) Inventors: Hugo MÉLIDA MARTÍNEZ, Valladolid (ES); Diego REBAQUE MORÁN, León (ES); Lucía JORDÁ MIRÓ, Madrid (ES); Irene DEL HIERRO GARCÍA, Madrid (ES); Laura BACETE CANO, Cuenca (ES); Gemma LOPEZ, Madrid (ES); Rosa Maria PÉREZ JIMÉNEZ, Madrid (ES); Frédéric BRUNNER, Konstanz (DE); Antonio MOLINA FERNÁNDEZ, Madrid (ES)

(21) Appl. No.: 18/006,881

(22) PCT Filed: Jul. 27, 2021
(86) PCT No.: PCT/EP2021/071085

§ 371 Date: Jan. 26, 2023

(30) Foreign Application Priority Data
Jul. 27, 2020 (EP) 20382671.4
Oct. 9, 2020 (EP) 20382893.4
Dec. 9, 2020 (EP) 20383070.8

(51) Int. Cl. A01N 43/16; A01P 21/00

(52) U.S. Cl. CPC A01N 43/16; A01P 21/00

(57) ABSTRACT

The present invention is directed to methods and compositions for increasing a growth characteristic of a plant, increasing nutrient use efficiency of a plant, or improving a plant’s ability to overcome biotic or abiotic stress comprising applying a composition comprising mixed linked β-1,3/β-1,4 glucans (MLGs) to a plant, plant part, propagation material of the plant, or to the soil, hydroponic solution or growth media in which a target plant is growing.

### STATEMENT OF PRIORITY

This application claims the benefit, under 35 U.S.C. § 119 (d), of European Patent Application No. EP20382671.4, filed on Jul. 27, 2020, European Patent Application No. EP20382893.4, filed on Oct. 9, 2020, and European Patent Application No. EP20383070.8, filed on Dec. 9, 2020, the entire contents of each of which are incorporated by reference herein.

### FIELD OF INVENTION

The present invention is directed to methods and compositions for increasing a growth characteristic of a plant, increasing nutrient use efficiency of a plant, or improving a plant’s ability to overcome biotic or abiotic stress comprising applying a composition comprising mixed linked β-1,3/β-1,4 glucans (MLGs) to a plant and/or part thereof, and/or growth media.

### BACKGROUND

Plants have evolved a complex immune system comprised by several defense layers. One of these layers is known as Pattern-Triggered Immunity (PTI) and is based in the recognition by plasma membrane-resident Pattern Recognition Receptors (PRRs) of Damage/Microbe-Associated Molecular Patterns (DAMPs/MAMPs). PTI responses feed into protein kinase signaling cascades, ending-up in gene reprogramming processes that may ultimately allow plant surveillance to pathogen/pest attack. The relevance of PTI is well-illustrated by the fact that immune responses and disease resistance to pathogens are compromised in plants defective in PRRs perceiving DAMPs/MAMPs. Examples of MAMPs that induce PTI in plants are eubacterial flagellin and peptidoglycan, lipopolysaccharides (LPS) from gram negative bacteria or fungal cell wall-derived glucans, chitins, mannans and proteins.

Glucans represent a group of widely distributed polysaccharides mainly in the extracellular layers of numerous phylogenetic groups across the tree of life. These include a wide variety of structures, mainly with β -linkages, although α -linked glucans also occur in many species. Mixed-linked glucans [MLGs; β-1,3/1,4-glucans; (1,3;1,4)-β-D-glucans] consist of unbranched and unsubstituted chains of β-1,4-glucosyl residues discontinued by β-1,3-linkages. MLGs are widely distributed as matrix polysaccharides in cell walls of the Poaceae, but have been also reported in other groups such as in the cell walls of Equisetum spp. and other vascular plants outside of the Poaceae, as well as bryophytes and algae, lichen-forming ascomycete symbionts and fungi. β-Glucans are well-known modulators of the immune system in mammals, but little is known about their roles in plants.

There is socio-economical pressure to provide alternatives that replace or reduce the use of agrochemicals in agriculture with a focus on the development of natural products, for a more environment-friendly and sustainable solution. The present invention overcomes the shortcomings in the art by providing novel composition and methods for use in agriculture that are more environmentally friendly.

### SUMMARY OF THE INVENTION

The following embodiments and aspects thereof are described and illustrated in conjunction with products and methods, which are meant to be exemplary and illustrative, not limiting in scope.

The present disclosure has applications in the agronomic sector. One embodiment provides methods and compositions for increasing a growth characteristic of a plant comprising applying a composition comprising MLGs to a plant and/or part thereof and/or to the media in which a plant and/or part thereof is growing.

Another embodiment provides increasing nutrient use efficiency of a plant comprising applying a composition comprising MLGs to a plant and/or part thereof and/or to the media in which a plant and/or part thereof is growing.

An additional embodiment provides increasing biotic and/or abiotic stress tolerance or resistance in a plant and/or part thereof comprising applying a composition comprising MLGs to a plant and/or part thereof and/or to the media in which a plant and/or part thereof is growing.

In some embodiments, a composition comprising MLGs may further comprise, a surfactant, a humectant, an adjuvant, an antioxidant, a preservative, a plant macronutrient, a plant micronutrient, a plant growth regulator, a pesticide, a fungicide, an antiviral, an anti-bacterial, and/or an herbicide.

These and other aspects of the invention are set forth in more detail in the description of the invention below.

### BRIEF DESCRIPTION OF THE DRAWINGS

FIG. 1 shows MGLs trigger cytoplasmid calcium elevations in Arabidopsis thaliana.

FIG. 2. Shows a bacterial crop protection assay in tomato plants treated with MLG43.

FIG. 3. Shows a B. cinerea crop protection assay in pepper plants treated with MLG43.

FIG. 4. Shows a second B. cinerea crop protection assay in pepper plants treated with MLG43

FIG. 5. Shows an Oomycete crop protection assay in Arabidopsis plants treated with MLG43

FIG. 6. Shows a Z tritici crop protection assay in wheat plants treated with MLG43.

### DETAILED DESCRIPTION OF THE INVENTION

The present invention now will be described hereinafter with reference to the accompanying drawings and examples, in which embodiments of the invention are shown. This description is not intended to be a detailed catalog of all the different ways in which the invention may be implemented, or all the features that may be added to the instant invention. For example, features illustrated with respect to one embodiment may be incorporated into other embodiments, and features illustrated with respect to a particular embodiment may be deleted from that embodiment. Thus, the invention contemplates that in some embodiments of the invention, any feature or combination of features set forth herein can be excluded or omitted. In addition, numerous variations and additions to the various embodiments suggested herein will be apparent to those skilled in the art in light of the instant disclosure, which do not depart from the instant invention. Hence, the following descriptions are intended to illustrate some particular embodiments of the invention, and not to exhaustively specify all permutations, combinations, and variations thereof.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

All publications, patent applications, patents and other references cited herein are incorporated by reference in their entireties for the teachings relevant to the sentence and/or paragraph in which the reference is presented.

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a composition comprises components A, B and C, it is specifically intended that any of A, B or C, or a combination thereof, can be omitted and disclaimed singularly or in any combination.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

The term “about,” as used herein when referring to a measurable value such as an amount or concentration and the like, is meant to encompass variations of ± 10%, ± 5%, ± 1%, ± 0.5%, or even ± 0.1% of the specified value as well as the specified value. For example, “about X” where X is the measurable value, is meant to include X as well as variations of ± 10%, ± 5%, ± 1%, ± 0.5%, or even ± 0.1% of X. A range provided herein for a measurable value may include any other range and/or individual value therein.

As used herein, phrases such as “between X and Y” and “between about X and Y” should be interpreted to include X and Y. As used herein, phrases such as “between about X and Y” mean “between about X and about Y” and phrases such as “from about X to Y” mean “from about X to about Y.”

The term “comprise,” “comprises” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention. Thus, the term “consisting essentially of” when used in a claim of this invention is not intended to be interpreted to be equivalent to “comprising.”

As used herein, the terms “increase,” “increasing,” “increased,” “enhance,” “enhanced,” “enhancing,” and “enhancement” (and grammatical variations thereof) describe an elevation of at least about 5%, 10%, 15%, 20%, 25%, 50%, 75%, 100%, 150%, 200%, 300%, 400%, 500% or more as compared to a control.

As used herein, the terms “reduce,” “reduced,” “reducing,” “reduction,” “diminish,” and “decrease” (and grammatical variations thereof), describe, for example, a decrease of at least about 5%, 10%, 15%, 20%, 25%, 35%, 50%, 75%, 80%, 85%, 90%, 95%, 97%, 98%, 99%, or 100% as compared to a control. In particular embodiments, the reduction can result in no or essentially no (i.e., an insignificant amount, e.g., less than about 10% or even 5%) detectable activity or amount.

As used herein, “a plant” can be, but is not limited to, any monocotyledonous and dicotyledonous plant, and any annual and perennial dicotyledonous and monocotyledonous plant. Example plants include, but are not limited to, those of the genera Glycine, Vitis, Asparagus, Populus, Pennisetum, Lolium, Oryza, Zea, Avena, Hordeum, Secale, Triticum, Helianthus, Gossypium, Medicago, Pisum, Acer, Actinidia, Abelmoschus, Agropyron, Allium, Amaranthus, Apium, Arachis, Asparagus, Beta, Brassica, Camellia, Canna, Capsicum, Carex, Carica papaya, Carya, Castanea, Cinnamomum, Citrullus, Citrus, Cocos, Coffea, Colocasia, Cola, Coriandrum, Corylus, Crataegus, Crocus, Cucurbita, Cucumis, Cynara, Daucus, Desmodium, Dimocarpus, Dioscorea, Diospyros, Echinochloa, Elaeis, Eleusine, Eriobotrya, Eugenia, Fagopyrum, Fagus, Ficus, Fortunella, Fragaria, Ginkgo, Hemerocallis, Hibiscus, Ipomoea, Juglans, Lactuca, Lathyrus, Lens, Linum, Litchi, Lotus, Lupinus, Luzula, Malus, Malpighia, Mammea, Mangifera, Manihot, Manilkara, Medicago, Melilotus, Mentha, Miscanthus, Musa, Nicotiana, Olea, Opuntia, Ornithopus, Panicum, Passiflora, Persea, Phaseolus, Pinus, Pistacia, Pisum, Poa, Prosopis, Prunus, Quercus, Raphanus, Rheum, Ribe, Rubus, Sambucus, Secale, Sesamum, Sinapis, Solanum, Sorghum, Spinacia, Tamarindus, Theobroma, Trifolium, Tropaeolum, Vaccinium, Vigna, Vitis, Zizania or Ziziphus Sorghum, Saccharum and Lycopersicum, or the class Liliatae. In some embodiments, a plant or part thereof is from the genera Glycine, Vitis, Asparagus, Populus, Pennisetum, Lolium, Oryza, Zea, Avena, Hordeum, Secale, Triticum, Sorghum, Saccharum and Lycopersicum, or the class Liliaceae.

As used herein, a “part thereof” includes, but is not limited to, plant reproductive tissues (e.g., petals, sepals, stamens, pistils, receptacles, anthers, pollen, flowers, fruits, flower buds, ovules, seeds, embryos, nuts, kernels, bulbs, ears, cobs and husks); plant vegetative tissues (e.g., petioles, stems, roots, root hairs, root tips, pith, coleoptiles, stalks, shoots, branches, bark, apical meristem, axillary bud, cotyledon, hypocotyls, and leaves); plant vascular tissues (e.g., phloem and xylem); specialized plant cells such as epidermal cells, parenchyma cells, collenchyma cells, sclerenchyma cells, stomata, guard cells, cuticle, mesophyll cells; callus tissue; and cuttings. It also includes plant cells, including plant cells that are intact in plants and/or parts of plants, plant protoplasts, plant tissues, plant organs, plant cell tissue cultures, plant calli, plant clumps, and the like.

A “growth media” or “growing media”, as used herein includes, but is not limited to soil, synthetic growth media and/or aqueous solution in which the plant is planted (e.g., a hydroponic solution). A growing media may be treated/contacted with a composition comprising MLGs before and/or after sowing seedlings or seeds including spraying or irrigating the growth medium with a composition comprising MLGs. For example, a composition comprising MLGs formulated into a liquid or solid formulation, such as a granule, may be applied to soil around seedlings prior to, during and/or after sowing the seedlings. In some aspects, both a growth medium and the plant or plant part planted or sowed in the same may be treated/contacted with a composition comprising MLGs.

As used herein, “growth characteristic” refers to any plant trait associated with growth, for example, biomass, root mass, yield, inflorescence size/weight, fruit yield, fruit quality, fruit size, seed production, foliar tissue weight, nodulation number, nodulation mass, nodulation activity, number of seed heads, number of tillers, number of flowers, number of tubers, tuber mass, bulb mass, number of seeds, total seed mass, rate of leaf emergence, rate of tiller emergence, rate of seedling emergence or any combination thereof. Thus, in some aspects, an increased growth characteristic may include, but is not limited to, increased fruit production, increased inflorescence production, increased fruit quality, increased root mass and/or biomass as compared to a control plant and/or part thereof and/or growth media where a composition comprising MLGs has not been applied.

“Fruit quality” refers to the typical fruit quality characteristics such as appearance: fruit size, diameter (e.g., inches, centimeters) and/or weight (g). Other fruit quality characteristics can include, but are not limited to, color (e.g., lycopene content in tomatoes), taste (sweetness, sourness, bitterness, etc.) and/or nutrient and/or nutritional content (e.g., sugar content (Brix value), proteins, lipids, vitamins, and/or minerals, etc.).

As used herein, “nutrient use efficiency” refers to a plant’s ability to utilize available nutrients. In some embodiments, “nutrient use efficiency may be defined in terms of total nutrient uptake (nutrient concentration in plant tissue × total biomass) and/or yield per unit of nutrient applied.

The term “abiotic stress” as used herein refers to outside, nonliving, factors which can cause harmful effects to plants. Thus, as used herein, abiotic stress includes, but is not limited to, cold temperature that results in freezing, chilling, heat or high temperatures, drought, high light intensity, low light intensity, salinity, flooding (excess water/water-logging), ozone, and/or combinations thereof. Parameters for the abiotic stress factors are species specific and even variety specific and therefore vary widely according to the species/variety exposed to the abiotic stress. Thus, while one species may be severely impacted by a high temperature of 23° C., another species may not be impacted until at least 30° C., and the like. Temperatures above 30° C. result in dramatic reductions in the yield of most plants. This is due to reductions in photosynthesis that begin at approximately 20-25° C., and the increased carbohydrate demands of crops growing at higher temperatures. The critical temperatures are not absolute, but vary depending upon such factors as the acclimatization of plants to prevailing environmental conditions. In addition, because most plants are exposed to multiple abiotic stresses at one time, the interaction between the stresses affects the response of the plant. Thus, the particular parameters for high/low temperature, light intensity, drought and the like, which impact plant productivity will vary with species, variety, degree of acclimatization and the exposure to a combination of environmental conditions.

The inventors of the present invention have discovered that treating a plant and/or part thereof, and/or a growth medium for growing a plant, with a composition comprising an effective amount/rate of MLGs can increase a growth characteristic, nutrient use efficiency, and/or abiotic and/or biotic stress tolerance/resistance of the plant and/or part thereof.

In some embodiments, a composition may comprise a single MGL or a mixture of MLGs with a degree of polymerization (DP) in a range from about DP3 to about DP >100. Thus, in some embodiments, a composition of the invention may comprise an MLG of DP3 (also referred to herein as “MLG43”), and/or DP4, and/or DP5, and/or DP6, and/or DP7, and/or DP8, and/or DP9, and/or DP10, and/or DP11, and/or DP12, and/or DP13, and/or DP14, and/or DP15, and/or DP16, and/or DP17, and/or DP18, and/or DP20, and/or DP21, and/or DP22, and/or DP23, and/or DP24, and/or DP25, and/or DP26, and/or DP27, and/or DP28, and/or DP29, and/or DP30, and/or DP40, and/or DP50, and/or DP60, and/or DP70, and/or DP80, and/or DP90, and/or DP100, and/or DP>100 and any range or value therein. In some embodiments, a composition may comprise a mixture of MLGs of DP from about DP3 to about DP6, from about DP3 to about DP7, from about DP3 to about DP8, from about DP3 to about DP9, from about DP3 to about DP10, from about DP3 to about DP15, about DP3 to about DP20, about DP3 to about DP30, about DP3 to about DP40, about DP3 to about DP50, about DP3 to about DP60, about DP3 to about DP70, about DP3 to about DP80, about DP3 to about DP90, about DP3 to about DP100, from about DP5 to about DP8, from about DP5 to about DP9, from about DP5 to about DP10, from about DP5 to about DP15, about DP5 to about DP20, about DP5 to about DP50, about DP5 to about DP40, about DP5 to about DP50, about DP5 to about DP60, about DP5 to about DP70, about DP5 to about DP80, about DP5 to about DP90, about DP5 to about DP100, about DP10 to about DP15, about DP10 to about DP20, about DP10 to about DP30, about DP10 to about DP40, about DP10 to about DP50, about DP10 to about DP60, about DP10 to about DP70, about DP10 to about DP80, about DP10 to about DP90, about DP10 to about DP100, about DP20 to about DP30, about DP20 to about DP40, about DP120 to about DP50, about DP20 to about DP60, about DP20 to about DP70, about DP20 to about DP80, about DP20 to about DP90, about DP20 to about DP100, DP40 to about DP50, about DP40 to about DP60, about DP40 to about DP70, about DP40 to about DP80, about DP40 to about DP90, about DP40 to about DP100, DP50 to about DP70, about DP50 to about DP80, about DP50 to about DP90, about DP50 to about DP100, and any range or value therein.

In some embodiments, a composition may comprise an amount of MLGs (comprising a single degree of polymerization or a mixture of degree of polymerization) in a range from about 0.1 mg per liter (L) to about 100 g per liter of the composition. Thus, in some embodiments, a composition of the invention may comprise MLGs in a range from about 0.1 mg/L to about 1 mg/L, about 0.1 mg/L to about 10 mg/L, about 0.1 mg/L to about 100 mg/L, about 0.1 mg/L to about 1 g/L, about 0.1 mg/L to about 10 g/L, about 0.1 mg/L to about 100 g/L, about 0.1 g/L to about 1 g/L, about 0.1 g/L to about 5 g/L, about 0.1 g/L to about 10 g/L, about 0.1 g/L to about 15 g/L, about 0.1 g/L to about 20 g/L, about 0.1 g/L to about 30 g/L, about 0.1 g/L to about 40 g/L, about 0.1 g/L to about 100 g/L, about 0.5 g/L to about 1 g/L, about 0.5 g/L to about 5 g/L, about 0.5 g/L to about 10 g/L, about 0.5 g/L to about 20 g/L, about 0.5 g/L to about 30 g/L, about 0.5 g/L to about 40 g/L, about 0.5 g/L to about 50 g/L, about 0.5 g/L to about 100 g/, about 1 g/L to about 5 g/L, about 1 g/L to about 10 g/L, about 1 g/L to about 15 g/L, about 1 g/L to about 20 g/L, about 1 g/L to about 30 g/L, about 1 g/L to about 40 g/L, about 1 g/L to about 50 g/L, about 1 g/L to about 100 g/L, about 5 g/L to about 10 g/L, about 5 g/L to about 15 g/L, about 5 g/L to about 20 g/L, about 5 g/L to about 30 g/L, about 5 g/L to about 40 g/L, 1, about 5 g/L to about 50 g/L, about 5 g/L to about 100 g/L, about 10 g/L to about 15 g/L, about 10 g/L to about 20 g/L, about 10 g/L to about 30 g/L, about 10 g/L to about 40 g/L, about 10 g/L to about 50 g/L, about 10 g/L to about 100 g/L, about 15 g/L to about 20 g/L, about 15 g/L to about 30 g/L, about 15 g/L to about 40 g/L, about 15 g/L to about 50 g/L, about 15 g/L to about 100 g/L, about 20 g/L to about 30 g/L, or about 20 g/L to about 40 g/L, about 20 g/L to about 50 g/L, about 20 g/L to about 100 g/L, about 30 g/L to about 40 g/L, about 30 g/L to about 50 g/L,, about 30 g/L to about 100 g/L, about 40 g/L to about 50 g/L, or about 40 g/L to about 100 g/L of the composition, or any value or range therein.

In some embodiments, an effective amount of MLGs is an amount sufficient to increase a growth characteristic of a plant and/or part thereof, increase nutrient use efficiency in a plant and/or part thereof, and/or increase abiotic stress and/or biotic stress tolerance/resistance of a plant and/or part thereof. In some embodiments, an effective amount of MLGs in a composition may be from about 0.1 mg per liter to about 100 g per liter of the composition. In some embodiments, an effective amount of MLGs in a composition may be from about 0.1 mg/L to about 1 mg/L, about 0.1 mg/L to about 10 mg/L, about 0.1 mg/L to about 100 mg/L, about 0.1 mg/L to about 1 g/L, about 0.1 mg/L to about 10 g/L, about 0.1 mg/L to about 100 g/L, about 0.1 g/L to about 1 g/L, about 0.1 g/L to about 5 g/L, about 0.1 g/L to about 10 g/L, about 0.1 g/L to about 15 g/L, about 0.1 g/L to about 20 g/L, about 0.1 g/L to about 30 g/L, about 0.1 g/L to about 40 g/L, about 0.1 g/L to about 100 g/L, about 0.5 g/L to about 1 g/L, about 0.5 g/L to about 5 g/L, about 0.5 g/L to about 10 g/L, about 0.5 g/L to about 20 g/L, about 0.5 g/L to about 30 g/L, about 0.5 g/L to about 40 g/L, about 0.5 g/L to about 50 g/L, about 0.5 g/L to about 100 g/, about 1 g/L to about 5 g/L, about 1 g/L to about 10 g/L, about 1 g/L to about 15 g/L, about 1 g/L to about 20 g/L, about 1 g/L to about 30 g/L, about 1 g/L to about 40 g/L, about 1 g/L to about 50 g/L, about 1 g/L to about 100 g/L, about 5 g/L to about 10 g/L, about 5 g/L to about 15 g/L, about 5 g/L to about 20 g/L, about 5 g/L to about 30 g/L, about 5 g/L to about 40 g/L, 1, about 5 g/L to about 50 g/L, about 5 g/L to about 100 g/L, about 10 g/L to about 15 g/L, about 10 g/L to about 20 g/L, about 10 g/L to about 30 g/L, about 10 g/L to about 40 g/L, about 10 g/L to about 50 g/L, about 10 g/L to about 100 g/L, about 15 g/L to about 20 g/L, about 15 g/L to about 30 g/L, about 15 g/L to about 40 g/L, about 15 g/L to about 50 g/L, about 15 g/L to about 100 g/L, about 20 g/L to about 30 g/L, or about 20 g/L to about 40 g/L, about 20 g/L to about 50 g/L, about 20 g/L to about 100 g/L, about 30 g/L to about 40 g/L, about 30 g/L to about 50 g/L,, about 30 g/L to about 100 g/L, about 40 g/L to about 50 g/L or about 40 g/L to about 100 g/L of the composition, or any value or range therein.

In some embodiments, a composition comprising MLGs may further comprise a peptide, a protein, a sugar and/or a carbohydrate. In some embodiments, a MLGs composition may comprise peptides and/or proteins in an amount from about 0.1% to about 10% w/w of the extract. In some embodiments, a composition comprising MLGs comprise peptides and/or proteins in an amount from about 0.1% to about 1%, about 0.1% to about 3%, about 0.1% to about 5%, about 0.1% to about 7%, about 0.5% to about 1%, about 0.5% to about 3%, about 0.5% to about 5%, about 0.5% to about 7%, about 0.5 to about 10%, about 1% to about 3%, about 1% to about 5%, about 1% to about 7%, about 1% to about 10%, about 3% to about 5%, about 3% to about 7%, about 3% to about 10%, about 5% to about 7%, about 5% to about 10%, or about 7% to about 10%, or any range or value therein of the composition. Thus, in some embodiments, a composition comprising MLGs may comprise peptides and/or proteins in an amount of about 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10% w/w or any range or value therein of the composition.

In some embodiments, a composition comprising MLGs may comprise others sugars and/or carbohydrates in an amount from about 1% to about 35% w/w of the extract. In some embodiments, a composition comprising MLGs may comprise others sugars and/or carbohydrates in an amount from about 1% to about 5%, about 1% to about 10%, about 1% to about 15%, about 1% to about 20%, about 1% to about 25%, about 1% to about 30%, about 5% to about 10%, about 5% to about 15%, about 5% to about 20%, about 5% to about 25%, about 5% to about 30%, about 5% to about 35%, about 10% to about 15%, about 10% to about 20%, about 10% to about 25%, about 10% to about 30%, about 10% to about 35%, about 15% to about 20%, about 15% to about 25%, about 15% to about 30%, about 15% to about 35%, about 20% to about 25%, about 20% to about 30%, about 20% to about 35%, about 25% to about 30%, about 25% to about 35%, or about 30% to about 35% w/w of the extract, or any value or range therein. Thus, in some embodiments, a composition comprising MLGs may comprise additional sugars and/or carbohydrates in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35% w/w of the extract or any range or value therein.

In some embodiments, sugars and/or carbohydrates that may be comprised in a composition comprising MLGs can include, but is not limited to glucose, mannose, galactose, arabinose, xylose other glucan oligosaccharides, glucose-derived low branched polysaccharides, glycogen, mannan oligosaccharides, mannose-derived low branched polysaccharides, galactans, galactomannans, arabinans and/or xylans.

In some embodiments, a composition comprising MLGs may further comprise additional components including, but not limited to, a surfactant, a humectant, an adjuvant, an antioxidant, a preservative, a plant macronutrient, a plant micronutrient, a plant growth regulator, a pesticide, a fungicide, an antiviral, an anti-bacterial, an herbicide, or any combination thereof.

Example surfactants can include, but are not limited to, alkali metal, alkaline earth metal and ammonium salts of ligno-sulfonic acid, naphthalenesulfonic acid, phenolsulfonic acid, dibutylnaphthalenesulfonic acid, alkylarylsulfonates, sodium dodecylsulfate, alkyl sulfates, alkylsulfonates, fatty alcohol sulfates, fatty acids and sulfated fatty alcohol glycol ethers, of sulfonated condensates naphthalene and naphthalene derivatives with formaldehyde, condensates of naphthalene or of naphthalenesulfonic acid with phenol and formaldehyde, polyoxyethylene octyl-phenyl ether, ethoxylated isooctylphenol, octylphenol, nonylphenol, alkylphenyl poly-glycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol, polyglycol ether acetal, sorbitol esters, lignin-sulfite waste liquors and/or methylcellulose.

In some embodiments, a surfactant may be present in a composition comprising MLGs in an amount from about 10% to about 40% w/w of the composition. In some embodiments, a surfactant may be present in a composition comprising MLGs in an amount from about 10% to about 15%, about 10% to about 20%, about 10% to about 25%, about 10% to about 30%, about 10% to about 35%, about 15% to about 20%, about 15% to about 25%, about 15% to about 30%, about 15% to about 35%, about 15% to about 40%, about 20% to about 25%, about 20% to about 30%, about 20% to about 35%, about 20% to about 40%, about 25% to about 30%, about 25% to about 35%, about 25% to about 40%, about 30% to about 35%, about 30% to about 40%, about 35% to about 40% w/w of the composition or any range or value therein). Thus, in some embodiments, the surfactant may be present in a composition comprising MLGs in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40% w/w of the composition or any range or value therein.

Example humectants can include, but are not limited to, glycerol, sorbitol, xylitol, maltitol, glyceryl triacetate, sodium lactate, urea formaldehyde, propylene glycol, ethylene glycol and/or fatty acids.

An example antioxidant can include, but is not limited to, ascorbic acid, tocopherols, propyl gallate, tertiary butylhydroquinone, butylated hydroxyanisole, and/or butylated hydroxytoluene.

An example preservative can include, but is not limited to, sorbic acid, sodium sorbate, sorbates, benzoic acid, sodium benzoate, benzoates, hydroxybenzoate and derivatives, sulfur dioxide and sulphites, nitrite, nitrate, lactic acid, propionic acid and sodium propionate, tocopherol, plant extract, hops, salt, sugar, vinegar, alcohol (e.g. methanol and ethanol), diatomaceous earth and castor oil, citric acid, ascorbic acid, sodium ascorbate, phenol derivatives (butylated hydroxytoluene, butylated hydroxyanisole, BHA, BHT, TBHQ and propyl gallate), gallic acid, sodium gallate, sulfur dioxide, sulphites, tocopherols, and/or methylchloroisothiazolinone, 1,2-Benzisothiazolin-3-one (BIT), Hexahydro-1,3,5-tris-hydroxyethyl -s-triazine (HTHT), 5-chloro-2-methyl-2H-isothiazol-3-one (CMIT), 2-methyl-2H-isothiazol-3-one (MIT), Zinc pyrithione (ZPT), 2-Bromo-2-nitropropane-1,3-diol (Bronopol), Formaldehyde, 1,3-Dimethylol-5,5-dimethylhydantoin (DMDMH), 2,2-Dibromo-3-nitrilopropionamide (DBNPA), and/or Poly (hexamethylene biguanide) hydrochloride (PHMB).

In some embodiments, a preservative may be present in a composition comprising MLGs in an amount ranging from about 0.001% to about 5% w/w or any range or value therein. In some embodiments, a composition may comprise a preservative in an amount ranging from about 0.001% to about 0.1%, about 0.001% to about 0.5%, about 0.001% to about 1%, about 0.001% to about 2%, about 0.001% to about 3%, about 0.001% to about 4%, about 0.01% to about 0.1%, about 0.01% to about 0.5%, about 0.01% to about 1%, about 0.01% to about 2%, about 0.01% to about 3%, about 0.01% to about 4%, about 0.01% to about 5%, about 0.05% to about 0.1%, about 0.05% to about 0.5%, about 0.05% to about 1%, about 0.05% to about 2%, about 0.05% to about 3%, about 0.05% to about 4%, about 0.05% to about 5%, about 0.1% to about 0.5%, about 0.1% to about 1%, about 0.1% to about 2%, about 0.1% to about 3%, about 0.1% to about 4%, about 0.1% to about 5%, about 0.5% to about 1%, about 0.5% to about 2%, about 0.5% to about 3%, about 0.5% to about 4%, about 0.5% to about 5%, about 1% to about 2%, about 1% to about 3%, about 1% to about 4%, about 1% to about 5%, about 2% to about 3%, about 2% to about 4%, about 4% to about 5%, about 3% to about 4%, about 3% to about 5%, about 4% to about 5% w/w of the composition, or any range or value therein. Thus, in some embodiments, the preservative may be present in a composition comprising MLGs in an amount of about 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5% w/w of the composition or any range or value therein.

Example plant macronutrients include, but are not limited to, nitrogen, potassium, calcium, magnesium, phosphorus, and/or sulfur.

Example plant micronutrients can include, but are not limited to, iron, manganese, boron, molybdenum, copper, zinc, chlorine, and/or cobalt.

Example plant growth regulators include, but are not limited to, auxin (including but not limited to naphthalene acetic acid (NAA) and/or indole-3-butyric acid (IBA) and/or indole-3-acetic acid (IAA, 3-IAA)), cytokinin, abscisic acid, gibberellin, ethylene, salicylic acid, jasmonic acid, brassinosteriod (e.g., brassinolide), or any combination thereof.

Example pesticides include, but are not limited to, malathion, parathion, methyl parathion, chlorpyrifos, diazinon, dichlorvos, phosmet, fenitrothion, tetrachlorvinphos, azamethiphos, fenvalerate, cyfluthrin, lambda-cyhalothrin, zeta-cypermethrin, permethrin, piperonyl butoxide, imidacloprid, acetamiprid, clothianidin, nitenpyram, nithiazine, thiacloprid, thiamethoxam, ryanodol, 9,21-didehydroryanodol, chlorantraniliprole, flubendiamide, and/or cyantraniliprole.

Example fungicides include, but are not limited to, prothioconazole, trifloxystrobin, azoxystrobin, propiconazole, and/or pyraclostrobin.

Example anti-bacterials (bactericides) include, but are not limited to, methylisothiazolinone, chloromethylisothiazolinone, benzisothiazolinone, octylisothiazolinone, dichlorooctylisothiazolinone, and/or butylbenzisothiazolinone

Example herbicides can include, but are not limited to, glyphosate, 2,4-dichlorophenoxyacetic acid, atrazine, S-metolachlor, and/or 3,6-dichloro-2-methoxybenzoic acid.

In some embodiments, a composition comprising MLGs may further comprise an antifoaming agent. Any antifoaming agent for use with agricultural and/or food products may be used. Example antifoaming agents include, but are not limited to, long chain unsaturated fatty acids including, but not limited to C12 to C14, C18:1 and C18:2 unsaturated fatty acids, and/or synthetic polysiloxanes (silicones) including, but not limited to, polydimethylsiloxane, and/or hydrophobic silica. In some embodiments, a composition comprising MLGs may comprise an amount of antifoaming agent in a range from about 0.0001% to about 0.05% w/w of the composition or any range or value therein. Thus, in some embodiments, the antifoaming agent may be present in the composition in an amount of about 0.0001%, 0.0002%, 0.0003%, 0.0004%, 0.0005%, 0.0006%, 0.0007%, 0.0008%, 0.0009%, 0.001%, 0.002%, 0.003%, 0.004%, 0.005%, 0.006%, 0.007%, 0.008%, 0.009%, 0.01%, 0.02%, 0.03%, 0.04%, or 0.05% w/w of the composition or any range or value therein.

In some embodiments, a composition comprising MLGs may further comprise a biocide. Any biocide for use with agricultural and/or food products may be used. When included in a composition comprising MLGs, a biocide may be present at about 0.1 g L⁻¹ to about 20 g L⁻¹ of the composition, or any range or value therein. Thus, in some embodiments, the biocide may be present in the composition in an amount of about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2, 3, 4, 5, 6, 7, 8, 9, 10, 11, 12, 13, 14, 15, 16, 17, 18, 19, or 20 g per liter of the composition, or any range or value therein.

A composition comprising MLGs may be applied to plant and/or part thereof. In some embodiments, a composition comprising MLGs may be atomized and sprayed on a plant and/or part thereof. A smearing treatment may also be used, for example, where a wettable powder, an emulsion or a flowable agent of a composition comprising MLGs may be applied to a plant and/or plant part thereof with or without water added. In another embodiments, an immersing treatment may be used in which a plant and/or part thereof are immersed in a composition comprising MLGs. In some embodiments, a composition comprising MLGs may be used in a film coating treatment and/or a pellet coating treatment for a plant and/or part hereof such as seeds and/or bulbs.

A composition comprising MLGs may be applied as a soil treatment in the form of a solid or a liquid. Thus, in some embodiments, the composition may be applied as a spray onto soil, soil incorporation, and/or perfusion of a chemical liquid into the soil (irrigation of chemical liquid, soil injection, and dripping of chemical liquid). Methods for applying a composition comprising MLGs during a soil treatment can include, but are not limited to, planting hole, furrow, around a planting hole, around a furrow, entire surface of cultivation lands, the parts between the soil and the plant, area between roots, area beneath the trunk, main furrow, growing box, seedling growing tray and seedbed. A soil treatment may be applied before seeding, at the time of seeding, immediately after seeding, germination and/or growing period after planting. Alternatively, an irrigation liquid may be mixed with a composition comprising MLGs in advance and, for example, used for treatment by an appropriate irrigating method including the irrigation method mentioned above and any other methods such as methods and compositions to improve plant health and protection.

A composition comprising MLGs may be applied to a plant and/or a plant part thereof, and/or to a medium in which a plant is growing for increasing, for example, a growth characteristic, nutrient use efficiency, disease tolerance (biotic stress, e.g., tolerance to fungal, bacterial, and/or viral diseases) and/or for increasing abiotic stress tolerance. Thus, in some embodiments, the present invention provides a method for increasing a growth characteristic of a plant and/or part thereof, the method comprising applying a composition comprising an effective amount of MLGs to a plant and/or part thereof and/or growth media, thereby increasing the growth characteristic of the plant and/or part thereof as compared to a control plant and/or part thereof (e.g., a plant and/or part thereof to which the composition of the invention has not been applied). In some embodiments, the method comprises applying a composition comprising MLGs to a plant and/or part thereof, and/or a growth media in which the plant and/or part thereof is present at least one time (e.g., about 1, 2, 3, 4, 5, 6, 7, 8, 9, 10, 11, and/or 12 or more times; e.g., 1 to about 2 times, 1 to about 3 times, 1 to about 4 times, 1 to about 5, times, 1 to about 6 times, 1 to about 7 times, 1 to about 8 times, 1 to about 9 times, 1 to about 10 times, 1 to about 11 times, or 1 to about 12 times, or any range or value therein). In some embodiments, the method comprises applying the composition at least two times (e.g., about 2, 3, 4, 5, 6, 7, 8, 9, 10, 11, 12 or more times; e.g., about 2 to about 3 times, about 2 to about 4 times, about 2 to about 5, times, about 2 to about 6 times, about 2 to about 7 times, about 2 to about 8 times, about 2 to about 9 times, about 2 to about 10 times, about 2 to about 11 times, or about 2 to about 12 times, or any range or value therein).

In some embodiments, the present invention provides a method for increasing disease tolerance of a plant and/or part thereof, the method comprising applying a composition comprising an effective amount of MLGs to a plant and/or a plant part thereof, and/or to a growth media, thereby increasing the disease tolerance of the plant and/or part thereof as compared to a control plant and/or part thereof (e.g., a plant and/or part thereof to which a composition comprising MLGs has not been applied). In some embodiments, the method comprises applying the composition at least one time (e.g., about 1, 2, 3, 4, 5, 6, 7, 8, 9, 10, 11, 12 or more times). In some embodiments, the method comprises applying the composition at least two times (e.g., about 2, 3, 4, 5, 6, 7, 8, 9, 10, 11, 12 or more times).

In some embodiments, when a composition comprising MLGs is applied at least two times to a plant and/or part thereof, and/or growth media, the range of time between application may vary. Thus, for example, a subsequent application of a composition comprising MLGs may be any time from about 1 day to about six month after the prior application. Thus, for example, a subsequent application may be applied about 1, 2, 3, 4, 5, 6 days or about 1, 2, 3, 4, 5, 6, 7, 8, 9, 10, 11, 12, 13, 14, 15, 16, 17, 18, 19, 20, 21, 22, 23, 24, 25, or 26 weeks after previous application, or any range or value therein.

In some embodiments, a composition comprising MLGs applied to a plant and/or part thereof, and/or to a growth media, may increase disease tolerance or resistance to a viral pathogen including, but not limited to, a virus from the virus family of Caulimoviridae, Potyviridae, Sequiviridae, Rheoviridae, Capillovirus, Geminiviridae, Bromoviridae, Closteroviridae, Comoviridae Tombusviridae, Rhabdoviridae, Bunyaviridae, Partitiviridae, Carlavirus, Enamovirus, Furovirus, Hordeivirus, Idaeovirus, Luteovirus, Marafivirus, Potexvirus, Sobemovirus, Tenuivirus, Tobamovirus, Tobravirus, Trichovirus, Tymovirus and/or Umbravirus.

In some embodiments, a composition comprising MLGs applied to a plant and/or part thereof, and/or to a growth media, may increase resistance to a virus, including but not limited to, turnip mosaic virus, papaya ring spot virus, bud blight virus, bean pod mottle virus, lettuce mosaic virus, maize mosaic virus, cauliflower mosaic virus, tobacco mosaic virus, soybean mosaic virus, African cassava mosaic virus, tomato mosaic virus, pepino mosaic virus, zucchini yellow mosaic virus, plum pox virus, tomato bushy stunt virus, tomato spot wilt virus, tomato yellow leaf curl virus, rice ragged stunt virus, rice tungro bacilliform, virus, rice tungro spherical virus, rice yellow mottle virus, cucumber mosaic virus, brome mosaic virus, wheat yellow mosaic virus, barley yellow dwarf virus, sugarcane mosaic virus, beet yellows virus, lettuce yellows virus, maize dwarf mosaic virus, maize streak virus, peanut stunt virus, Citrus tristeza virus, potato leafroll virus, potato virus X, potato virus Y, sweet potato feathery mottle potyvirus, Melon necrotic spot virus, maize white line mosaic virus, maize chlorotic mottle virus, banana bunchy top virus, cacao swollen shoot virus, tomato leaf curl New Dehli virus, banana streak virus, and/or sweet potato sunken vein closterovirus.

In some embodiments, a composition comprising MLGs applied to a plant and/or part thereof, and/or to a growth media, may increase resistance to a fungal pathogen including, but not limited to, a fungal/oomycete pathogen from the family of Physodermataceae, Synchytriaceae, Olpidiaceae, Choanephoraceae, Gilbertellaceae, Mucoraceae, Dipodascaceae, Eremotheciaceae, Taphrinaceae, Botryosphaeriaceae, Capnodiaceae, Phaeosphaeriaceae, Leptosphaeriaceae, Cucurbitariaceae, Didymellaceae Davidiellaceae, Mycosphaerellaceae, Schizothyriaceae, Dothideaceae, Dothioraceae, Lahmiaceae, Elsinoaceae, Lophiostomataceae, Pleosporaceae, Venturiaceae, Trichochomaceae, Erysiphaceae, Cyttariaceae, Hemiphacidiaceae, Hyaloscyphaceae, Phacidiaceae, Sclerotiniaceae, Ascodichaenaceae, Mediolariaceae, Rhytismataceae, Meliolaceae, Caloscyphaceae, Sarcosomataceae, Cryphonectriaceae, Diaporthaceae, Gnomoniaceae, Valsaceae, Glomerellaceae, Plectosphaerellaceae, Bionectriaceae, Clavicipitaceae, Hypocreaceae, Nectriaceae, Magnaporthaceae, Pyriculariaceae, Ceratocystideae, Ophiostomataceae, Phyllachoraceae, Chaetomiaceae, Amphisphaeriaceae, Diatrypaceae, Xylariaceae, Psathyrellaceae, Marasmiaceae, Mycenaceae, Schizophyllaceae, Typhulaceae, Thelephoraceae, Atheliaceae, Atheliaceae, Stereaceae, Echinodontiaceae, Corticiaceae, Ganodermataceae, Hymenochaetaceae, Cystofilobasidiaceae, Helicobasidiaceae, Helicobasidiaceae, Melampsoraceae, Phakopsoraceae, Pucciniaceae, Tilletiaceae, Entylomataceae, Ustilaginaceae, Leptolegniaceae and/or Peronosporaceae.

In some embodiments, a composition comprising MLGs applied to a plant and/or part thereof, and/or to a growth media, may increase resistance to a fungal pathogen including, but not limited to, Physoderma alfalfa, Physoderma maydis, Synchytrium endobioticum, Olpidium brassicae, Choanephora cucurbitarum, Mucor circinelloides, Rhizopus stolonifera, Geotrichum candidum, Taphrina caerulescens, Taphrina deformans, Taphrina populina, Botryosphaeria dothidea, Diplodia mutila, Dothiorella sarmentorum, Macrophomina phaseolina, Phyllosticta ampelicida, Phyllosticta citricarpa, Stenocarpella maydis, Cladosporium allii-cepae, Cladosporium cladosporioides, Acrodontium simplex, Cercospora spp., Cercospora apii, Cercospora beticola, Cercospora brassicicola, Cercospora kikuchii, Corynespora cassiicola, Cercospora zeae-maydis, Cercospora zeina, Dothistroma septosporum, Lecanosticta acicula, Mycocentrospora acerina, Passalora spp., Pseudocercospora fijiensis, Aureobasidium spp., Ophiosphaerella herpotricha, Parastagonospora nodorum, Diplodia tumefaciens, Alternaria alternate, Bipolaris maydis, Bipolaris oryzae, Bipolaris sacchari, Bipolaris victoriae, Curvularia spp., Leptosphaerulina trifolii, Venturia inaequalis, Aspergillus spp., Aspergillus flavus, Blumeria graminis, Erysiphe spp., Podosphaera leucotricha, Botrytis cinerea, Monilinia spp., Monilinia fructicola, Sclerotinia sclerotiorum, Amphilogia gyrosa, Cryphonectria parasitica, Diaporthe citri, Diaporthe helianthi, Diaporthe phaseolorum, Cytospora leucostoma, Colletotrichum spp., Colletotrichum coccodes, Colletotrichum gloeosporioides, Colletotrichum graminicola, Plectosphaerella cucumerina, Verticillium albo-atrum, Verticillium dahlia, Claviceps purpurea, Epichloe typhina, Trichoderma viride, Fusarium spp., Fusarium oxysporum, Fusarium solani, Fusarium graminearum, Nectria cinnabarina, Neonectria spp., Gaeumannomyces graminis, Pyricularia grisea, Pyricularia oryzae, Ceratocystis spp., Thielaviopsis basicola, Ophiostoma ulmi, Phyllachora graminis, Cronartium spp., Uromyces graminicola, Tranzschelia spp., Tilletia spp., Ustilago spp., Ustilago maydis, Peronospora spp., Hyalperonospora spp., Albugo spp., Phytophthora spp., Pythium spp., Aphanomyces spp., Magnaporthe oryzae, Puccinia, Blumeria graminis, Exserohilum turcicum, Mycosphaerella graminicola, Melampsora lini, Phakopsora pachyrhizi, and/or Rhizoctonia solani.

In some embodiments, a composition comprising MLGs applied to a plant and/or part thereof, and/or to a growth media, may increase resistance to a bacterial pathogen including, but not limited to, a bacterial pathogen from the family of Enterobacteriaceae, Pseudomonadaceae, Rhizobiaceae, Microbacteriaceae, Xanthomonadaceae, Rhizobiaceae, Corynebacteriaceae, Acetobacteraceae, Comamonadaceae, Bacillaceae, Burkholderiaceae, Micrococcaceae, Ralstoniaceae, Xanthomonadaceae, Spiroplasmataceae, Sphingomonadaceae, Acholeplasmataceae, Corynebacteriaceae, and/or Streptomycetaceae. In some embodiments, a composition of the invention applied to a plant and/or part thereof, and/or growth media, may increase resistance to a bacterial pathogen including, but not limited to, a bacterial pathogen from the genus of Erwinia spp., Dickeya spp., Pseudomonas spp., Xanthomonas spp., Agrobacterium spp., Rhizobium spp., Corynebacterium spp., Streptomyces spp., Pantoea spp., Serratia spp., Acetobacter spp., Acidovorax spp., Arthrobacter spp., Bacillus spp., Brenneria spp., Burkholderia spp., Clavibacter spp., Pectobacterium spp., Pantoea spp., Ralstonia spp., Xylella spp., Spiroplasma spp., Phytoplasma spp., and/or Sphingomonas spp.

In some embodiments, a composition comprising MLGs applied to a plant and/or part thereof, and/or to a growth medium, may increase resistance to a bacterial pathogen including, but not limited to, Erwinia amylovora, E.a carotovora var. chrysanthemi, D. dadanti, Pseudomonas tabaci, P. angulate, P. phaseolicola, P. lachrymans, P. pisi, P. fluorescens, P. glycinea, P. vesicatoria, P. savastanoi, P. syringae, P. solanacearum, Xanthamonas phaseoli, X. malvacearum, X. oryzae, X translucens, X. pruni, X. campestris, X. vasuclarum, Acidovorax avenae, Agrobacterium tumefaciens, A. rubi (=Rhizobium rubi), A. rhizogenes (=Rhizobium rhizogenes) and A. vitis (=Rhizobium vitis), Bacillus pumilus., Brenneria alni (= Erwinia alni), Clavibacter michiganensis, Pectobacterium carotovorum, Pantoea agglomerans, Ralstonia solanacearum, Corynebacterium insidiosum, C. sepedonicum, C. fascians, C. flacumfaciens, C. michiganense, Streptomyces scabies, S. ipomoeae, Pantoea agglomerans, Serratia marcescens, Streptomyces reticuliscabei, Acetobacter aceti, Spiroplasma citri Xylella fastidiosa, and/or Sphingomonas melonis.

As used herein, “disease resistance” or “disease tolerance” are used interchangeably and refer to a decrease in disease symptoms and/or a decrease pathogen growth and reproduction of a plant and/or part thereof. In some embodiments, the percent (%) increase in resistance/tolerance to disease as compared to a control may be in a range from about 0.1% to about 100%. In some embodiments, the percent increase in resistance/tolerance to disease may be an increase in a range from about 0.1% to about 10%, 0.1% to about 30%, about 0.1% to about 50%, about 0.1% to about 80%, about 0.1% to about 90%, about 0.1% to about 95%, about 1% to about 10%, about 1% to about 20%, about 1% to about 40%, about 1% to about 50%, about 1% to about 75%, about 1% to about 95%, about 1% to about 100%, about 10% to about 20%, about 10% to about 40%, about 10% to about 50%, about 10% to about 70%, about 10% to about 80%, about 10% to about 90%, about 10% to about 100%, about 20% to about 40%, about 20% to about 75%, about 20% to about 90%, about 20% to about 95%, about 20% to about 100%, about 25% to about 50%, about 50% to about 75%, about 50% to about 95%, about 50% to about 100%, about 75% to about 90%, about 75% to about 100%, about 90% to about 95%, about 90% to about 100% or any value or range therein, as compared to a control. In some embodiments, the % increase in resistance/tolerance to disease may be about 0.1%, 0.5%, 1%, 1.5%, 2%, 2.5%, 3, 3.5%, 4%, 4.5%, 5%, 5.5%, 6%, 6.5%, 7%, 7.5%, 8%, 8.5%, 9%, 9.5%, 10%, 11%, 12%, 13%, 14%, 15%, 16%, 17, 5, 18%, 19%, 20%, 21%, 22%, 23%, 24%, 25%, 26%, 27%, 28%, 29%, 30%, 35%, 40%, 45%, or 50%, 55%, 60%, 65%, 70%, 75%, 80%, 85%, 90%, 95%, 96%, 97%, 98%, 99%or 100% or any value or range therein, as compared to a control.

In some embodiments, a method for increasing abiotic stress tolerance of a plant and/or part thereof is provided, the method comprising applying a composition comprising an effective amount of MLGs to a plant and/or part thereof, and/or to the growth media, thereby increasing the abiotic stress tolerance of the plant and/or part thereof as compared to a control plant and/or part thereof (e.g., a plant and/or part thereof to which the composition comprising MLGs has not been applied). In some embodiments, the method comprises applying the composition at least one time (e.g., about 1, 2, 3, 4, 5, 6, 7, 8, 9, 10, 11, 12 or more times, or any range or value therein). In some embodiments, the method comprises applying the composition at least two times (e.g., about 2, 3, 4, 5, 6, 7, 8, 9, 10, 11, 12 or more times, or any range or value therein).

In some embodiments, abiotic stress may include, but is not limited to, drought, salinity (e.g., medium salinity (ECₑ=4-8 dSm⁻¹); high salinity (ECₑ>8 dSm⁻¹), flooding, freezing (e.g., about 0° C. or less), chilling or cold temperature (e.g., less than about 10-15° C.), heat or high temperatures (e.g., more than about 40° C.), high light intensity (e.g. more than about 10,000 foot candles), low light intensity (e.g. less than about 1000 foot candles), and/or ozone, and/or combinations thereof. In some embodiments, the abiotic stress is drought. In some embodiments, the abiotic stress is salinity.

As used herein, “an “increased tolerance to abiotic stress” or “increased resistance to abiotic stress” are used interchangeably and refer to the ability of a plant and/or part thereof,, where the plant and/or part thereof, and/or growth media has been contacted with a composition comprising MLGs, to withstand a given abiotic stress better than a control plant and/or part thereof (i.e., a plant and/or part thereof, and/or growth media, that has been exposed to the same abiotic stress but has not been contacted with a composition comprising MLGs). Increased tolerance to abiotic stress can be measured using a variety of parameters including, but not limited to, the size and number of plants and/or parts thereof, and the like (e.g., number and size of fruits), the level or amount of cell division, the amount of floral abortion, the amount of sunburn damage, crop yield, and the like. Thus, in some embodiments of this invention, a plant and/or part thereof, where the plant and/or part thereof, and/or growth media have been contacted with a composition comprising MLGs, having increased tolerance to the abiotic stress would have, for example, increased fruit/seed number and/or weight as compared to a plant and/or part thereof exposed to the same stress but not having been contacted with said composition.

In some embodiments, the percent increase in resistance/tolerance to abiotic stress as compared to a control may be an increase in a range from about 0.1% to about 100%. In some embodiments, the percent increase in resistance/tolerance to abiotic stress may be in a range from about 0.1% to about 10%, 0.1% to about 30%, about 0.1% to about 50%, about 0.1% to about 80%, about 0.1% to about 90%, about 0.1% to about 95%, about 1% to about 10%, about 1% to about 20%, about 1% to about 40%, about 1% to about 50%, about 1% to about 75%, about 1% to about 95%, about 1% to about 100%, about 10% to about 20%, about 10% to about 40%, about 10% to about 50%, about 10% to about 70%, about 10% to about 80%, about 10% to about 90%, about 10% to about 100%, about 20% to about 40%, about 20% to about 75%, about 20% to about 90%, about 20% to about 95%, about 20% to about 100%, about 25% to about 50%, about 50% to about 75%, about 50% to about 95%, about 50% to about 100%, about 75% to about 90%, about 75% to about 100%, about 90% to about 95%, about 90% to about 100% or any value or range therein, as compared to a control. In some embodiments, the percent increase in resistance/tolerance to abiotic stress may be about 0.01%, 0.05%, 0.1%, 0.5%, 1%, 1.5%, 2%, 2.5%, 3, 3.5%, 4%, 4.5%, 5%, 5.5%, 6%, 6.5%, 7%, 7.5%, 8%, 8.5%, 9%, 9.5%, 10%, 11%, 12%, 13%, 14%, 15%, 16%, 17, 5, 18%, 19%, 20%, 21%, 22%, 23%, 24%, 25%, 26%, 27%, 28%, 29%, 30%, 35%, 40%, 45%, or 50%, 55%, 60%, 65%, 70%, 75%, 80%, 85%, 90%, 95%, 96%, 97%, 98%, 99% or 100% or any value or range therein, as compared to a control.

An embodiment of the present disclosure further provides methods for obtaining plants having increased fruit production compared to plants where a composition comprising MLGs has not been applied.

An embodiment of the present disclosure further provides methods for obtaining plants having increased inflorescence production compared to plants where a composition comprising MLGs has not been applied.

An embodiment of the present disclosure further provides methods for obtaining plants having increased fruit quality when compared to plants where a composition comprising MLGs has not been applied.

An embodiment of the present disclosure further provides methods for obtaining plants having increased production of defense/immunity-related calcium when compared to plants where a composition comprising MLGs has not been applied.

An embodiment of the present disclosure further provides methods for obtaining plants having increased expression of defense/immunity-related genes when compared to plants where a composition comprising MLGs has not been applied.

An embodiment of the present disclosure further provides methods for obtaining plants having increased tolerance to fungi when compared to plants where a composition comprising MLGs has not been applied.

An embodiment of the present disclosure further provides methods for obtaining pepper plants having increased tolerance to white mold (Sclerotinia sclerotiorum) when compared to plants where a composition comprising MLGs has not been applied.

An embodiment of the present disclosure further provides methods for obtaining cucumber plants having increased tolerance to Podosphaera fusca when compared to plants where a composition comprising MLGs has not been applied.

An embodiment of the present disclosure further provides methods for obtaining plants having increased tolerance to bacteria when treated with a composition comprising MLGs.

An embodiment of the present disclosure further provides methods for obtaining plants having increased tolerance to bacterial speck (Pseudomonas syringae) when treated with a composition comprising MLGs.

An embodiment of the present disclosure further provides methods for obtaining plants having increased tolerance to plant viruses when compared to plants where a composition comprising MLGs has not been applied.

An embodiment of the present disclosure further provides methods for obtaining plants having decreased viral load when compared to plants where a composition comprising MLGs has not been applied.

An embodiment of the present disclosure further provides methods for obtaining zucchini plants having increased tolerance to tomato leaf curl New Dehli virus (ToLCNDV) compared to plants where a composition comprising MLGs has not been applied.

In some embodiments, a method for increasing nutrient use efficiency of a plant and/or part thereof is provided, the method comprising applying a composition comprising an effective amount of MLGs to a plant and/or plant part thereof, and/or to a growth media, thereby increasing nutrient use efficiency of the plant and/or part thereof as compared to a control plant and/or part thereof (e.g., a plant and/or part thereof to which the composition of the invention has not been applied). In some embodiments, the method comprises applying the composition at least once (e.g., about 1, 2, 3, 4, 5, 6, 7, 8, 9, 10, 11, and/or 12 or more times, or any range or value therein). In some embodiments, the method comprises applying the composition at least two times (e.g., about 2, 3, 4, 5, 6, 7, 8, 9, 10, 11, 12 or more times, or any range or value therein).

In some embodiments, a method is provided for obtaining plants having increased fruit production (e.g., increased by about 5% to about 100% or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150%, or more, or any range or value therein) compared to plants where a composition comprising MLGs has not been applied. Thus in some embodiments, the methods of the invention may provide plants having increased fruit production of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, about 75% to about 140%, and any range or value therein, as compared to a plant not contacted with a composition of the invention comprising MLGs.

In some embodiments, a method is provided for obtaining plants having increased inflorescence production (e.g., increased by about 5% to about 100% or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150%, or more, or any range or value therein) compared to plants where a composition comprising MLGs has not been applied. Thus in some embodiments, the methods of the invention may provide a plant having increased inflorescence production of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, about 75% to about 140%, and any range or value therein, as compared to a plant not contacted with a composition of the invention comprising MLGs.

In some embodiments, a method is provided for obtaining plants having increased fruit quality when compared to plants where a composition comprising MLGs has not been applied (e.g., increase in fruit quality by about 5% to about 100% or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150%, or more, or any range or value therein) compared to plants where a composition comprising MLGs has not been applied. Thus in some embodiments, the methods of the invention may provide a plant having increased fruit quality of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, about 75% to about 140%, and any range or value therein, as compared to a plant not contacted with a composition of the invention comprising MLGs.

An embodiment of the present disclosure further provides methods for obtaining plants having increased production of defense/immunity-related calcium when compared to plants where a composition comprising MLGs has not been applied (e.g., increased by about 1 fold to about 100 fold or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150 fold, or more, or any range or value therein). Thus in some embodiments, the methods of the invention may provide a plant having increased production of defense/immunity-related calcium of about 1 to about 5 fold, about 1 to about 10 fold, about 1 to about 20 fold, about 5 to about 15 fold, about 5 to 20 fold, about 5 to about 25 fold, about 5 to about 30 fold, about 5 to about 50 fold, about 10 to about 20 fold, about 10 to about 30 fold, about 10 to about 50 fold, about 10 to about 70 fold, about 15 to about 20 fold, about 15% to about 50 fold, about 20 to about 30 fold, about 20 to about 50 fold, about 20 to about 70 fold, about 40 to about 50 fold, about 40 to about 80 fold, about 40 to about 100 fold, about 50 to about 70 fold, about 50 to about 100 fold, about 70 to about 100 fold, about 80 to about 100 fold, and any range or value therein, as compared to a plant not contacted with a composition of the invention comprising MLGs.

In some embodiments, a method is provided for obtaining plants having increased expression of defense/immunity-related genes when compared to plants where a composition comprising MLGs has not been applied (e.g., an increase of about 1 fold to about 100 fold or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150 fold, or more, or any range or value therein). Thus in some embodiments, the methods of the invention may provide a plant having increased expression of defense/immunity-related genes of about 1 to about 5 fold, about 1 to about 10 fold, about 1 to about 20 fold, about 5 to about 15 fold, about 5 to 20 fold, about 5 to about 25 fold, about 5 to about 30 fold, about 5 to about 50 fold, about 10 to about 20 fold, about 10 to about 30 fold, about 10 to about 50 fold, about 10 to about 70 fold, about 15 to about 20 fold, about 15% to about 50 fold, about 20 to about 30 fold, about 20 to about 50 fold, about 20 to about 70 fold, about 40 to about 50 fold, about 40 to about 80 fold, about 40 to about 100 fold, about 50 to about 70 fold, about 50 to about 100 fold, about 70 to about 100 fold, about 80 to about 100 fold, and any range or value therein, as compared to a plant not contacted with a composition of the invention comprising MLGs.

In some embodiments, a method is provided for obtaining plants having increased tolerance to one or more fungal pathogens when compared to plants where a composition comprising MLGs has not been applied (e.g., an increase of about 5% to about 100% or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150%, or more, or any range or value therein). Thus in some embodiments, the methods of the invention may provide a plant having increased tolerance to one or more fungal pathogens of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, about 75% to about 140%, and any range or value therein, as compared to a plant not contacted with a composition of the invention comprising MLGs.

In some embodiments, a method is provided for obtaining pepper plants having increased tolerance to white mold (Sclerotinia sclerotiorum) when compared to plants where a composition comprising MLGs has not been applied (e.g., an increase of about 5% to about 100% or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150%, or more, or any range or value therein). Thus in some embodiments, the methods of the invention may provide a plant having increased tolerance to white mold of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, about 75% to about 140%, and any range or value therein, as compared to a plant not contacted with a composition of the invention comprising MLGs.

In some embodiments, a method is provided for obtaining cucumber plants having increased tolerance to Podosphaera fusca when compared to plants where a composition comprising MLGs has not been applied (e.g., an increase of about 5% to about 100% or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150%, or more, or any range or value therein). Thus in some embodiments, the methods of the invention may provide a plant having increased tolerance to P. fusca of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, about 75% to about 140%, and any range or value therein, as compared to a plant not contacted with a composition of the invention comprising MLGs.

In some embodiments, a method is provided for obtaining plants having increased tolerance to one or more pathogenic bacteria when treated with a composition comprising MLGs (e.g., an increase of about 5% to about 100% or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150%, or more, or any range or value therein). Thus in some embodiments, the methods of the invention may provide a plant having increased tolerance to one or more pathogenic bacteria of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, about 75% to about 140%, and any range or value therein, as compared to a plant not contacted with a composition of the invention comprising MLGs.

In some embodiments, a method is provided for obtaining plants having increased tolerance to bacterial speck (Pseudomonas syringae) when treated with a composition comprising MLGs (e.g., an increase of about 5% to about 100% or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150%, or more, or any range or value therein). Thus in some embodiments, the methods of the invention may provide a plant having increased tolerance to bacterial speck of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, about 75% to about 140%, and any range or value therein, as compared to a plant not contacted with a composition of the invention comprising MLGs.

In some embodiments, a method is provided for obtaining plants having increased tolerance to one or more plant pathogenic viruses when compared to plants where a composition comprising MLGs has not been applied (e.g., an increase of about 5% to about 100% or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150%, or more, or any range or value therein). Thus in some embodiments, the methods of the invention may provide a plant having increased tolerance to one or more plant pathogenic viruses of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, or about 75% to about 140%, and any range or value therein, as compared to a plant not contacted with a composition of the invention comprising MLGs.

In some embodiments, a method is provided for obtaining plants having a decreased viral load when compared to plants where a composition comprising MLGs has not been applied (e.g., a decrease of about 5% to about 100%; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100%, or any range or value therein). Thus in some embodiments, the methods of the invention may provide a plant having a decreased viral load of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, or about 75% to about 140%, and any range or value therein, as compared to a plant not contacted with a composition of the invention comprising MLGs.

In some embodiments, a method is provided for obtaining zucchini plants having increased tolerance to tomato leaf curl New Dehli virus (ToLCNDV) compared to plants where a composition comprising MLGs has not been applied (e.g., an increase of about 5% to about 100% or more; e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 110, 120, 130, 140, 150%, or more, or any range or value therein). Thus in some embodiments, the methods of the invention may provide a plant having increased tolerance to tomato leaf curl New Dehli virus (ToLCNDV) of about 5% to about 10%, about 5% to about 15%, about 5% to about 20%, about 5% to about 25%, about 5% to about 30%, about 5% to about 40%, about 5% to about 50%, about 10% to about 20%, about 10% to about 30%, about 10% to about 50%, 10% to about 70%, about 15% to about 20%, about 15% to about 30%, 15% to about 50%, about 20% to about 30%, about 20% to about 50%, about 20% to about 70%, about 40% to about 50%, about 40% to about 60%, about 40% to about 80%, about 40% to about 100%, about 50% to about 70%, about 50% to about 100%, about 50% to about 125%, about 75% to about 100%, about 75% to about 120%, or about 75% to about 140%, and any range or value therein, as compared to a plant not contacted with a composition of the invention comprising MLGs.

The invention will now be described with reference to the following examples. It should be appreciated that these examples are not intended to limit the scope of the claims to the invention but are rather intended to be exemplary of certain embodiments. Any variations in the exemplified methods that occur to the skilled artisan are intended to fall within the scope of the invention.

### EXAMPLES

### Example 1 MLGs Trigger Cytoplasmic Calcium Elevations in Arabidopsis Thaliana

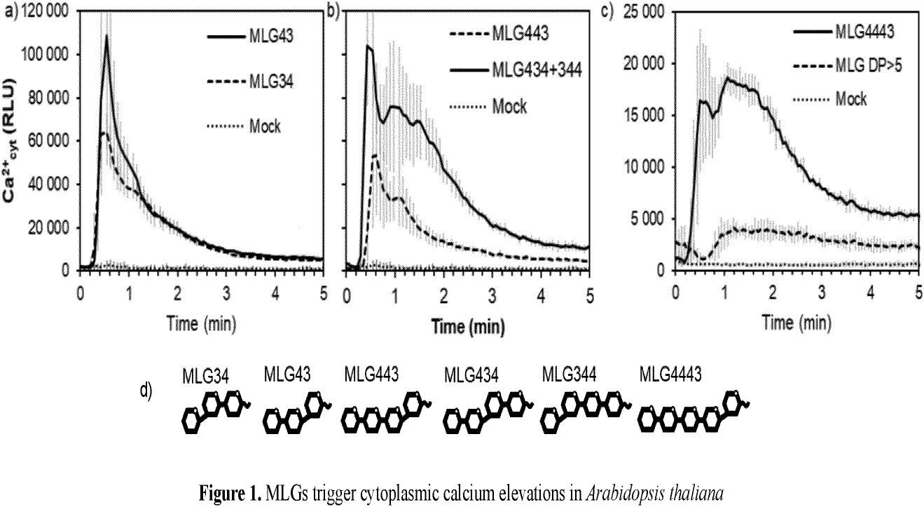

Cellular calcium influx measured as relative luminescence units (RLU) over time in 8-days old Arabidopsis Col-0^{AEQ} seedlings after treatment with FIG. 1, panels a, b and c: mixed-linked glucans (MLGs) purified from Equisetum arvense and Hordeum vulgare (barley) β-glucans. FIG. 1, panel b: MLGs purified from barley β-glucan, FIG. 1, panel c: Synthetic MLGs. Data represent mean ± σ (n=8). FIG. 1, panel d: Structural scheme of the different MLG oligosaccharides used in the calcium assay.

Results shown in FIG. 1, panels a, b, and c clearly demonstrate that MLG oligosaccharides obtained upon enzymatic digestion of β-glucan from different plant sources (Equisetum arvense and Hordeum vulgare) and with a degree of polymerization (DP) between 3 and 5 were able to trigger Ca²⁺ influxes. As shown in FIG. 1, panel c, MLG oligosaccharides of DP higher than 5 (MLG DP>5) were also active in triggering calcium influx. Differences in signal intensity among similar MLG structures from different natural β-glucan sources were observed and may be assigned to differences in purity between these sources. Different in calcium signal intensity between MLGs of different DPs may reflect difference in biological activity.

### Example 2. MLG43 Induces Gene Expression Changes in Arabidopsis Thaliana

12-day-old Arabidopsis seedlings grown on liquid MS medium were treated with 50 µM MLG43 or water (mock) solutions for 0 and 30 minutes. Total RNA was purified with the RNeasy Plant Mini Kit (Qiagen) according to the manufacturer’s protocol.

For RNA-seq analyses, samples from three biological replicates for each treatment were selected and processed as previously described (Mélida et al., 2018). The incubation with MLG43, regulated the expression of 2062 genes, most of which (1375) were up-regulated as shown in Table 1 (see, end of Examples, pages 37-83). MLG43 up-regulated genes mainly grouped into GO terms related to immune system processes and to response to different stimuli, including biotic and abiotic as shown in annex Table 1.

### Example 3. Tomato Plants Treated With MLG43 Display Higher Fruit Yield and Quality

Tomato plants var. Mayoral were sown in a greenhouse on Dec. 15, 2018 MLG43 at 0.05 g/l (with adjuvants: surfactant 0.05%, antifoaming agent and biocide) was applied at three different rates by foliar application every three weeks for a total of 6 applications, starting one week after transplanting. Tomato fruits were harvested at 6 different time points in 2019. Total yield at each harvest was recorded. Fruit quality was assessed at harvest point 2, 4 and 6. Data represent the average +/-SD of 4 replicates distributed in random blocks with 40 plants /replicate. (** p<0.05, * P< 0.1).

As shown in Table 2, tomato plants treated with MLG43 exhibited an increase in total weight of fruit production of 9% when compared to untreated plants. Fruit size and weight was increased by 8% and 7%, respectively, in MLG43-treated tomato plants (Table 3).

TABLE 2

Total weight tomato production in MLG43-treated tomato plants per harvest date

| No. of samples | Date | Total Kg production per MLG43 plants | Total Kg production per CONTROL plants | % Control |
|---|---|---|---|---|
| 1122 | March 15 | 222 | 156 | 142^{∗∗} |
| 1122 | April 1 | 284 | 331 | 86^{∗} |
| 1122 | April 15 | 317 | 312 | 102 |
| 1122 | May 1 | 485 | 402 | 121^{∗∗} |
| 1122 | May 15 | 466 | 383 | 121^{∗∗} |
| 1122 | June 1 | 1025 | 991 | 103^{∗} |
| | TOTAL | 2799 | 2575 | 109^{∗} |

TABLE 3

Average fruit size and weight in MLG43-treated tomato plants per harvest date

| No. of samples | Date | Average fruit size (cm) in MLG43 plants | Average fruit weight (g) in MLG43 plants | Average fruit size (cm) in CONTROL plants | Average fruit weight (g) in CONTROL plants | % Control |
|---|---|---|---|---|---|---|
| 1122 | April 1 | 13.6 | 129 | 12.9 | 117 | 110^{∗} |
| 1122 | May 1 | 14.5 | 139 | 13.8 | 130 | 107^{∗} |
| 1122 | June 1 | 14.0 | 134 | 13.7 | 129 | 104 |
| | TOTAL | 14.0 | 134 | 13.4 | 125 | 107^{∗} |

### Example 4. Watermelon Plants Treated With MLG43 Display Higher Yield and Fruit Quality

Watermelon plants var. Motril and Boston were sown a greenhouse on Dec. 19, 2018. A total of 1600 plants were used, 800 control plants and 800 MLG43-treated plants distributed in random blocks. MLG43 -treated plants were sprayed four times once per month, from January to April 2019 with 0.05 g/l MLG43 (with adjuvants: surfactant 0.05%, antifoaming agent and biocide) at 10 ml/plant/month. Control plants were treated with water or mock (adjuvant alone). The plants were harvested twice in April 2020 and production data were collected per harvest day according to the category, with category 1 (CAT1) being the best and category 2 (CAT2) being of less quality. Data represent the average +/-SD of 4 replicates distributed in random blocks with 40 plants /replicate. (** p<0.05).

TABLE 4

Total weight watermelon production in MLG43-treated watermelon plants per category and harvest date

| | MLG43 | | Control | |
|---|---|---|---|---|
| Date | Total Kg CAT1 production | Total Kg CAT2 production | Total Kg CAT1 production | Total Kg CAT1 production |
| April 8 | 9063 | 86 | 3946 | 157 |
| May 15 | 4102 | 0 | 4005 | 1486 |
| Total | 13251^{∗∗} | | 9594 | |

As shown above in Table 4, watermelon plants treated with MLG43 display an increased total fruit production by 46.5% and increased fruit quality by 62% when compared to untreated plants. Moreover, only 5.2% of the MLG43-treated plants where of Category 2, compared to the 14.4% of the untreated plants.

### Example 5. Pepper Plants Treated With MLG43 Have an Increased Fruit Production and Quality

Pepper plants var. California, Guepard and Ferrari were sown in a greenhouse on Dec. 19, 2018. A total of 512 plants were used per variety, 256 control plants and 256 MLG43-treated plants distributed in random blocks. MLG43 0.05 g/ (with adjuvants: surfactant 0.05%, antifoaming agent and biocide)-treated plants were sprayed 5 times, once per month from January to April 2019 with 0.05 g/l MLG43 (with adjuvants: surfactant 0.05%, antifoaming agent and biocide) at 5ml/plant/month. Data represent the average +/-SD of 4 replicates distributed in random blocks with plants/replicate. (* P< 0.1).

TABLE 5

Total production per pepper plant in grams in MLG43 or control treated plants

| VARIETY | GROUP | PRODUCTION PER PLANT (grams) | | |
|---|---|---|---|---|
| | | PROD. PER PLANT | GAIN | % |
| California | CONTROL | 1001.51 ± 63.54 | + 337.23 g* | + 33.7%^{∗} |
| | MLG43 | 1338.74 ± 43.08 | | |
| Guepard | CONTROL | 516.29 ± 20.04 | + 126.24 g* | + 22.5%^{∗} |
| | MLG43 | 632.532 ± 19.92 | | |
| Ferrari | CONTROL | 915.56 ± 49.52 | + 228.81 g* | + 25%^{∗} |
| | MLG43 | 1138.38 ± 79.76 | | |

As shown above in Table 5, pepper plants treated with MLG43 had an increase of fruit production between 22.5% and 33.7% compared to untreated plants.

TABLE 6

Average weight per pepper fruit in grams in MLG43 or control treated plants

| VARIETY | GROUP | WEIGHT OF FRUITS (grams) | | |
|---|---|---|---|---|
| | | AVERAGE WEIGHT | GAIN | % |
| California | CONTROL | 185.97 ± 3.15 | + 26.10 g^{∗} | + 14.0%^{∗} |
| | MLG43 | 212.08 ± 2.49 | | |
| Guepard | CONTROL | 179.54 ± 163 | + 6.27 g^{∗} | + 3.48%^{∗} |
| | MLG43 | 185.81 ± 1.60 | | |

As shown above in Table 6, pepper plants treated with MLG43 had an increase in the average weight of fruit between 3.48% and 14% compared to untreated plants.

### Example 6. Pepper Plants Treated With MLG43 Have an Increased Tolerance Against Sclerotinia Sclereotiorum

Pepper plants var. Ferrari were sown on Nov. 26, 2018 and grown in a greenhouse. 0.125 g/l MLG43 (with adjuvants: surfactant 0.05%, antifoaming agent and biocide) was applied by foliar spray at 2 ml/plant on 5 week old plants, 2 days prior inoculation with 5 ml/plant of a foliar spray of a 250 cfu/ml suspension of Sclerotinia sclerotiorum Plants were kept at 100% relative humidity for ten days and then humidity was lowered to 80% for the rest of the experiment. Disease symptoms were determined at 5 and 9 day-post inoculation (dpi) according to a disease severity index score where 0 corresponds to no symptoms and 4 corresponds to a dead leaf. Data represent the average +/-SD of 4 replicates distributed in random blocks with 6 plants /replicate. Different letters indicate statistically significant differences according to Student’s t-test (p<0.05).

TABLE 7

Disease symptom index of pepper plants inoculated with S. sclerotiorum upon treatment with MLG43 vs control

| TREATMENT | DISEASE INDEX | |
|---|---|---|
| | 5 dpi | 9 dpi |
| MOCK CONTROL | 0.66 a | 1.88 b |
| MLG43 | 0.56 a | 1.34 a |

As shown above in Table 7 the disease index in MLG43 treated pepper plants was significantly lower than in untreated pepper plants at 9 dpi.

### Example 7. Tomato Plants Treated With MLG43 Have an Increased Tolerance Against Pseudomonas Syringae

Tomato plants (Solanum lycopersicum var. Moneymaker) were sown on Nov. 15, 2018 and grown in a greenhouse. Three-week-old tomato plants were sprayed with 2 ml of a 0.125 g/l MLG43 solution (with adjuvants: surfactant 0.05%, antifoaming agent and biocide) or mock-treatment (surfactant 0.05%, antifoaming agent and biocide). Pseudomonas syringae DC3000 (10⁸ cfu/ml) infection was performed 48 h after treatment with MLG43 solution or Mock. Tomato leaf discs were collected at 0- and 11-days post-inoculation (dpi) and colony forming units (cfu) per foliar area was determined. Data represent mean ± σ (n=8). Statistically significant differences according to Student’s t-test (** p<0.01).

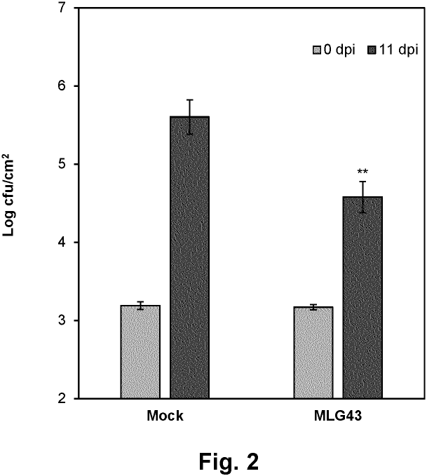

As shown in FIG. 2 a clear log cfu/cm² reduction (1.02) in the tomato MLG43-pretreated plants compared to mock plants.

### Example 8. Cucumber Plants Treated With MLG43 Have Increased Tolerance Against Podosphaera Fusca

Cucumber plants were sown on and distributed in random blocks of 9 plants with 7 replicates (63 plants per treatment) and grown in a standard greenhouse between March and September 2019. MLG43 1 g/l (with adjuvants: surfactant 0.05%, antifoaming agent and biocide) was sprayed at 1, 5, 10, 50, 100 and 200 g/ha 2 days before inoculation with Podosphaera fusca. Plants were then evaluated for 6, 9, and 14 days post inoculation (dpi) according to a disease severity index score where 0 corresponds to no symptoms and 5 corresponds to a dead plant. The area under the disease progress curve (AUDPC) was calculated as a quantitative summary of disease intensity over time as well as the efficacy of protection. Different letters indicate statistically significant differences according to Student’s t-test (p<0.05).

TABLE 8

Disease index AUDPC for control plants and plants treated with six different rates of MLG43

| | | | | | |
|---|---|---|---|---|---|
| TREATMENT | 6 dpi | 9 dpi | 14 dpi | AUDPC | Efficacy |
| CONTROL | 0.0 e | 0.0 e | 0.0 d | 0.0 d | 100 a |
| Inoculated Untreated | 3.3 a | 3.4 a | 3.6 a | 27.6 a | 0.0 d |
| C1 MLG43 | 2.5 bc | 2.9 b | 2.9 b | 22.7 b | 17.7 c |
| C2 MLG43 | 2.3 cd | 2.6 cd | 2.6 c | 20.0 c | 27.6 b |
| C3 MLG43 | 2.0 d | 2.4 d | 2.5 c | 19.0 c | 31.0 b |
| C4 MLG43 | 2.0 d | 2.5 d | 2.5 c | 19.1 c | 30.9 b |
| C5 MLG43 | 2.6 bc | 2.8 bc | 2.8 b | 22.2 b | 19.4 c |
| C6 MLG43 | 2.7 b | 3.0 b | 3.0 b | 23.6 b | 14.1 c |

As shown above in Table 8 the disease index, AUDPC and efficacy in cucumber plants treated with six different rates of MLG43 were significantly lower than in untreated cucumber plants inoculated with Podosphaera fusca. The differences were dose dependent, the highest rate giving statistically the highest level of protection against pathogen disease. The EC50 value (rate inducing half-maximum resistance) was 50 g/ha.

### Example 9. Zucchini Plants Treated With MLG43 Have an Increased Tolerance Against Tomato Leaf Curl New Dehli Virus (ToLCNDV)

Natural ToLCNDV infection occurred in zucchini plants var. Victoria and Cronos grown under standard greenhouse conditions by an experimented farmer in Almería, Spain. In total, 2200 (var. victoria) and 4300 (var. cronos) plants were used as untreated controls whereas 4400 (var. Victoria) and 2190 (var. Cronos) plants were sprayed every two weeks with MLG43 0.05 g/l (with adjuvants: surfactant 0.05%, antifoaming agent and biocide) in combination with abamectine twice and with either imidacloprod or spinosad alternating every other week. Furthermore, mancozeb was also added as a combination twice. Control plants were treated with abamectine or imidacloprod or spinosad or mancoceb alone. To detect viral load, completely randomized blocks of 10 plants with 18 replicates (180 plants for each control and MLG43-treated) were designed and 2 young leaves/plant were harvested and used for tissue print hybridization with a virus specific Digoxigenin-labeled probe on positively charged nylon membranes. The Digoxigenin-labeled probe was obtained by PCR amplification from the partial AV1 gene from DNA-A of ToLCNDV using the primer pairs ToNDA-580F:5′-TCACACATCGCGTAGGCAAG-3′ (SEQ ID NO:1) and ToNDA-935R: 5′-TGCCGGCCTCTTGTTGATTG-3′ (SEQ ID NO:2) with the PCR DIG Labeling Mix (Roche Diagnostics, Switzerland) and following the manufacturer’s instructions. Immunodetection was performed with anti-digoxigenin antibody conjugated with alkaline phosphatase (Roche Diagnostics, Switzerland) and chemiluminescence with CSPD (Roche Diagnostics, Switzerland) as substrate, following the manufacturer’s instructions and different times of exposure (15 min -overnight) to a Lumi-film (Amersham Bioscience, UK). Virus disease index was calculated as the number of TolCNDV positive plants/180 total number of sampled plants.

TABLE 9

ToLCNDV infection index in MLG43 or untreated zucchini plants

| TREATMENTS | Viral infection index Replicate 1 | Viral infection index Replicate 2 | Viral infection index Replicate 3 | T2 P-value |
|---|---|---|---|---|
| Untreated | 17.7% | 6.65% | 16.21% | 0.00124139 |
| MLG43 | 6.7% | 1.89% | 5.82% | |

As shown above in Table 9, plants treated with MLG43 had a lower infection index by tomato leaf curl New Dehli virus (ToLCNDV). Table 10 below shows the total zucchini fruit production per plant in treated and untreated plants. Treated plants were sprayed every three weeks with 0.05 g/l MLG43.

Column 1 shows the location, column 2 shows the group, column 3 shows the average harvested production for each plant in kilograms, column 4 shows the number of plants for each group, column 5 shows the percentage of gain with respect to the control values, and column 6 shows the P-value corresponding to statistical T2 analysis for daily production per plant data and treatment. P-values lower than 0.05 indicate significant differences between control and treated groups (α=0.05). The plants were grown in a conventional production greenhouse in Almeria, Murcia and Granada, Spain. Percentage respect to the control values is shown for each year harvest data.

TABLE 10

Total zucchini fruit production per plant (Kg.) sprayed every three weeks with MLG43 (0.05 g/l) versus non-treated (control) plants

| LOCATION | TREATMENT | PRODUCTION PER PLANT (Kg.) | N | % GAIN | T² P-VALUE |
|---|---|---|---|---|---|
| Almeria | CONTROL | 7.10 | 4300 | 100 | 0.000235332 |
| | MLG43 | 9.82 | 2190 | 138.3 | |
| Murcia | CONTROL | 3.03 | 2200 | 100 | |
| | MLG43 | 3.53 | 4400 | 116.4 | |
| Granada | CONTROL | 6.89 | 2300 | 100 | |
| | MLG43 | 7.23 | 4600 | 104.9 | |

As shown above in Table 10, plants treated with MLG43 showed between 4.9% and 38.3% increased fruit production compared to untreated plants.

### Example 10. Pepper Plants Treated With MLG43 Have Increased Tolerance Against Botrytis Cinerea

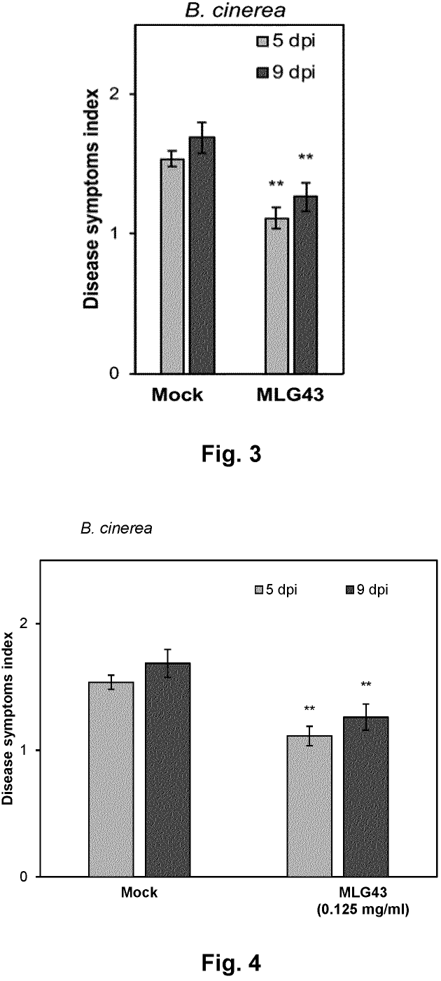

Five week old pepper plants (Capsicum annuum, Murano) were pre-treated with MLG43 as a foliar spray application with MLG43 (0.25 mg/plant) 2 days prior to Botrytis cinerea fungal inoculation. Control plants were mock treated. Two-days after treatment, Control and MLG43-treated plants were moved to a 75% humidity greenhouse chamber and spray-inoculated with 3 ml of Gamborg’s B5 medium containing B. cinerea conidia. Disease symptoms were determined at 5 dpi and 9 dpi in all the leaves of each plant (n = 12) using a scale from 0 to 4 where 0 = no symptoms; 1 = 9 little necrotic spots (< 10 % of leaf area); 2 = two or more notable necrotic spots (10 - 25 % of leaf area); 3 = big necrotic area (25 - 50 % of leaf area); 4 = more than 50 % of leaf area affected, 5 = leaf senescence. The MLG43-treated pepper plants showed a reduction in the disease symptoms index in comparison to mock-treated plants; the reduction was significant (p<0.05) both at 5 and 9 dpi(days post inoculation) for B. cinerea infections. The results are shown in FIG. 3 (^{∗∗} p<0.05).

In a further study, pepper plants were treated with 0.125 mg/ml MLG43. In this study, pepper plants (C. annuum, Murano) were grown in a greenhouse in soil-vermiculite (3:1) at under 14 hours of light/10 hours of dark at 21-19° C. Five-weeks-old plants were mock treated (control) or treated using 2 ml of a MLG43 solution (0.125 mg/ml). Two-days after treatment, plants were moved to a 75% humidity greenhouse chamber and spray-inoculated with 3 ml of Gamborg’s B5 medium containing 10⁶ B. cinerea conidia (Benito et al., 1998). Disease symptoms were determined at 5 dpi and 9 dpi in all the leaves of each plant (n = 12) using a scale from 0 to 5 where 0 = no symptoms; 1 = little necrotic spots (< 10 % of leaf area); 2 = two or more notable necrotic spots (10 - 25 % of leaf area); 3 = big necrotic area (25 - 50 % of leaf area); 4 = more than 50 % of leaf area affected, 5 = leaf senescence. Disease symptoms index produced by Botrytis cinerea at 5 and 9 days post inoculation (dpi) in leaves of pepper plants is shown in FIG. 4. Data represent mean ± SE (n = 12). Statistically significant differences according to Student’s t-test (* p<0.05; ** p<0.01) were observed. These results show that treatment of pepper plants with MLG43 at 0.125 mg/ml confers enhanced disease resistance against Botrytis cinereal. The results are graphically illustrated in FIG. 4.

### Example 11 MLG43 Confers Enhanced Disease Resistance to Oomycetes

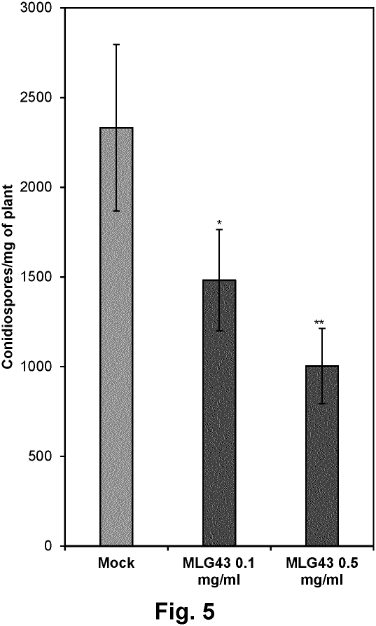

Treatment of Arabidopsis thaliana (Col-0 ecotype) with MLG43 confers enhanced disease resistance to the oomycete Hyaloperonospora arabidopsidis (Noco2 isolate). In this example, Arabidopsis thaliana (Col-0 ecotype) plants were grown in soil-vermiculite (3:1) under short day conditions (10 hours of light/14 hours of dark) at 21-20° C. and 75% humidity. Two-weeks-old plants were untreated (mock control) or treated by foliar spray using 0.1 ml of MLG43 solution per pot at either 0.1 mg/ml or 0.5 mg/ml. Two-days after treatment, plants were spray-inoculated with 0.1 ml conidia suspension (4·10⁴ conidia/ml) of a H. arabidopsidis isolate Noco2. The presence of H. arabidopsidis in plants was quantified at 7 days post inoculation as the abundance of conidiospores/mg of plant fresh weight by harvesting the inoculated plants in water, shaking them and counting the conidiospores using a Neubauer chamber. The number of conidiospores of Hyaloperonospora arabidopsidis per mg of plant fresh weight determined at 7 days post inoculation showed increased disease resistance in the MLG43 treated plants. Statistically significant differences according to Student’s t-test (* p<0.05; ** p<0.01) were measured in the MLG43 treated plants compared to the mock treatment control plants. The results are shown in FIG. 5.

### Example 12. Wheat Plants Treated With MLG43 Display Enhanced Disease Resistance to Zymoseptoria Tritici

Seeds from wheat (Triticum aestivum L.) cultivars Chinese Spring were sown in peat substrate and grown for 17 d in a glasshouse at 17° C. (day) and 15° C. (night) with a 16-h photoperiod and 60% humidity. For all infection experiments, 2×3 pot arrays (7×7 cm and 200 ml each) containing two seedlings per unit were used.

Z. tritici inoculum (Swiss strain ST99CH_3D7) (described by Zhan et al., Molecular Ecology, 14: 2683-2693 (2005)) was prepared as follows: 3D7 was inoculated in YPD (yeast extract 10 g/L, peptone 10 g/L, dextrose 20 g/L, agar 15 g/L) plates. After 4 d of incubation at 18° C., spores were collected in sterile deionised water and stored on ice until infection. The concentrations of the spore suspensions were determined with a Neubauer counting chambers and adjusted to 2.5×10⁶spores ml⁻¹ in 0.1% (v/v) for inoculation.

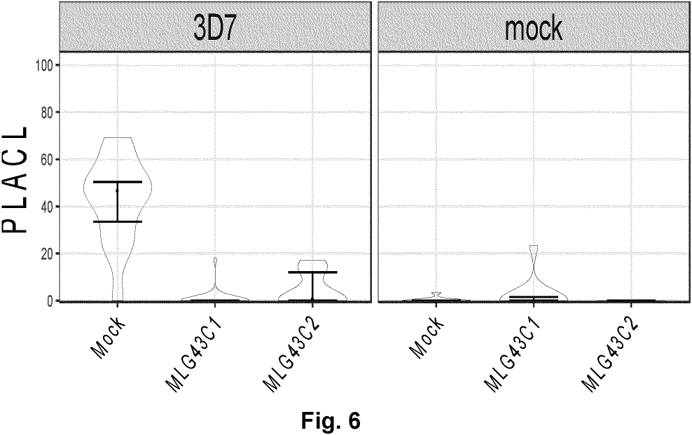

Wheat plants were mock treated (control) or sprayed with 12 ml of MLG43 at either 0.25 mg/ml or 0.75 mg/ml. Twenty four hours later plants were spray-inoculated with 12 ml of the spores suspension of the fungus. Pot arrays were placed into a sealing bag to keep humidity at 100% during 2 d post-inoculation. For symptom quantification, second leaves were mounted on paper sheets, scanned with a flatbed scanner (CanoScan LiDE 400) and analysed using automated image analysis (Stewart et al., Molecular Plant Pathology, 19: 201-216 (2016)). Data analysis and plotting was performed using RStudio v.1.0.143. Confidence intervals of the medians were determined using the ‘boot’ package and Kolmogorov-Smirnov (KS) tests for statistical significance with the ‘matching’ package in RStudio. Statistically significant differences in disease resistance were observed in MLG43 treatments compared with mock treated plants according to Kolmogorov-Smirnov (p-value<0.1). The results are shown in FIG. 6.

TABLE 1

Differentially expressed genes after MLG43 treatment in Arabidopsis thaliana plants. Genes are considered up- or down-regulated when n-fold is above 2 or below 0.5, respectively

| gene id | n-fold (treatment/mock) | gene annotation |
|---|---|---|
| AT1G07170 | Only treatment | PHF5-like protein |
| AT1G17860 | Only treatment | Kunitz family trypsin and protease inhibitor protein |
| AT1G19350 | Only treatment | Brassinosteroid signaling positive regulator (BZR1) family protein |
| AT1G20020 | Only treatment | ferredoxin-NADP[+]-oxidoreductase 2 |
| AT1G21640 | Only treatment | NAD kinase 2 |
| AT1G29150 | Only treatment | non-ATPase subunit 9 |
| AT1G49500 | Only treatment | transcription initiation factor TFIID subunit 1b-like protein |
| AT1G51620 | Only treatment | Protein kinase superfamily protein |
| AT1G51820 | Only treatment | Leucine-rich repeat protein kinase family protein |
| AT1G51913 | Only treatment | transmembrane protein |
| AT1G52220 | Only treatment | CURVATURE THYLAKOID protein |
| AT1G55152 | Only treatment | hypothetical protein |
| AT1G55810 | Only treatment | uridine kinase-like 3 |
| AT1G56190 | Only treatment | Phosphoglycerate kinase family protein |
| AT1G61340 | Only treatment | F-box family protein |
| AT1G61360 | Only treatment | S-locus lectin protein kinase family protein |
| AT1G61560 | Only treatment | Seven transmembrane MLO family protein |
| AT1G61560 | Only treatment | Seven transmembrane MLO family protein |
| AT1G64710 | Only treatment | GroES-like zinc-binding alcohol dehydrogenase family protein |
| AT1G69252 | Only treatment | NA |
| AT1G72770 | Only treatment | HYPERSENSITIVE TO ABA1 |
| AT1G75860 | Only treatment | DNA ligase |
| AT1G76970 | Only treatment | Target of Myb protein 1 |
| AT1G78660 | Only treatment | gamma-glutamyl hydrolase 1 |
| AT1G79810 | Only treatment | Pex2/Pex12 N-terminal domain-containing protein / zinc finger (C3HC4-type RING finger) family protein |
| AT2G17290 | Only treatment | Calcium-dependent protein kinase family protein |
| AT2G22990 | Only treatment | sinapoylglucose 1 |
| AT2G24600 | Only treatment | Ankyrin repeat family protein |
| AT2G25297 | Only treatment | transmembrane protein |
| AT2G26500 | Only treatment | cytochrome b6f complex subunit (petM) |
| AT2G26590 | Only treatment | regulatory particle non-ATPase 13 |
| AT2G26690 | Only treatment | Major facilitator superfamily protein |
| AT2G28630 | Only treatment | 3-ketoacyl-CoA synthase 12 |
| AT2G29960 | Only treatment | cyclophilin 5 |
| AT2G30600 | Only treatment | BTB/POZ domain-containing protein |
| AT2G37760 | Only treatment | NAD(P)-linked oxidoreductase superfamily protein |
| AT2G37940 | Only treatment | Inositol phosphorylceramide synthase 2 |
| AT2G41430 | Only treatment | dehydration-induced protein (ERD15) |
| AT2G41880 | Only treatment | guanylate kinase 1 |
| AT2G46370 | Only treatment | Auxin-responsive GH3 family protein |
| AT2G47060 | Only treatment | Protein kinase superfamily protein |
| AT3G02200 | Only treatment | Proteasome component (PCI) domain protein |
| AT3G66654 | Only treatment | Cyclophilin-like peptidyl-prolyl cis-trans isomerase family protein |
| AT3G13120 | Only treatment | Ribosomal protein S10p/S20e family protein |
| AT3G13430 | Only treatment | RING/U-box superfamily protein |
| AT3G13580 | Only treatment | Ribosomal protein L30/L7 family protein |
| AT3G13845 | Only treatment | transmembrane protein |
| AT3G19290 | Only treatment | ABRE binding factor 4 |
| AT3G21070 | Only treatment | NAD kinase 1 |
| AT3G21070 | Only treatment | NAD kinase 1 |
| AT3G24530 | Only treatment | AAA-type ATPase family protein / ankyrin repeat family protein |
| AT3G25900 | Only treatment | Homocysteine S-methyltransferase family protein |
| AT3G32930 | Only treatment | 6%2C7-dimethyl-8-ribityllumazine synthase |
| AT3G44590 | Only treatment | 60S acidic ribosomal protein family |
| AT3G45620 | Only treatment | Transducin/WD40 repeat-like superfamily protein |
| AT3G51370 | Only treatment | Protein phosphatase 2C family protein |
| AT3G54300 | Only treatment | vesicle-associated membrane protein 727 |
| AT3G62030 | Only treatment | rotamase CYP 4 |
| AT4G00830 | Only treatment | RNA-binding (RRM/RBD/RNP motifs) family protein |
| AT4G01610 | Only treatment | Cysteine proteinases superfamily protein |
| AT4G02350 | Only treatment | exocyst complex component sec15B |
| AT4G10120 | Only treatment | Sucrose-phosphate synthase family protein |
| AT4G11890 | Only treatment | Protein kinase superfamily protein |
| AT4G12720 | Only treatment | MutT/nudix family protein |
| AT4G14370 | Only treatment | Disease resistance protein (TIR-NBS-LRR class) family |
| AT4G14890 | Only treatment | 2Fe-2S ferredoxin-like superfamily protein |
| AT4G15233 | Only treatment | ABC-2 and Plant PDR ABC-type transporter family protein |
| AT4G16990 | Only treatment | disease resistance protein (TIR-NBS class) |
| AT4G16990 | Only treatment | disease resistance protein (TIR-NBS class) |
| AT4G16990 | Only treatment | disease resistance protein (TIR-NBS class) |
| AT4G21860 | Only treatment | methionine sulfoxide reductase B 2 |
| AT4G28880 | Only treatment | casein kinase I-like 3 |
| AT4G30100 | Only treatment | P-loop containing nucleoside triphosphate hydrolases superfamily protein |
| AT4G33050 | Only treatment | calmodulin-binding family protein |
| AT4G33430 | Only treatment | BRI1-associated receptor kinase |
| AT4G35450 | Only treatment | ankyrin repeat-containing protein 2 |
| AT4G39200 | Only treatment | Ribosomal protein S25 family protein |
| AT4G39640 | Only treatment | gamma-glutamyl transpeptidase 1 |
| AT5G02230 | Only treatment | Haloacid dehalogenase-like hydrolase (HAD) superfamily protein |
| AT5G02500 | Only treatment | heat shock cognate protein 70-1 |
| AT5G09660 | Only treatment | peroxisomal NAD-malate dehydrogenase 2 |
| AT5G24165 | Only treatment | hypothetical protein |
| AT5G28450 | Only treatment | Chlorophyll A-B binding family protein |
| AT5G35200 | Only treatment | ENTH/ANTH/VHS superfamily protein |
| AT5G48150 | Only treatment | GRAS family transcription factor |
| AT5G48657 | Only treatment | defense protein-like protein |
| AT5G49710 | Only treatment | RING finger protein |
| AT5G52760 | Only treatment | Copper transport protein family |
| AT5G54760 | Only treatment | Translation initiation factor SUI1 family protein |
| AT5G54940 | Only treatment | Translation initiation factor SUI1 family protein |
| AT5G56900 | Only treatment | CwfJ-like family protein / zinc finger (CCCH-type) family protein |
| AT5G58140 | Only treatment | phototropin 2 |
| AT5G58240 | Only treatment | FRAGILE HISTIDINE TRIAD |
| AT5G66210 | Only treatment | calcium-dependent protein kinase 28 |
| AT2G46030 | 1059362.531 | ubiquitin-conjugating enzyme 6 |
| AT3G25520 | 19296.14134 | ribosomal protein L5 |
| AT3G59990 | 7626.984748 | methionine aminopeptidase 2B |
| AT1G05850 | 5150.992522 | Chitinase family protein |
| AT5G36880 | 2813.658218 | acetyl-CoA synthetase |
| AT2G21330 | 1903.522718 | fructose-bisphosphate aldolase 1 |
| AT4G31490 | 1860.712847 | Coatomer%2C beta subunit |
| AT1G12520 | 1596.973979 | copper chaperone for SOD1 |
| AT4G25030 | 1478.028828 | Serine/Threonine-kinase |
| AT3G01090 | 1391.450567 | SNF1 kinase homolog 10 |
| AT1G70530 | 1337.492113 | cysteine-rich RLK (RECEPTOR-like protein kinase) 3 |
| AT5G47840 | 1292.751734 | adenosine monophosphate kinase |
| AT4G36195 | 1088.736505 | Serine carboxypeptidase S28 family protein |
| AT3G07565 | 561.8941506 | histone H2A deubiquitinase (DUF3755) |
| AT1G11840 | 524.361257 | glyoxalase/bleomycin resistance protein/dioxygenase superfamily protein |
| AT4G33050 | 509.8845329 | calmodulin-binding family protein |
| AT3G07310 | 495.5356751 | phosphoserine aminotransferase%2C putative (DUF760) |
| AT5G63050 | 491.7040479 | embryo defective 2759 |
| AT4G23010 | 355.949178 | UDP-galactose transporter 2 |
| AT1G70730 | 333.0910687 | Phosphoglucomutase/phosphomannomutase family protein |
| AT5G61900 | 305.3762881 | Calcium-dependent phospholipid-binding Copine family protein |
| AT3G59970 | 261.1545735 | methylenetetrahydrofolate reductase 1 |
| AT3G12910 | 247.3203992 | NAC (No Apical Meristem) domain transcriptional regulator superfamily protein |
| AT2G19180 | 214.1308509 | hypothetical protein |
| AT1G79680 | 187.6428268 | WALL ASSOCIATED KINASE (WAK)-LIKE 10 |
| AT5G24110 | 182.6993103 | WRKY DNA-binding protein 30 |
| AT3G06040 | 177.6856713 | Ribosomal protein L12/ATP-dependent Clp protease adaptor protein CIpS family protein |
| AT1G14540 | 175.0757166 | Peroxidase superfamily protein |
| AT1G26380 | 161.7438889 | FAD-binding Berberine family protein |
| AT5G41750 | 151.9272332 | Disease resistance protein (TIR-NBS-LRR class) family |
| AT2G40830 | 149.1431713 | RING-H2 finger C1A |
| AT3G56240 | 148.776817 | copper chaperone |
| AT4G39460 | 144.5399225 | S-adenosylmethionine carrier 1 |
| AT2G37430 | 140.7538002 | C2H2 and C2HC zinc fingers superfamily protein |
| AT1G79245 | 137.1093532 | NA |
| AT4G20410 | 130.2603608 | gamma-soluble NSF attachment protein |
| AT2G35710 | 124.4479647 | Nucleotide-diphospho-sugar transferases superfamily protein |
| AT5G07890 | 118.8559779 | myosin heavy chain-like protein |
| AT4G11470 | 118.6988566 | cysteine-rich RLK (RECEPTOR-like protein kinase) 31 |
| AT1G31170 | 116.2186878 | sulfiredoxin |
| AT5G11200 | 115.6522676 | DEAD/DEAH box RNA helicase family protein |
| AT2G32200 | 113.2091947 | cysteine-rich/transmembrane domain A-like protein |
| AT3G49010 | 108.7782988 | breast basic conserved 1 |
| AT5G64905 | 100.7661603 | elicitor peptide 3 precursor |
| AT1G57680 | 93.75928728 | plasminogen activator inhibitor |
| AT1G65390 | 93.33803437 | phloem protein 2 A5 |
| AT1G64980 | 93.00199066 | Nucleotide-diphospho-sugar transferases superfamily protein |
| AT1G53910 | 89.883197 | related to AP2 12 |
| AT1G06983 | 83.20784428 | NA |
| AT5G05300 | 79.7792643 | hypothetical protein |
| AT1G05675 | 79.66185906 | UDP-Glycosyltransferase superfamily protein |
| AT1G80820 | 74.45160128 | cinnamoyl coa reductase |
| AT3G15690 | 72.6301438 | Single hybrid motif superfamily protein |
| AT3G04600 | 72.40853477 | Nucleotidylyl transferase superfamily protein |
| AT5G64890 | 70.40759385 | elicitor peptide 2 precursor |
| AT2G36690 | 69.46188194 | 2-oxoglutarate (2OG) and Fe(II)-dependent oxygenase superfamily protein |
| AT1G53625 | 69.19007965 | hypothetical protein |
| AT1G60200 | 68.6520033 | splicing factor PWI domain-containing protein / RNA recognition motif (RRM)-containing protein |
| AT2G13800 | 67.15269769 | somatic embryogenesis receptor-like kinase 5 |
| AT1G71520 | 66.72809511 | Integrase-type DNA-binding superfamily protein |
| AT3G47350 | 66.42158221 | hydroxysteroid dehydrogenase 2 |
| AT3G29000 | 65.86627652 | Calcium-binding EF-hand family protein |
| AT1G30755 | 65.73012086 | elongation factor G%2C putative (DUF668) |
| AT1G07160 | 65.68060191 | Protein phosphatase 2C family protein |
| AT3G04870 | 60.44861898 | zeta-carotene desaturase |
| AT3G06650 | 57.37061685 | ATP-citrate lyase B-1 |
| AT2G26300 | 55.12291011 | G protein alpha subunit 1 |
| AT5G53140 | 54.09134998 | Protein phosphatase 2C family protein |
| AT3G55020 | 51.191223 | Ypt/Rab-GAP domain of gyp1p superfamily protein |
| AT1G69920 | 49.73533325 | glutathione S-transferase TAU 12 |
| AT5G57220 | 49.71036984 | cytochrome P450%2C family 81%2C subfamily F%2C polypeptide 2 |
| AT4G18195 | 49.44499999 | purine permease 8 |
| AT1G13520 | 49.15416545 | hypothetical protein (DUF1262) |
| AT1G56250 | 47.12962297 | phloem protein 2-B14 |
| AT5G22520 | 44.56577445 | hypothetical protein |
| AT1G12900 | 44.32448202 | glyceraldehyde 3-phosphate dehydrogenase A subunit 2 |
| AT3G23230 | 43.6731302 | Integrase-type DNA-binding superfamily protein |
| AT1G21120 | 41.54968563 | O-methyltransferase family protein |
| AT3G07195 | 41.02879882 | RPM1-interacting protein 4 (RIN4) family protein |
| AT3G54150 | 40.27218491 | S-adenosyl-L-methionine-dependent methyltransferases superfamily protein |
| AT5G37770 | 40.21562554 | EF hand calcium-binding protein family |
| AT3G66654 | 40.00257425 | Cyclophilin-like peptidyl-prolyl cis-trans isomerase family protein |
| AT2G22670 | 39.90491297 | indoleacetic acid-induced protein 8 |
| AT2G26560 | 38.84607256 | phospholipase A 2A |
| AT3G54150 | 38.77554598 | S-adenosyl-L-methionine-dependent methyltransferases superfamily protein |
| AT1G78410 | 38.42931167 | VQ motif-containing protein |
| AT1G56060 | 38.24293361 | cysteine-rich/transmembrane domain protein B |
| AT5G04080 | 37.13672644 | cysteine-rich TM module stress tolerance protein |
| AT2G19190 | 36.22604962 | FLG22-induced receptor-like kinase 1 |
| AT1G58180 | 36.12498573 | beta carbonic anhydrase 6 |
| AT4G08390 | 36.02083099 | stromal ascorbate peroxidase |
| AT3G01830 | 35.89875923 | Calcium-binding EF-hand family protein |
| AT1G66090 | 35.39267979 | Disease resistance protein (TIR-NBS class) |
| AT4G20000 | 34.57369768 | VQ motif-containing protein |
| AT1G15240 | 33.94013762 | phox (PX) domain-containing protein |
| AT3G60240 | 33.44251913 | eukaryotic translation initiation factor 4G |
| AT5G01540 | 33.15669334 | lectin receptor kinase a4.1 |
| AT1G56240 | 33.07116587 | phloem protein 2-B13 |
| AT1G17147 | 32.89320658 | VQ motif-containing protein |
| AT1G72520 | 32.64410927 | PLAT/LH2 domain-containing lipoxygenase family protein |
| AT3G15518 | 32.39914891 | hypothetical protein |
| AT4G23190 | 32.2479441 | cysteine-rich RLK (RECEPTOR-like protein kinase) 11 |
| AT5G35620 | 31.80799076 | Eukaryotic initiation factor 4E protein |
| AT1G68690 | 31.39994655 | Protein kinase superfamily protein |
| AT2G27389 | 30.18984793 | hypothetical protein |
| AT1G26420 | 30.15916525 | FAD-binding Berberine family protein |
| AT3G02840 | 30.1095949 | ARM repeat superfamily protein |
| AT3G26510 | 29.79823637 | Octicosapeptide/Phox/Bem1p family protein |
| AT4G14630 | 29.55838194 | germin-like protein 9 |
| AT4G15975 | 29.25190975 | RING/U-box superfamily protein |
| AT4G23215 | 27.91661584 | NA |
| AT1G30370 | 27.48550386 | alpha/beta-Hydrolases superfamily protein |
| AT1G80490 | 26.68033535 | TOPLESS-related 1 |
| AT1G73840 | 26.19491413 | hydroxyproline-rich glycoprotein family protein |
| AT5G27420 | 26.18040417 | carbon/nitrogen insensitive 1 |
| AT5G39670 | 25.91366122 | Calcium-binding EF-hand family protein |
| AT2G02710 | 25.67387301 | PAS/LOV protein B |
| AT1G30700 | 25.67311846 | FAD-binding Berberine family protein |
| AT4G21390 | 25.32735727 | S-locus lectin protein kinase family protein |
| AT5G28610 | 25.29135935 | LOW protein: ATP-dependent RNA helicase DRS1-like protein |
| AT1G62660 | 24.45643452 | Glycosyl hydrolases family 32 protein |
| AT1G02400 | 23.91202989 | gibberellin 2-oxidase 6 |
| AT2G33310 | 23.89554691 | auxin-induced protein 13 |
| AT1G21110 | 23.76771325 | O-methyltransferase family protein |
| AT1G30755 | 23.40826141 | elongation factor G%2C putative (DUF668) |
| AT4G37370 | 23.2202821 | cytochrome P450%2C family 81%2C subfamily D%2C polypeptide 8 |
| AT4G12720 | 22.73638305 | MutT/nudix family protein |
| AT5G36925 | 22.32907616 | hypothetical protein |
| AT3G21520 | 22.24668793 | transmembrane protein%2C putative (DUF679 domain membrane protein 1) |
| AT4G24550 | 21.91659783 | Clathrin adaptor complexes medium subunit family protein |
| AT1G04080 | 21.65336654 | Tetratricopeptide repeat (TPR)-like superfamily protein |
| AT5G15130 | 21.04383884 | WRKY DNA-binding protein 72 |
| AT5G66210 | 20.96478023 | calcium-dependent protein kinase 28 |
| AT2G17740 | 20.83644824 | Cysteine/Histidine-rich C1 domain family protein |
| AT2G18210 | 20.80085425 | hypothetical protein |
| AT1G19020 | 20.75028382 | CDP-diacylglycerol-glycerol-3-phosphate 3-phosphatidyltransferase |
| AT4G02450 | 20.3745343 | HSP20-like chaperones superfamily protein |
| AT3G28580 | 20.14823353 | P-loop containing nucleoside triphosphate hydrolases superfamily protein |
| AT3G09830 | 20.09337023 | Protein kinase superfamily protein |
| AT4G26480 | 19.9371748 | RNA-binding KH domain-containing protein |
| AT2G44370 | 19.79832463 | Cysteine/Histidine-rich C1 domain family protein |
| AT4G23220 | 19.78197931 | cysteine-rich RECEPTOR-like kinase |
| AT5G22690 | 19.63898197 | Disease resistance protein (TIR-NBS-LRR class) family |
| AT2G40095 | 19.57732814 | Alpha/beta hydrolase related protein |
| AT2G35658 | 19.48238836 | transmembrane protein |
| AT2G41100 | 19.34619624 | Calcium-binding EF hand family protein |
| AT1G21400 | 19.18637532 | Thiamin diphosphate-binding fold (THDP-binding) superfamily protein |
| AT5G26920 | 19.15016487 | Cam-binding protein 60-like G |
| AT5G54730 | 19.00397807 | yeast autophagy 18 F-like protein |
| AT4G14365 | 18.82308352 | hypothetical protein |
| AT4G11000 | 18.80064387 | Ankyrin repeat family protein |
| AT1G36622 | 18.46461555 | transmembrane protein |
| AT4G30210 | 18.33468008 | P450 reductase 2 |
| AT5G10290 | 18.32525222 | leucine-rich repeat transmembrane protein kinase family protein |
| AT4G08460 | 18.21055018 | hypothetical protein (DUF1644) |
| AT1G18570 | 18.09045876 | myb domain protein 51 |
| AT5G41750 | 17.7594965 | Disease resistance protein (TIR-NBS-LRR class) family |
| AT4G31550 | 17.72503871 | WRKY DNA-binding protein 11 |
| AT5G42380 | 17.72501329 | calmodulin like 37 |
| AT4G26570 | 17.52084675 | calcineurin B-like 3 |
| AT2G39200 | 17.16573699 | Seven transmembrane MLO family protein |
| AT4G37550 | 17.15866823 | Acetamidase/Formamidase family protein |
| AT5G19240 | 16.95065719 | Glycoprotein membrane precursor GPI-anchored |
| AT5G62150 | 16.54267534 | peptidoglycan-binding LysM domain-containing protein |
| AT1G24145 | 16.47469042 | transmembrane protein |
| AT2G40270 | 16.43151577 | Protein kinase family protein |
| AT5G14700 | 16.3732004 | NAD(P)-binding Rossmann-fold superfamily protein |
| AT4G39580 | 16.32984536 | Galactose oxidase/kelch repeat superfamily protein |
| AT3G11840 | 16.08405889 | E3 ubiquitin-protein ligase PUB24-like protein |
| AT5G48540 | 16.01692455 | receptor-like protein kinase-related family protein |
| AT2G45990 | 15.91820073 | ribosomal RNA small subunit methyltransferase G |
| AT1G65390 | 15.90353936 | phloem protein 2 A5 |
| AT5G44585 | 15.61392695 | hypothetical protein |
| AT5G28630 | 15.44775039 | glycine-rich protein |
| AT2G32030 | 15.25352945 | Acyl-CoA N-acyltransferases (NAT) superfamily protein |
| AT3G16530 | 15.14220185 | Legume lectin family protein |
| AT5G25560 | 15.08625658 | CHY-type/CTCHY-type/RING-type Zinc finger protein |
| AT5G53050 | 15.06315712 | alpha/beta-Hydrolases superfamily protein |
| AT4G23810 | 14.9818364 | WRKY family transcription factor |
| AT4G31800 | 14.81237321 | WRKY DNA-binding protein 18 |
| AT5G52750 | 14.66030161 | Heavy metal transport/detoxification superfamily protein |
| AT1G61100 | 14.49166771 | disease resistance protein (TIR class) |
| AT1G02360 | 14.42417591 | Chitinase family protein |
| AT1G05575 | 14.35433952 | transmembrane protein |
| AT2G38470 | 14.30656896 | WRKY DNA-binding protein 33 |
| AT5G25250 | 14.28737229 | SPFH/Band 7/PHB domain-containing membrane-associated protein family |
| AT2G46430 | 14.28525223 | cyclic nucleotide gated channel 3 |
| AT3G50930 | 14.09433961 | cytochrome BC1 synthesi |
| AT3G55840 | 14.03248662 | Hs1pro-1 protein |
| AT1G19800 | 14.00711372 | trigalactosyldiacylglycerol 1 |
| AT5G58940 | 14.00503585 | calmodulin-binding receptor-like cytoplasmic kinase 1 |
| AT4G18205 | 13.80777652 | Nucleotide-sugar transporter family protein |
| AT1G55450 | 13.73824569 | S-adenosyl-L-methionine-dependent methyltransferases superfamily protein |
| AT3G23250 | 13.64720456 | myb domain protein 15 |
| AT2G17040 | 13.59681058 | NAC domain containing protein 36 |
| AT5G12340 | 13.53664834 | DUF4228 domain protein |
| AT1G03090 | 13.44642218 | methylcrotonyl-CoA carboxylase alpha chain |
| AT4G21920 | 13.41589 | hypothetical protein |
| AT2G25735 | 13.4098057 | hypothetical protein |
| AT4G23170 | 13.20412121 | receptor-like protein kinase-related family protein |
| AT1G74360 | 12.90195294 | Leucine-rich repeat protein kinase family protein |
| AT4G36500 | 12.89385955 | hypothetical protein |
| AT1G56060 | 12.65482937 | cysteine-rich/transmembrane domain protein B |
| AT3G03030 | 12.55845879 | F-box/RNI-like superfamily protein |
| AT4G18197 | 12.38274855 | purine permease 7 |
| AT3G61070 | 12.36390138 | peroxin 11E |
| AT4G20780 | 12.32294333 | calmodulin like 42 |
| AT1G49000 | 12.2971534 | transmembrane protein |
| AT1G58420 | 12.28130405 | Uncharacterized conserved protein UCP031279 |
| AT5G48657 | 12.2429175 | defense protein-like protein |
| AT1G07135 | 12.17651609 | glycine-rich protein |
| AT3G29180 | 12.1479236 | DUF1336 family protein (DUF1336) |
| AT5G54710 | 12.14685611 | Ankyrin repeat family protein |
| AT5G44070 | 12.1127252 | phytochelatin synthase 1 (PCS1) |
| AT4G23180 | 12.06799609 | cysteine-rich RLK (RECEPTOR-like protein kinase) 10 |
| AT5G23510 | 11.99557623 | hypothetical protein |
| AT1G09932 | 11.96289783 | Phosphoglycerate mutase family protein |
| AT3G13235 | 11.94966375 | ubiquitin family protein |
| AT3G02800 | 11.93853559 | Tyrosine phosphatase family protein |
| AT5G51190 | 11.79181791 | Integrase-type DNA-binding superfamily protein |
| AT5G40590 | 11.60998601 | Cysteine/Histidine-rich C1 domain family protein |
| AT2G35930 | 11.59545838 | plant U-box 23 |
| AT3G19010 | 11.50037752 | 2-oxoglutarate (2OG) and Fe(II)-dependent oxygenase superfamily protein |
| AT2G27660 | 11.41905643 | Cysteine/Histidine-rich C1 domain family protein |
| AT1G64510 | 11.34174721 | Translation elongation factor EF1 B/ribosomal protein S6 family protein |
| AT2G28815 | 11.31008871 | 50S ribosomal protein L16 |
| AT1G30757 | 11.29664925 | transmembrane protein |
| AT1G07940 | 11.21013706 | GTP binding Elongation factor Tu family protein |
| AT5G43420 | 11.17644799 | RING/U-box superfamily protein |
| AT4G17490 | 11.05232993 | ethylene responsive element binding factor 6 |
| AT1G27730 | 11.04102148 | salt tolerance zinc finger |
| AT5G25930 | 11.0282385 | kinase family with leucine-rich repeat domain-containing protein |
| AT3G25610 | 10.9296872 | ATPase E1-E2 type family protein / haloacid dehalogenase-like hydrolase family protein |
| AT3G59310 | 10.79696033 | solute carrier family 35 protein (DUF914) |
| AT5G08080 | 10.75423409 | syntaxin of plants 132 |
| AT5G63890 | 10.7359494 | histidinol dehydrogenase |
| AT5G23510 | 10.57194045 | hypothetical protein |
| AT5G67450 | 10.52342639 | zinc-finger protein 1 |
| AT5G48530 | 10.46565202 | hypothetical protein |
| AT5G48430 | 10.28648282 | Eukaryotic aspartyl protease family protein |
| AT4G38550 | 10.09441185 | phospholipase-like protein (PEARLI 4) family protein |
| AT4G24570 | 10.07899742 | dicarboxylate carrier 2 |
| AT4G26200 | 10.07284294 | 1-amino-cyclopropane-1-carboxylate synthase 7 |
| AT5G39020 | 10.04003609 | Malectin/receptor-like protein kinase family protein |
| AT5G50570 | 9.988315557 | Squamosa promoter-binding protein-like (SBP domain) transcription factor family protein |
| AT4G31550 | 9.981571842 | WRKY DNA-binding protein 11 |
| AT5G01542 | 9.967706235 | NA |
| AT3G18250 | 9.965187336 | Putative membrane lipoprotein |
| AT2G15220 | 9.96275368 | Plant basic secretory protein (BSP) family protein |
| AT1G21400 | 9.942741548 | Thiamin diphosphate-binding fold (THDP-binding) superfamily protein |
| AT5G17300 | 9.884626178 | Homeodomain-like superfamily protein |
| AT3G12320 | 9.832754571 | hypothetical protein |
| AT3G15356 | 9.760635739 | Legume lectin family protein |
| AT5G45340 | 9.744937432 | cytochrome P450%2C family 707%2C subfamily A%2C polypeptide 3 |
| AT2G20562 | 9.741353806 | taximin |
| AT5G44910 | 9.731976967 | Toll-Interleukin-Resistance (TIR) domain family protein |
| AT1G13210 | 9.693922459 | autoinhibited Ca2+/ATPase II |
| AT4G31800 | 9.654318737 | WRKY DNA-binding protein 18 |
| AT1G22280 | 9.650119577 | phytochrome-associated protein phosphatase type 2C |
| AT2G32020 | 9.58112577 | Acyl-CoA N-acyltransferases (NAT) superfamily protein |
| AT4G38550 | 9.534698464 | phospholipase-like protein (PEARLI 4) family protein |
| AT2G15390 | 9.533577326 | fucosyltransferase 4 |
| AT5G47230 | 9.508744893 | ethylene responsive element binding factor 5 |
| AT3G56408 | 9.50152259 | NA |
| AT4G28085 | 9.485539002 | transmembrane protein |
| AT5G35735 | 9.471837468 | Auxin-responsive family protein |
| AT2G26190 | 9.438054263 | calmodulin-binding family protein |
| AT1G20310 | 9.406801347 | syringolide-induced protein |
| AT3G52400 | 9.342446706 | syntaxin of plants 122 |
| AT3G55980 | 9.341935252 | salt-inducible zinc finger 1 |
| AT2G22500 | 9.334082004 | uncoupling protein 5 |
| AT2G24270 | 9.311005255 | aldehyde dehydrogenase 11A3 |
| AT5G13800 | 9.215569197 | pheophytinase |
| AT5G01100 | 9.209365972 | O-fucosyltransferase family protein |
| AT2G39650 | 9.142583668 | cruciferin (DUF506) |
| AT4G24310 | 9.122098712 | transmembrane protein%2C putative (DUF679) |
| AT3G05370 | 9.114945278 | receptor like protein 31 |
| AT2G47140 | 9.061844232 | NAD(P)-binding Rossmann-fold superfamily protein |
| AT4G36360 | 9.041385899 | beta-galactosidase 3 |
| AT1G80840 | 9.034208847 | WRKY DNA-binding protein 40 |
| AT4G08555 | 8.982458275 | hypothetical protein |
| AT2G20142 | 8.966825314 | Toll-Interleukin-Resistance (TIR) domain family protein |
| AT2G44840 | 8.897003751 | ethylene-responsive element binding factor 13 |
| AT2G15390 | 8.880894033 | fucosyltransferase 4 |
| AT2G47060 | 8.789011499 | Protein kinase superfamily protein |
| AT2G46420 | 8.767262569 | helicase with zinc finger protein |
| AT5G41740 | 8.765446207 | Disease resistance protein (TIR-NBS-LRR class) family |
| AT3G18710 | 8.693845009 | plant U-box 29 |
| AT4G11280 | 8.693609638 | 1-aminocyclopropane-1-carboxylic acid (acc) synthase 6 |
| AT2G31880 | 8.680807785 | Leucine-rich repeat protein kinase family protein |
| AT4G16990 | 8.608190337 | disease resistance protein (TIR-NBS class) |
| AT3G55980 | 8.507990894 | salt-inducible zinc finger 1 |
| AT1G19660 | 8.500907056 | Wound-responsive family protein |
| AT1G24150 | 8.385284596 | formin homologue 4 |
| AT3G16660 | 8.356922345 | Pollen Ole e 1 allergen and extensin family protein |
| AT2G18960 | 8.352648315 | H[+]-ATPase 1 |
| AT4G39670 | 8.319412749 | Glycolipid transfer protein (GLTP) family protein |
| AT2G29280 | 8.315644981 | NA |
| AT3G21781 | 8.311625587 | NA |
| AT4G01750 | 8.305577662 | rhamnogalacturonan xylosyltransferase 2 |
| AT3G08760 | 8.273271137 | Protein kinase superfamily protein |
| AT5G57940 | 8.227290248 | cyclic nucleotide gated channel 5 |
| AT3G26500 | 8.157975222 | plant intracellular ras group-related LRR 2 |
| AT1G18390 | 8.153532516 | Serine/Threonine kinase family catalytic domain protein |
| AT2G01180 | 8.130733621 | phosphatidic acid phosphatase 1 |
| AT5G66790 | 8.088399399 | Protein kinase superfamily protein |
| AT5G24314 | 8.077133928 | plastid transcriptionally active7 |
| AT1G74650 | 8.068164185 | myb domain protein 31 |
| AT5G53370 | 7.959842773 | pectin methylesterase PCR fragment F |
| AT5G41100 | 7.956464927 | hydroxyproline-rich glycoprotein family protein |
| AT1G02920 | 7.857899969 | glutathione S-transferase 7 |
| AT2G31865 | 7.811184416 | poly(ADP-ribose) glycohydrolase 2 |
| AT5G52760 | 7.807635963 | Copper transport protein family |
| AT2G22870 | 7.796559184 | P-loop containing nucleoside triphosphate hydrolases superfamily protein |
| AT3G61190 | 7.74975943 | BON association protein 1 |
| AT5G67340 | 7.746439149 | ARM repeat superfamily protein |
| AT1G10200 | 7.736143065 | GATA type zinc finger transcription factor family protein |
| AT1G59870 | 7.71154593 | ABC-2 and Plant PDR ABC-type transporter family protein |
| AT5G47180 | 7.70327464 | Plant VAMP (vesicle-associated membrane protein) family protein |
| AT4G22710 | 7.6672226 | cytochrome P450%2C family 706%2C subfamily A%2C polypeptide 2 |
| AT5G09670 | 7.655656762 | loricrin-like protein |
| AT4G19520 | 7.650425306 | disease resistance protein (TIR-NBS-LRR class) family |
| AT2G41100 | 7.645372789 | Calcium-binding EF hand family protein |
| AT3G03125 | 7.525904049 | NA |
| AT2G18690 | 7.520278554 | transmembrane protein |
| AT1G17990 | 7.494186292 | FMN-linked oxidoreductases superfamily protein |
| AT5G53860 | 7.411146543 | embryo defective 2737 |
| AT5G42830 | 7.273138726 | HXXXD-type acyl-transferase family protein |
| AT3G26910 | 7.269798637 | hydroxyproline-rich glycoprotein family protein |
| AT3G10930 | 7.269066833 | hypothetical protein |
| AT3G62150 | 7.243746746 | P-glycoprotein 21 |
| AT1G14870 | 7.21066323 | PLANT CADMIUM RESISTANCE 2 |
| AT1G11310 | 7.18290893 | Seven transmembrane MLO family protein |
| AT5G10150 | 7.171582345 | UPSTREAM OF FLC protein (DUF966) |
| AT1G18020 | 7.147077933 | FMN-linked oxidoreductases superfamily protein |
| AT4G22890 | 7.143997002 | PGR5-LIKE A |
| AT4G33050 | 7.121318993 | calmodulin-binding family protein |
| AT5G66070 | 7.119310603 | RING/U-box superfamily protein |
| AT3G17700 | 7.107715146 | cyclic nucleotide-binding transporter 1 |
| AT3G08720 | 7.097712035 | serine/threonine protein kinase 2 |
| AT1G17420 | 7.090146372 | lipoxygenase 3 |
| AT2G25460 | 7.080615139 | EEIG1/EHBP1 protein amino-terminal domain protein |
| AT5G55600 | 7.044811321 | Agenet and bromo-adjacent homology (BAH) domain-containing protein |
| AT4G18020 | 7.012542468 | CheY-like two-component responsive regulator family protein |
| AT5G22250 | 6.968975017 | Polynucleotidyl transferase%2C ribonuclease H-like superfamily protein |
| AT4G39890 | 6.956427313 | RAB GTPase homolog H1C |
| AT2G27710 | 6.927801778 | 60S acidic ribosomal protein family |
| AT5G35330 | 6.91788705 | methyl-CPG-binding domain protein 02 |
| AT4G30910 | 6.887974062 | Cytosol aminopeptidase family protein |
| AT1G62300 | 6.843918926 | WRKY family transcription factor |
| AT5G43520 | 6.820239156 | Cysteine/Histidine-rich C1 domain family protein |
| AT3G62750 | 6.797139596 | beta glucosidase 8 |
| AT5G64250 | 6.780092484 | Aldolase-type TIM barrel family protein |
| AT2G41070 | 6.778008368 | Basic-leucine zipper (bZIP) transcription factor family protein |
| AT2G02170 | 6.767739472 | Remorin family protein |
| AT2G40140 | 6.753076168 | zinc finger (CCCH-type) family protein |
| AT5G66210 | 6.686993435 | calcium-dependent protein kinase 28 |
| AT2G02870 | 6.677542616 | Galactose oxidase/kelch repeat superfamily protein |
| AT1G71400 | 6.666655083 | receptor like protein 12 |
| AT5G45620 | 6.625275819 | Proteasome component (PCI) domain protein |
| AT1G07000 | 6.615203165 | exocyst subunit exo70 family protein B2 |
| AT2G44490 | 6.611958187 | Glycosyl hydrolase superfamily protein |
| AT1G67350 | 6.587009065 | NADH-ubiquinone oxidoreductase |
| AT4G20830 | 6.578722204 | FAD-binding Berberine family protein |
| AT1G24150 | 6.56506491 | formin homologue 4 |
| AT1G01060 | 6.499997061 | Homeodomain-like superfamily protein |
| AT3G47490 | 6.499507364 | HNH endonuclease |
| AT3G51390 | 6.489974931 | DHHC-type zinc finger family protein |
| AT1G01340 | 6.477284434 | cyclic nucleotide gated channel 10 |
| AT1G21130 | 6.45980551 | O-methyltransferase family protein |
| AT2G34630 | 6.441460436 | geranyl diphosphate synthase 1 |
| AT3G53460 | 6.43754758 | chloroplast RNA-binding protein 29 |
| AT2G16860 | 6.435849359 | GCIP-interacting family protein |
| AT2G20960 | 6.425950945 | phospholipase-like protein (PEARLI 4) family protein |
| AT1G73805 | 6.347854958 | Calmodulin binding protein-like protein |
| AT3G52800 | 6.329765101 | A20/AN1-like zinc finger family protein |
| AT3G56410 | 6.329055196 | hypothetical protein (DUF3133) |
| AT3G26910 | 6.325818783 | hydroxyproline-rich glycoprotein family protein |
| AT2G39518 | 6.321736391 | Uncharacterized protein family (UPF0497) |
| AT3G52450 | 6.315239506 | plant U-box 22 |
| AT2G27500 | 6.313209173 | Glycosyl hydrolase superfamily protein |
| AT5G08275 | 6.235956547 | NA |
| AT1G28370 | 6.22525339 | ERF domain protein 11 |
| AT1G09060 | 6.207655412 | JmjC domain protein JMJ24 |
| AT4G02410 | 6.207460247 | Concanavalin A-like lectin protein kinase family protein |
| AT3G50260 | 6.207029279 | cooperatively regulated by ethylene and jasmonate 1 |
| AT5G13190 | 6.206481647 | GSH-induced LITAF domain protein |
| AT3G09020 | 6.192471154 | alpha 1%2C4-glycosyltransferase family protein |
| AT1G64065 | 6.103799834 | Late embryogenesis abundant (LEA) hydroxyproline-rich glycoprotein family |
| AT2G37940 | 6.081388161 | Inositol phosphorylceramide synthase 2 |
| AT1G52200 | 6.079772563 | PLAC8 family protein |
| AT4G22690 | 6.078384323 | cytochrome P450%2C family 706%2C subfamily A%2C polypeptide 1 |
| AT4G27280 | 6.076886043 | Calcium-binding EF-hand family protein |
| AT3G52748 | 6.054512358 | NA |
| AT1G53570 | 6.029448448 | mitogen-activated protein kinase kinase kinase 3 |
| AT3G21070 | 6.022614789 | NAD kinase 1 |
| AT1G74590 | 5.95480715 | glutathione S-transferase TAU 10 |
| AT5G40780 | 5.94360301 | lysine histidine transporter 1 |
| AT2G33710 | 5.922469601 | Integrase-type DNA-binding superfamily protein |
| AT1G71020 | 5.913818446 | ARM repeat superfamily protein |
| AT5G04340 | 5.913513576 | 6 |
| AT3G57530 | 5.891546454 | calcium-dependent protein kinase 32 |
| AT1G57990 | 5.885937006 | purine permease 18 |
| AT1G72920 | 5.84842012 | Toll-Interleukin-Resistance (TIR) domain family protein |
| AT1G27770 | 5.845076367 | autoinhibited Ca2+-ATPase 1 |
| AT5G64900 | 5.839845489 | precursor of peptide 1 |
| AT4G11521 | 5.834180765 | Receptor-like protein kinase-related family protein |
| AT2G41560 | 5.831032322 | autoinhibited Ca(2+)-ATPase%2C isoform 4 |
| AT4G28760 | 5.815191901 | methyl-coenzyme M reductase II subunit gamma%2C putative (DUF3741) |
| AT1G58180 | 5.814101473 | beta carbonic anhydrase 6 |
| AT4G29780 | 5.811570792 | nuclease |
| AT5G42030 | 5.805392473 | ABL interactor-like protein 4 |
| AT4G33050 | 5.765205863 | calmodulin-binding family protein |
| AT4G34460 | 5.750926214 | GTP binding protein beta 1 |
| AT1G28190 | 5.745219784 | hypothetical protein |
| AT1G06890 | 5.737219057 | nodulin MtN21 /EamA-like transporter family protein |
| AT1G64610 | 5.736464172 | Transducin/WD40 repeat-like superfamily protein |
| AT5G50670 | 5.734321478 | Squamosa promoter-binding protein-like (SBP domain) transcription factor family protein |
| AT1G51800 | 5.729007926 | Leucine-rich repeat protein kinase family protein |
| AT4G34240 | 5.724086559 | aldehyde dehydrogenase 311 |
| AT1G03370 | 5.702403493 | C2 calcium/lipid-binding and GRAM domain containing protein |
| AT1G51820 | 5.688281921 | Leucine-rich repeat protein kinase family protein |
| AT1G67060 | 5.686702148 | peptidase M50B-like protein |
| AT4G08850 | 5.65964547 | Leucine-rich repeat receptor-like protein kinase family protein |
| AT5G47960 | 5.655732701 | RAB GTPase homolog A4C |
| AT3G57230 | 5.633118864 | AGAMOUS-like 16 |
| AT2G46400 | 5.630173006 | WRKY DNA-binding protein 46 |
| AT1G02100 | 5.601324663 | Leucine carboxyl methyltransferase |
| AT2G43350 | 5.580484687 | glutathione peroxidase 3 |
| AT4G35480 | 5.560061985 | RING-H2 finger A3B |
| AT1G60440 | 5.540994598 | pantothenate kinase 1 |
| AT1G51850 | 5.516613498 | Leucine-rich repeat protein kinase family protein |
| AT2G13790 | 5.506307641 | somatic embryogenesis receptor-like kinase 4 |
| AT3G48500 | 5.484795414 | Nucleic acid-binding%2C OB-fold-like protein |
| AT5G66675 | 5.481375901 | transmembrane protein%2C putative (DUF677) |
| AT1G16130 | 5.467001547 | wall associated kinase-like 2 |
| AT5G17350 | 5.455796794 | hypothetical protein |
| AT1G52200 | 5.449641513 | PLAC8 family protein |
| AT1G14040 | 5.448802581 | EXS (ERD1/XPR1/SYG1) family protein |
| AT2G40110 | 5.446964084 | Yippee family putative zinc-binding protein |
| AT3G45640 | 5.441812013 | mitogen-activated protein kinase 3 |
| AT3G28850 | 5.420279418 | Glutaredoxin family protein |
| AT1G31420 | 5.418700645 | Leucine-rich repeat protein kinase family protein |
| AT1G02930 | 5.413972624 | glutathione S-transferase 6 |
| AT3G04210 | 5.390940514 | Disease resistance protein (TIR-NBS class) |
| AT1G72900 | 5.370022738 | Toll-Interleukin-Resistance (TIR) domain-containing protein |
| AT5G63530 | 5.356790073 | farnesylated protein 3 |
| AT5G64940 | 5.314327962 | ABC2 homolog 13 |
| AT5G54720 | 5.293985637 | Ankyrin repeat family protein |
| AT4G30280 | 5.245219401 | xyloglucan endotransglucosylase/hydrolase 18 |
| AT1G51700 | 5.239531838 | DOF zinc finger protein 1 |
| AT5G47910 | 5.232946799 | respiratory burst oxidase homologue D |
| AT1G23180 | 5.215139605 | ARM repeat superfamily protein |
| AT1G33600 | 5.183164759 | Leucine-rich repeat (LRR) family protein |
| AT1G65510 | 5.176040809 | transmembrane protein |
| AT2G23680 | 5.158086907 | Cold acclimation protein WCOR413 family |
| AT3G09940 | 5.154190301 | monodehydroascorbate reductase |
| AT5G67488 | 5.153595785 | NA |
| AT4G23550 | 5.152916212 | WRKY family transcription factor |
| AT1G32920 | 5.133489063 | hypothetical protein |
| AT1G07520 | 5.113008089 | GRAS family transcription factor |
| AT4G24920 | 5.106716453 | secE/sec61-gamma protein transport protein |
| AT2G32210 | 5.103690168 | cysteine-rich/transmembrane domain A-like protein |
| AT5G02690 | 5.07584411 | hypothetical protein |
| AT1G03740 | 5.072332292 | Protein kinase superfamily protein |
| AT5G44568 | 5.062306537 | transmembrane protein |
| AT5G15870 | 5.058586397 | glycosyl hydrolase family 81 protein |
| AT2G23770 | 5.054028678 | protein kinase family protein / peptidoglycan-binding LysM domain-containing protein |
| AT2G26530 | 5.053381872 | AR781%2C pheromone receptor-like protein (DUF1645) |
| AT3G13650 | 5.019441665 | Disease resistance-responsive (dirigent-like protein) family protein |
| AT5G48380 | 5.00132348 | BAK1-interacting receptor-like kinase 1 |
| AT5G22510 | 4.99884218 | alkaline/neutral invertase |
| AT3G04640 | 4.996775399 | glycine-rich protein |
| AT1G50740 | 4.967253629 | Transmembrane proteins 14C |
| AT1G11310 | 4.965282807 | Seven transmembrane MLO family protein |
| AT2G28830 | 4.945697098 | armadillo/beta-catenin repeat protein |
| AT1G76070 | 4.942278273 | hypothetical protein |
| AT2G46440 | 4.928817565 | cyclic nucleotide-gated channels |
| AT1G69900 | 4.917913414 | Actin cross-linking protein |
| AT3G11820 | 4.906541611 | syntaxin of plants 121 |
| AT5G21222 | 4.904222331 | protein kinase family protein |
| AT3G19010 | 4.889924969 | 2-oxoglutarate (2OG) and Fe(II)-dependent oxygenase superfamily protein |
| AT5G38210 | 4.884589898 | Protein kinase family protein |
| AT4G15530 | 4.860890611 | pyruvate orthophosphate dikinase |
| AT1G34260 | 4.846652015 | FORMS APLOID AND BINUCLEATE CELLS 1A |
| AT4G02200 | 4.830983482 | Drought-responsive family protein |
| AT5G03380 | 4.827778878 | Heavy metal transport/detoxification superfamily protein |
| AT3G52430 | 4.824105383 | alpha/beta-Hydrolases superfamily protein |
| AT3G16720 | 4.800800276 | TOXICOS EN LEVADURA 2 |
| AT3G12570 | 4.799325351 | FYD |
| AT1G56140 | 4.798093078 | Leucine-rich repeat transmembrane protein kinase |
| AT3G13435 | 4.790351027 | transmembrane protein |
| AT2G31010 | 4.787514549 | Protein kinase superfamily protein |
| AT5G22210 | 4.787127174 | aspartyl/glutamyl-tRNA (Asn/Gln) amidotransferase subunit B |
| AT1G68580 | 4.784976524 | Agenet and bromo-adjacent homology (BAH) domain-containing protein |
| AT3G19860 | 4.780627496 | basic helix-loop-helix (bHLH) DNA-binding superfamily protein |
| AT5G65050 | 4.76270424 | AGAMOUS-like 31 |
| AT1G21130 | 4.75790175 | O-methyltransferase family protein |
| AT3G55630 | 4.742705416 | DHFS-FPGS homolog D |
| AT5G46910 | 4.734758468 | Transcription factor jumonji (jmj) family protein / zinc finger (C5HC2 type) family protein |
| AT1G29670 | 4.734355527 | GDSL-like Lipase/Acylhydrolase superfamily protein |
| AT1G42990 | 4.721720024 | basic region/leucine zipper motif 60 |
| AT5G64660 | 4.707092071 | CYS%2C MET%2C PRO%2C and GLY protein 2 |
| AT1G55310 | 4.660468104 | SC35-like splicing factor 33 |
| AT3G59700 | 4.654638991 | lectin-receptor kinase |
| AT1G01260 | 4.642603861 | basic helix-loop-helix (bHLH) DNA-binding superfamily protein |
| AT3G46090 | 4.642071651 | C2H2 and C2HC zinc fingers superfamily protein |
| AT2G36220 | 4.631686673 | hypothetical protein |
| AT1G02880 | 4.601234685 | thiamin pyrophosphokinase1 |
| AT5G61160 | 4.581535118 | anthocyanin 5-aromatic acyltransferase 1 |
| AT4G16957 | 4.563186816 | SUPPRESSOR OF%2C CONSTITUTIVE protein |
| AT3G50950 | 4.561037755 | HOPZ-ACTIVATED RESISTANCE 1 |
| AT1G20823 | 4.559000443 | RING/U-box superfamily protein |
| AT5G64310 | 4.555753595 | arabinogalactan protein 1 |
| AT4G11850 | 4.55449572 | phospholipase D gamma 1 |
| AT3G01590 | 4.553983854 | Galactose mutarotase-like superfamily protein |
| AT1G11050 | 4.535411743 | Protein kinase superfamily protein |
| AT3G01770 | 4.531561129 | bromodomain and extraterminal domain protein 10 |
| AT2G19130 | 4.510115335 | S-locus lectin protein kinase family protein |
| AT1G66910 | 4.500961287 | Protein kinase superfamily protein |
| AT3G54420 | 4.498204721 | homolog of carrot EP3-3 chitinase |
| AT5G61010 | 4.48387674 | exocyst subunit exo70 family protein E2 |
| AT1G47740 | 4.47298563 | PPPDE putative thiol peptidase family protein |
| AT1G33610 | 4.468599978 | Leucine-rich repeat (LRR) family protein |
| AT3G44260 | 4.465947588 | Polynucleotidyl transferase%2C ribonuclease H-like superfamily protein |
| AT1G51270 | 4.459217662 | vesicle-associated protein 1-4 |
| AT3G28210 | 4.45661295 | zinc finger (AN1-like) family protein |
| AT5G49520 | 4.455193211 | WRKY DNA-binding protein 48 |
| AT4G14360 | 4.445133509 | S-adenosyl-L-methionine-dependent methyltransferases superfamily protein |
| AT1G28380 | 4.435399258 | MAC/Perforin domain-containing protein |
| AT3G45650 | 4.421245977 | nitrate excretion transporter1 |
| AT1G69890 | 4.408285805 | actin cross-linking protein (DUF569) |
| AT4G01700 | 4.404931687 | Chitinase family protein |
| AT1G77180 | 4.398320051 | chromatin protein family |
| AT5G41100 | 4.398265324 | hydroxyproline-rich glycoprotein family protein |
| AT1G07128 | 4.384243888 | NA |
| AT1G53280 | 4.383662701 | Class I glutamine amidotransferase-like superfamily protein |
| AT4G34390 | 4.382097074 | extra-large GTP-binding protein 2 |
| AT1G25220 | 4.379202369 | anthranilate synthase beta subunit 1 |
| AT1G25390 | 4.375229068 | Protein kinase superfamily protein |
| AT2G39210 | 4.367281386 | Major facilitator superfamily protein |
| AT4G39570 | 4.366645484 | Galactose oxidase/kelch repeat superfamily protein |
| AT2G28400 | 4.350711652 | senescence regulator (Protein of unknown function%2C DUF584) |
| AT1G79245 | 4.343633965 | NA |
| AT3G52150 | 4.341834846 | RNA-binding (RRM/RBD/RNP motifs) family protein |
| AT1G29690 | 4.331179574 | MAC/Perforin domain-containing protein |
| AT5G45430 | 4.323111754 | Protein kinase superfamily protein |
| AT5G22450 | 4.31957894 | spectrin beta chain%2C brain |
| AT5G03900 | 4.310326257 | Iron-sulfur cluster biosynthesis family protein |
| AT5G05540 | 4.290252578 | small RNA degrading nuclease 2 |
| AT5G54860 | 4.285713394 | Major facilitator superfamily protein |
| AT5G39580 | 4.273968178 | Peroxidase superfamily protein |
| AT3G15770 | 4.26629005 | hypothetical protein |
| AT5G53900 | 4.262643662 | Serine/threonine-protein kinase WNK (With No Lysine)-like protein |
| AT5G67420 | 4.24648079 | LOB domain-containing protein 37 |
| AT4G34150 | 4.238316106 | Calcium-dependent lipid-binding (CaLB domain) family protein |
| AT1G72930 | 4.233634546 | toll/interleukin-1 receptor-like protein |
| AT5G40170 | 4.231465116 | receptor like protein 54 |
| AT4G01250 | 4.228497967 | WRKY family transcription factor |
| AT2G47130 | 4.227374018 | NAD(P)-binding Rossmann-fold superfamily protein |
| AT5G12880 | 4.21744391 | proline-rich family protein |
| AT2G27020 | 4.217043872 | 20S proteasome alpha subunit G1 |
| AT1G30730 | 4.208942703 | FAD-binding Berberine family protein |
| AT1G23710 | 4.192806823 | hypothetical protein (DUF1645) |
| AT4G18880 | 4.188077356 | heat shock transcription factor A4A |
| AT2G23320 | 4.187975996 | WRKY DNA-binding protein 15 |
| AT1G11910 | 4.180111662 | aspartic proteinase A1 |
| AT5G64120 | 4.177774053 | Peroxidase superfamily protein |
| AT2G33580 | 4.173922655 | Protein kinase superfamily protein |
| AT1G80360 | 4.161845962 | Pyridoxal phosphate (PLP)-dependent transferases superfamily protein |
| AT3G57450 | 4.160167507 | hypothetical protein |
| AT4G18975 | 4.151824057 | Pentatricopeptide repeat (PPR) superfamily protein |
| AT3G02860 | 4.151616895 | zinc ion binding protein |
| AT1G67470 | 4.126886054 | Protein kinase superfamily protein |
| AT4G33050 | 4.113707393 | calmodulin-binding family protein |
| AT1G16110 | 4.113053201 | wall associated kinase-like 6 |
| AT1G31180 | 4.109495825 | isopropylmalate dehydrogenase 3 |
| AT1G49730 | 4.095872031 | Protein kinase superfamily protein |
| AT3G27960 | 4.089817787 | Tetratricopeptide repeat (TPR)-like superfamily protein |
| AT3G49530 | 4.082121582 | NAC domain containing protein 62 |
| AT2G22300 | 4.074339573 | signal responsive 1 |
| AT2G33480 | 4.071854579 | NAC domain containing protein 41 |
| AT2G16900 | 4.061177366 | phospholipase-like protein (PEARLI 4) family protein |
| AT1G33590 | 4.052526928 | Leucine-rich repeat (LRR) family protein |
| AT1G61340 | 4.037905785 | F-box family protein |
| AT3G26980 | 4.026676733 | membrane-anchored ubiquitin-fold protein 4 precursor |
| AT3G46590 | 4.025084861 | TRF-like 1 |
| AT5G12930 | 4.024369654 | inactive rhomboid protein |
| AT5G26030 | 4.010711969 | ferrochelatase 1 |
| AT5G58120 | 4.002374347 | Disease resistance protein (TIR-NBS-LRR class) family |
| AT1G07650 | 4.000538147 | Leucine-rich repeat transmembrane protein kinase |
| AT1G59590 | 3.989242733 | ZCF37 |
| AT3G54500 | 3.988607985 | agglutinin-like protein |
| AT1G70140 | 3.988586965 | formin 8 |
| AT1G25220 | 3.986848814 | anthranilate synthase beta subunit 1 |
| AT3G26680 | 3.971573574 | DNA repair metallo-beta-lactamase family protein |
| AT1G67480 | 3.969192033 | Galactose oxidase/kelch repeat superfamily protein |
| AT1G21100 | 3.951743665 | O-methyltransferase family protein |
| AT3G44860 | 3.947671329 | farnesoic acid carboxyl-O-methyltransferase |
| AT4G39030 | 3.942559159 | MATE efflux family protein |
| AT3G02750 | 3.938730542 | Protein phosphatase 2C family protein |
| AT2G47060 | 3.931677303 | Protein kinase superfamily protein |
| AT2G41430 | 3.930304409 | dehydration-induced protein (ERD15) |
| AT5G20090 | 3.929424675 | Uncharacterized protein family (UPF0041) |
| AT1G09940 | 3.928703705 | Glutamyl-tRNA reductase family protein |
| AT3G11560 | 3.926664587 | LETM1-like protein |
| AT1G23830 | 3.925773085 | transmembrane protein |
| AT2G38870 | 3.923298941 | Serine protease inhibitor%2C potato inhibitor I-type family protein |
| AT3G09940 | 3.916468651 | monodehydroascorbate reductase |
| AT1G59910 | 3.914148536 | Actin-binding FH2 (formin homology 2) family protein |
| AT4G27040 | 3.904027368 | EAP30/Vps36 family protein |
| AT3G21630 | 3.873979588 | chitin elicitor receptor kinase 1 |
| AT5G24230 | 3.873671134 | Lipase class 3-related protein |
| AT5G22690 | 3.871724317 | Disease resistance protein (TIR-NBS-LRR class) family |
| AT3G51450 | 3.865576429 | Calcium-dependent phosphotriesterase superfamily protein |
| AT5G05190 | 3.860775252 | hypothetical protein (DUF3133) |
| AT4G11300 | 3.859661116 | ROH1%2C putative (DUF793) |
| AT5G44820 | 3.851325042 | Nucleotide-diphospho-sugar transferase family protein |
| AT4G01010 | 3.848597938 | cyclic nucleotide-gated channel 13 |
| AT3G01540 | 3.848575866 | DEAD box RNA helicase 1 |
| AT1G51620 | 3.822034621 | Protein kinase superfamily protein |
| AT1G19180 | 3.817382368 | jasmonate-zim-domain protein 1 |
| AT5G06980 | 3.816111862 | hypothetical protein |
| AT1G74330 | 3.793184586 | Protein kinase superfamily protein |
| AT5G59730 | 3.790238325 | exocyst subunit exo70 family protein H7 |
| AT1G31540 | 3.787814605 | Disease resistance protein (TIR-NBS-LRR class) family |
| AT1G29850 | 3.780520285 | double-stranded DNA-binding family protein |
| AT1G54920 | 3.778843382 | hypothetical protein |
| AT4G18170 | 3.772372767 | WRKY DNA-binding protein 28 |
| AT2G26280 | 3.771610709 | CTC-interacting domain 7 |
| AT1G78860 | 3.765576245 | D-mannose binding lectin protein with Apple-like carbohydrate-binding domain-containing protein |
| AT1G67530 | 3.762455355 | ARM repeat superfamily protein |
| AT5G36220 | 3.75745122 | cytochrome p450 81d1 |
| AT5G14420 | 3.753334705 | RING domain ligase2 |
| AT3G18690 | 3.752515394 | MAP kinase substrate 1 |
| AT3G13440 | 3.75164551 | S-adenosyl-L-methionine-dependent methyltransferases superfamily protein |
| AT4G26700 | 3.733163046 | fimbrin 1 |
| AT2G41880 | 3.730265041 | guanylate kinase 1 |
| AT1G01240 | 3.730155689 | transmembrane protein |
| AT2G29720 | 3.727128983 | FAD/NAD(P)-binding oxidoreductase family protein |
| AT1G05890 | 3.705778277 | RING/U-box superfamily protein |
| AT2G46620 | 3.70494556 | P-loop containing nucleoside triphosphate hydrolases superfamily protein |
| AT1G03860 | 3.696017284 | prohibitin 2 |
| AT4G00970 | 3.691975837 | cysteine-rich RLK (RECEPTOR-like protein kinase) 41 |
| AT1G06002 | 3.683282944 | NA |
| AT4G06746 | 3.68101253 | related to AP2 9 |
| AT1G03220 | 3.657474881 | Eukaryotic aspartyl protease family protein |
| AT1G65510 | 3.651568009 | transmembrane protein |
| AT3G47570 | 3.647532056 | Leucine-rich repeat protein kinase family protein |
| AT5G52830 | 3.63531673 | WRKY DNA-binding protein 27 |
| AT1G05000 | 3.623859696 | Phosphotyrosine protein phosphatases superfamily protein |
| AT1G33590 | 3.604393672 | Leucine-rich repeat (LRR) family protein |
| AT4G10970 | 3.602280037 | ribosome maturation factor |
| ATCG00010 | 3.599624567 | NA |
| AT4G12120 | 3.599010558 | Sec1/munc18-like (SM) proteins superfamily |
| AT3G08710 | 3.597667393 | thioredoxin H-type 9 |
| AT4G31170 | 3.585162605 | Protein kinase superfamily protein |
| AT2G07340 | 3.560607587 | PREFOLDIN 1 |
| AT2G27500 | 3.545388554 | Glycosyl hydrolase superfamily protein |
| AT5G46050 | 3.54499684 | peptide transporter 3 |
| AT2G31230 | 3.544482255 | ethylene-responsive element binding factor 15 |
| AT3G09920 | 3.531769139 | phosphatidyl inositol monophosphate 5 kinase |
| AT2G31945 | 3.526318315 | transmembrane protein |
| AT2G47900 | 3.523720774 | tubby like protein 3 |
| AT3G58490 | 3.520657525 | Phosphatidic acid phosphatase (PAP2) family protein |
| AT3G10640 | 3.516519243 | SNF7 family protein |
| AT1G20510 | 3.514822395 | OPC-8:0 CoA ligase1 |
| ATCG00310 | 3.514032707 | NA |
| AT5G42740 | 3.513930304 | Sugar isomerase (SIS) family protein |
| AT5G02290 | 3.499806257 | Protein kinase superfamily protein |
| AT1G27020 | 3.495528035 | plant/protein |
| AT1G14370 | 3.494642007 | protein kinase 2A |
| AT2G40860 | 3.491998576 | protein kinase family protein / protein phosphatase 2C (PP2C) family protein |
| AT1G16670 | 3.474210164 | Protein kinase superfamily protein |
| AT4G22470 | 3.469064134 | protease inhibitor/seed storage/lipid transfer protein (LTP) family protein |
| AT4G02380 | 3.460717167 | senescence-associated gene 21 |
| AT5G08790 | 3.450786126 | NAC (No Apical Meristem) domain transcriptional regulator superfamily protein |
| AT5G52200 | 3.449516998 | phosphoprotein phosphatase inhibitor |
| AT2G32190 | 3.440941121 | cysteine-rich/transmembrane domain A-like protein |
| AT4G32330 | 3.439678558 | TPX2 (targeting protein for Xklp2) protein family |
| AT2G24570 | 3.438554615 | WRKY DNA-binding protein 17 |
| AT4G02540 | 3.432095617 | Cysteine/Histidine-rich C1 domain family protein |
| AT1G63830 | 3.426453488 | PLAC8 family protein |
| AT3G14930 | 3.422562462 | Uroporphyrinogen decarboxylase |
| AT4G32530 | 3.408525262 | ATPase%2C F0/V0 complex%2C subunit C protein |
| AT5G47590 | 3.407037536 | Heat shock protein HSP20/alpha crystallin family |
| AT1G51790 | 3.399885229 | Leucine-rich repeat protein kinase family protein |
| AT4G16420 | 3.399400336 | ADA2 2B |
| AT4G01995 | 3.396122618 | beta-carotene isomerase D27 |
| AT2G15480 | 3.385067429 | UDP-glucosyl transferase 73B5 |
| AT3G07780 | 3.375154824 | potyvirus VPg interacting protein (DUF1423) |
| AT4G24730 | 3.37157929 | manganese-dependent ADP-ribose/CDP-alcohol diphosphatase-like protein |
| AT1G66160 | 3.36960057 | CYS%2C MET%2C PRO%2C and GLY protein 1 |
| AT3G05580 | 3.341830346 | Calcineurin-like metallo-phosphoesterase superfamily protein |
| AT4G24380 | 3.340905188 | dihydrofolate reductase |
| AT5G13080 | 3.33498345 | WRKY DNA-binding protein 75 |
| AT2G26690 | 3.333211757 | Major facilitator superfamily protein |
| AT3G57050 | 3.325842142 | cystathionine beta-lyase |
| AT2G32240 | 3.32551212 | early endosome antigen |
| AT5G23890 | 3.324207783 | GPI-anchored adhesin-like protein |
| AT3G59080 | 3.320418725 | Eukaryotic aspartyl protease family protein |
| AT4G02330 | 3.319673131 | Plant invertase/pectin methylesterase inhibitor superfamily |
| AT5G06320 | 3.318378879 | NDR1/HIN1-like 3 |
| AT5G46510 | 3.318115716 | Disease resistance protein (TIR-NBS-LRR class) family |
| AT5G44870 | 3.306546242 | Disease resistance protein (TIR-NBS-LRR class) family |
| AT3G08650 | 3.304967518 | ZIP metal ion transporter family |
| AT1G72060 | 3.302141054 | serine-type endopeptidase inhibitor |
| AT3G46280 | 3.301258484 | kinase-like protein |
| AT5G44582 | 3.297862655 | hypothetical protein |
| AT4G35110 | 3.291875158 | phospholipase-like protein (PEARLI 4) family protein |
| AT4G08470 | 3.281867064 | MAPK/ERK kinase kinase 3 |
| AT2G47640 | 3.277035482 | Small nuclear ribonucleoprotein family protein |
| AT2G25840 | 3.274561247 | Nucleotidylyl transferase superfamily protein |
| AT1G56510 | 3.269335682 | Disease resistance protein (TIR-NBS-LRR class) |
| AT2G46800 | 3.260789008 | zinc transporter |
| AT1G79245 | 3.253641658 | NA |
| AT1G79940 | 3.246722502 | DnaJ / Sec63 Brl domains-containing protein |
| AT4G14220 | 3.246198128 | RING-H2 group F1A |
| AT1G08930 | 3.237137596 | Major facilitator superfamily protein |
| AT1G19770 | 3.237056938 | purine permease 14 |
| AT4G23270 | 3.227719092 | cysteine-rich RLK (RECEPTOR-like protein kinase) 19 |
| AT4G25640 | 3.22670427 | detoxifying efflux carrier 35 |
| AT2G41380 | 3.225544077 | S-adenosyl-L-methionine-dependent methyltransferases superfamily protein |
| AT3G51920 | 3.213447069 | calmodulin 9 |
| AT1G22930 | 3.212915434 | T-complex protein 11 |
| AT4G01950 | 3.211505504 | glycerol-3-phosphate acyltransferase 3 |
| AT1G15750 | 3.197555034 | Transducin family protein / WD-40 repeat family protein |
| AT1G19380 | 3.191984532 | sugar%2C putative (DUF1195) |
| AT3G44630 | 3.189665624 | Disease resistance protein (TIR-NBS-LRR class) family |
| AT5G38510 | 3.183173431 | Rhomboid-related intramembrane serine protease family protein |
| AT5G66210 | 3.181986058 | calcium-dependent protein kinase 28 |
| AT5G22620 | 3.180984138 | phosphoglycerate/bisphosphoglycerate mutase family protein |
| AT5G18470 | 3.180385532 | Curculin-like (mannose-binding) lectin family protein |
| AT4G20110 | 3.177591419 | VACUOLAR SORTING RECEPTOR 7 |
| AT4G39640 | 3.175852344 | gamma-glutamyl transpeptidase 1 |
| AT2G41100 | 3.173509809 | Calcium-binding EF hand family protein |
| AT5G44060 | 3.169356323 | embryo sac development arrest protein |
| AT1G63720 | 3.164254219 | hydroxyproline-rich glycoprotein family protein |
| AT1G65486 | 3.163881933 | transmembrane protein |
| AT3G50470 | 3.163556041 | homolog of RPW8 3 |
| AT1G65845 | 3.163067139 | transmembrane protein |
| AT1G63680 | 3.162162184 | ALBINO OR PALE-GREEN 13 |
| AT2G17540 | 3.156958546 | hypothetical protein |
| AT3G14830 | 3.154886493 | epstein-barr nuclear antigen |
| AT1G17130 | 3.149566541 | coiled-coil protein (DUF572) |
| AT2G17120 | 3.147602873 | lysm domain GPI-anchored protein 2 precursor |
| AT4G19400 | 3.145521324 | Profilin family protein |
| AT5G36290 | 3.139418427 | Uncharacterized protein family (UPF0016) |
| AT3G29290 | 3.133702994 | Pentatricopeptide repeat (PPR) superfamily protein |
| AT5G61220 | 3.133377193 | LYR family of Fe/S cluster biogenesis protein |
| AT1G78850 | 3.130243724 | D-mannose binding lectin protein with Apple-like carbohydrate-binding domain-containing protein |
| AT3G22060 | 3.129962291 | Receptor-like protein kinase-related family protein |
| AT4G34180 | 3.12587502 | Cyclase family protein |
| AT3G55770 | 3.116156144 | GATA type zinc finger transcription factor family protein |
| AT1G72940 | 3.112494289 | Toll-Interleukin-Resistance (TIR) domain-containing protein |
| AT5G54490 | 3.10505348 | pinoid-binding protein 1 |
| AT5G66310 | 3.10091682 | ATP binding microtubule motor family protein |
| AT1G74330 | 3.100802734 | Protein kinase superfamily protein |
| AT3G47550 | 3.08871315 | RING/FYVE/PHD zinc finger superfamily protein |
| AT2G29650 | 3.083675073 | phosphate transporter 4%3B1 |
| AT1G69840 | 3.079351752 | SPFH/Band 7/PHB domain-containing membrane-associated protein family |
| AT4G24160 | 3.078586938 | alpha/beta-Hydrolases superfamily protein |
| AT5G53550 | 3.076562518 | YELLOW STRIPE like 3 |
| AT1G72910 | 3.069737948 | Toll-Interleukin-Resistance (TIR) domain-containing protein |
| AT1G68580 | 3.066780428 | Agenet and bromo-adjacent homology (BAH) domain-containing protein |
| AT4G16950 | 3.057717226 | Disease resistance protein (TIR-NBS-LRR class) family |
| AT4G38930 | 3.057079008 | Ubiquitin fusion degradation UFD1 family protein |
| AT5G04375 | 3.056546514 | NA |
| AT1G79075 | 3.054769327 | NA |
| AT1G61360 | 3.052067407 | S-locus lectin protein kinase family protein |
| AT1G03740 | 3.045861001 | Protein kinase superfamily protein |
| AT3G26430 | 3.041714844 | GDSL-like Lipase/Acylhydrolase superfamily protein |
| AT1G65390 | 3.035922259 | phloem protein 2 A5 |
| AT1G76680 | 3.034519113 | 12-oxophytodienoate reductase 1 |
| AT3G29160 | 3.033895554 | SNF1 kinase homolog 11 |
| AT4G30210 | 3.027691239 | P450 reductase 2 |
| AT1G10340 | 3.020133308 | Ankyrin repeat family protein |
| AT4G38545 | 3.017156914 | NA |
| AT4G36860 | 3.016673818 | LIM domain-containing protein |
| AT5G41700 | 3.006151357 | ubiquitin conjugating enzyme 8 |
| AT3G28340 | 3.005016896 | galacturonosyltransferase-like 10 |
| AT5G57035 | 3.001760999 | U-box domain-containing protein kinase family protein |
| AT1G42540 | 2.999617194 | glutamate receptor 3.3 |
| AT2G23810 | 2.999596655 | tetraspanin8 |
| AT1G71697 | 2.997371446 | choline kinase 1 |
| AT1G18160 | 2.99125898 | Protein kinase superfamily protein |
| AT2G44380 | 2.988964877 | Cysteine/Histidine-rich C1 domain family protein |
| AT5G60410 | 2.987001031 | DNA-binding protein with MIZ/SP-RING zinc finger%2C PHD-finger and SAP domain-containing protein |
| AT4G22820 | 2.984798719 | A20/AN1-like zinc finger family protein |
| AT4G11330 | 2.981055248 | MAP kinase 5 |
| AT1G66500 | 2.979618033 | Pre-mRNA cleavage complex II |
| AT5G67440 | 2.979591291 | Phototropic-responsive NPH3 family protein |
| AT3G46600 | 2.97637757 | GRAS family transcription factor |
| AT4G23100 | 2.976073985 | glutamate-cysteine ligase |
| AT5G58575 | 2.972992254 | SAGA-associated factor-like protein |
| AT5G61210 | 2.971409478 | soluble N-ethylmaleimide-sensitive factor adaptor protein 33 |
| AT4G13395 | 2.965344609 | ROTUNDIFOLIA like 12 |
| AT5G59820 | 2.952309262 | C2H2-type zinc finger family protein |
| AT5G21105 | 2.948939131 | Plant L-ascorbate oxidase |
| AT3G44480 | 2.946201069 | Disease resistance protein (TIR-NBS-LRR class) family |
| AT1G53430 | 2.934009449 | Leucine-rich repeat transmembrane protein kinase |
| AT5G04830 | 2.931385395 | Nuclear transport factor 2 (NTF2) family protein |
| AT5G18310 | 2.929099717 | ubiquitin hydrolase |
| AT3G14870 | 2.926694945 | hypothetical protein (DUF641) |
| AT3G16220 | 2.922562665 | Putative eukaryotic LigT |
| AT3G49430 | 2.919036063 | SER/ARG-rich protein 34A |
| AT5G01220 | 2.916890671 | sulfoquinovosyldiacylglycerol 2 |
| AT4G24110 | 2.916464094 | NADP-specific glutamate dehydrogenase |
| AT1G76600 | 2.914933676 | poly polymerase |
| AT4G16890 | 2.912505481 | TIR-NBS-LRR class disease resistance protein |
| AT1G79245 | 2.902611996 | NA |
| AT5G54710 | 2.900200748 | Ankyrin repeat family protein |
| AT3G55170 | 2.897238635 | Ribosomal L29 family protein |
| AT1G10890 | 2.892254576 | arginine/glutamate-rich 1 protein |
| AT5G15730 | 2.887147549 | Protein kinase superfamily protein |
| AT4G25900 | 2.886519649 | Galactose mutarotase-like superfamily protein |
| AT1G18210 | 2.885569596 | Calcium-binding EF-hand family protein |
| AT5G38990 | 2.883576211 | Malectin/receptor-like protein kinase family protein |
| AT3G57550 | 2.88262393 | guanylate kinase |
| AT3G26020 | 2.881745168 | Protein phosphatase 2A regulatory B subunit family protein |
| AT1G73990 | 2.880370209 | signal peptide peptidase |
| AT4G24290 | 2.873439798 | MAC/Perforin domain-containing protein |
| ATCG00700 | 2.87265728 | photosystem II reaction center protein N |
| AT3G13460 | 2.870931758 | evolutionarily conserved C-terminal region 2 |
| AT1G04170 | 2.868131945 | eukaryotic translation initiation factor 2 gamma subunit |
| AT5G18310 | 2.86786412 | ubiquitin hydrolase |
| AT3G22460 | 2.865621305 | O-acetylserine (thiol) lyase (OAS-TL) isoform A2 |
| AT5G40540 | 2.864610162 | Protein kinase superfamily protein |
| AT1G03230 | 2.862919763 | Eukaryotic aspartyl protease family protein |
| AT1G30720 | 2.859835683 | FAD-binding Berberine family protein |
| AT4G17900 | 2.846990539 | PLATZ transcription factor family protein |
| AT5G65020 | 2.844045403 | annexin 2 |
| AT5G44610 | 2.836108081 | microtubule-associated protein 18 |
| AT1G74510 | 2.833725119 | Galactose oxidase/kelch repeat superfamily protein |
| AT3G28930 | 2.833049195 | AlG2-like (avirulence induced gene) family protein |
| AT5G08240 | 2.832766033 | transmembrane protein |
| AT4G20860 | 2.826225335 | FAD-binding Berberine family protein |
| AT4G21560 | 2.82306602 | vacuolar protein sorting-associated protein-like protein |
| AT4G23570 | 2.816480227 | phosphatase-like protein |
| AT1G65486 | 2.814462413 | transmembrane protein |
| AT5G10695 | 2.812357184 | methionyl-tRNA synthetase |
| AT5G58430 | 2.811137526 | exocyst subunit exo70 family protein B1 |
| AT5G62980 | 2.807956921 | Dihydroneopterin aldolase |
| AT4G17330 | 2.805002796 | G2484-1 protein |
| AT1G70410 | 2.801868838 | beta carbonic anhydrase 4 |
| AT5G46470 | 2.80115929 | disease resistance protein (TIR-NBS-LRR class) family |
| AT5G38720 | 2.791328827 | ribosomal RNA-processing 7 protein |
| AT2G20900 | 2.788239074 | diacylglycerol kinase 5 |
| AT4G02380 | 2.784007969 | senescence-associated gene 21 |
| AT5G17230 | 2.782089535 | PHYTOENE SYNTHASE |
| AT3G10720 | 2.778364131 | Plant invertase/pectin methylesterase inhibitor superfamily |
| AT3G63420 | 2.777263581 | Ggamma-subunit 1 |
| AT3G10260 | 2.772951088 | Reticulon family protein |
| AT2G35630 | 2.762199303 | ARM repeat superfamily protein |
| AT2G22660 | 2.759963293 | DNA-binding protein%2C putative (duplicated DUF1399) |
| AT3G50900 | 2.758668752 | hypothetical protein |
| AT5G23010 | 2.757504317 | methylthioalkylmalate synthase 1 |
| AT5G64240 | 2.757140516 | metacaspase 3 |
| AT3G25600 | 2.757126646 | Calcium-binding EF-hand family protein |
| AT2G44180 | 2.756922706 | methionine aminopeptidase 2A |
| AT4G25390 | 2.755689744 | Protein kinase superfamily protein |
| AT3G57530 | 2.755430588 | calcium-dependent protein kinase 32 |
| AT5G11670 | 2.748509076 | NADP-malic enzyme 2 |
| AT5G22320 | 2.746279554 | Leucine-rich repeat (LRR) family protein |
| AT1G18300 | 2.739356849 | nudix hydrolase homolog 4 |
| AT5G52040 | 2.733173978 | RNA-binding (RRM/RBD/RNP motifs) family protein |
| AT4G37640 | 2.730916735 | calcium ATPase 2 |
| AT3G19660 | 2.72860999 | hypothetical protein |
| AT1G51660 | 2.726338651 | mitogen-activated protein kinase kinase 4 |
| AT1G73080 | 2.725074494 | PEP1 receptor 1 |
| AT5G11970 | 2.724420396 | ABC family ABC transporter%2C putative (DUF3511) |
| AT5G22440 | 2.72344128 | Ribosomal protein L1p/L10e family |
| AT4G14350 | 2.72034164 | AGC (cAMP-dependent%2C cGMP-dependent and protein kinase C) kinase family protein |
| AT3G58640 | 2.718520246 | Mitogen activated protein kinase kinase kinase-like protein |
| AT3G13437 | 2.710290668 | transmembrane protein |
| AT2G41835 | 2.709978179 | zinc finger (C2H2 type%2C AN1-like) family protein |
| AT2G43810 | 2.708248067 | Small nuclear ribonucleoprotein family protein |
| AT1G10890 | 2.707419449 | arginine/glutamate-rich 1 protein |
| AT5G61910 | 2.707328868 | DCD (Development and Cell Death) domain protein |
| AT4G20830 | 2.707245691 | FAD-binding Berberine family protein |
| AT5G63790 | 2.70658462 | NAC domain containing protein 102 |
| AT4G38930 | 2.704851581 | Ubiquitin fusion degradation UFD1 family protein |
| AT4G39230 | 2.702084989 | NmrA-like negative transcriptional regulator family protein |
| AT3G50480 | 2.700802224 | homolog of RPW8 4 |
| AT3G25070 | 2.69744736 | RPM1 interacting protein 4 |
| AT2G21300 | 2.697108103 | ATP binding microtubule motor family protein |
| AT4G19520 | 2.696728238 | disease resistance protein (TIR-NBS-LRR class) family |
| AT2G02860 | 2.696504939 | sucrose transporter 2 |
| AT1G70740 | 2.694106625 | Protein kinase superfamily protein |
| AT2G41010 | 2.691856858 | calmodulin (CAM)-binding protein of 25 kDa |
| AT4G26400 | 2.690825008 | RING/U-box superfamily protein |
| AT1G34320 | 2.689346469 | Ikzf5 (DUF668) |
| AT4G38360 | 2.679667991 | organic solute transporter ostalpha protein (DUF300) |
| AT5G47690 | 2.677997218 | binding protein |
| AT1G44575 | 2.665886936 | Chlorophyll A-B binding family protein |
| AT5G20180 | 2.660843241 | Ribosomal protein L36 |
| AT1G80610 | 2.660524192 | hypothetical protein |
| AT1G64710 | 2.657503072 | GroES-like zinc-binding alcohol dehydrogenase family protein |
| AT3G14150 | 2.651885253 | Aldolase-type TIM barrel family protein |
| AT2G03730 | 2.646277126 | ACT domain repeat 5 |
| AT1G66920 | 2.63947165 | Protein kinase superfamily protein |
| AT5G55530 | 2.636915156 | Calcium-dependent lipid-binding (CaLB domain) family protein |
| AT4G38540 | 2.636559144 | FAD/NAD(P)-binding oxidoreductase family protein |
| AT3G29034 | 2.634518359 | transmembrane protein |
| AT5G41180 | 2.633196664 | leucine-rich repeat transmembrane protein kinase family protein |
| AT1G27450 | 2.631880243 | adenine phosphoribosyl transferase 1 |
| AT1G69750 | 2.629533564 | cytochrome c oxidase 19-2 |
| AT5G40920 | 2.627752891 | NA |
| AT1G70620 | 2.625771584 | cyclin-like protein |
| AT3G01480 | 2.624542143 | cyclophilin 38 |
| AT5G25170 | 2.622504442 | PPPDE putative thiol peptidase family protein |
| AT1G58025 | 2.622125045 | DNA-binding bromodomain-containing protein |
| AT5G62570 | 2.617761938 | Calmodulin binding protein-like protein |
| AT2G17705 | 2.617553195 | methionine-S-oxide reductase |
| AT3G57550 | 2.611139174 | guanylate kinase |
| AT3G63340 | 2.605466739 | kinase superfamily protein |
| AT3G15210 | 2.604936904 | ethylene responsive element binding factor 4 |
| AT1G32410 | 2.597186434 | Vacuolar protein sorting 55 (VPS55) family protein |
| AT5G66480 | 2.597014433 | bacteriophage N4 adsorption B protein |
| AT1G04200 | 2.591836036 | dyggve-melchior-clausen syndrome protein |
| AT5G64130 | 2.587268688 | cAMP-regulated phosphoprotein 19-related protein |
| AT2G17220 | 2.585934276 | Protein kinase superfamily protein |
| AT5G01830 | 2.585041879 | ARM repeat superfamily protein |
| AT1G58807 | 2.58355474 | Disease resistance protein (CC-NBS-LRR class) family |
| AT3G28940 | 2.579055769 | AlG2-like (avirulence induced gene) family protein |
| AT3G55450 | 2.578128016 | PBS1-like 1 |
| AT1G63750 | 2.578083127 | Disease resistance protein (TIR-NBS-LRR class) family |
| AT5G58240 | 2.572315563 | FRAGILE HISTIDINE TRIAD |
| AT5G20230 | 2.571024997 | blue-copper-binding protein |
| AT2G20724 | 2.569513169 | NA |
| AT1G53780 | 2.561706535 | 26S proteasome regulatory complex ATPase |
| AT3G12740 | 2.558035209 | ALA-interacting subunit 1 |
| AT5G03380 | 2.553813399 | Heavy metal transport/detoxification superfamily protein |
| AT2G27710 | 2.553690456 | 60S acidic ribosomal protein family |
| AT5G16505 | 2.553646968 | NA |
| AT1G61040 | 2.550578179 | plus-3 domain-containing protein |
| AT2G04039 | 2.549777225 | DUF2996 family protein |
| AT5G03700 | 2.548488424 | D-mannose binding lectin protein with Apple-like carbohydrate-binding domain-containing protein |
| AT4G25690 | 2.548467451 | stress response NST1-like protein |
| AT1G12230 | 2.543219463 | Aldolase superfamily protein |
| AT5G44575 | 2.539779966 | hypothetical protein |
| AT3G53810 | 2.538998289 | Concanavalin A-like lectin protein kinase family protein |
| AT1G15530 | 2.537334036 | Concanavalin A-like lectin protein kinase family protein |
| AT4G19420 | 2.536054318 | Pectinacetylesterase family protein |
| AT1G77500 | 2.535700103 | DUF630 family protein%2C putative (DUF630 and DUF632) |
| AT1G59124 | 2.535102621 | Disease resistance protein (CC-NBS-LRR class) family |
| AT3G49350 | 2.533578789 | Ypt/Rab-GAP domain of gyp1p superfamily protein |
| AT5G48220 | 2.525898859 | Aldolase-type TIM barrel family protein |
| AT1G27450 | 2.522899687 | adenine phosphoribosyl transferase 1 |
| AT1G13060 | 2.522237674 | 20S proteasome beta subunit E1 |
| AT5G19230 | 2.517490168 | Glycoprotein membrane precursor GPI-anchored |
| AT3G22600 | 2.515820253 | Bifunctional inhibitor/lipid-transfer protein/seed storage 2S albumin superfamily protein |
| AT5G10740 | 2.515318416 | Protein phosphatase 2C family protein |
| AT1G10590 | 2.512118833 | Nucleic acid-binding%2C OB-fold-like protein |
| AT1G79700 | 2.511792028 | Integrase-type DNA-binding superfamily protein |
| AT1G53440 | 2.510946459 | Leucine-rich repeat transmembrane protein kinase |
| AT1G59124 | 2.509020006 | Disease resistance protein (CC-NBS-LRR class) family |
| AT2G46750 | 2.507356234 | D-arabinono-1%2C4-lactone oxidase family protein |
| AT1G21010 | 2.505689257 | poly polymerase |
| AT3G60415 | 2.503730804 | phosphoglycerate mutase family protein |
| AT5G04870 | 2.500784254 | calcium dependent protein kinase 1 |
| AT3G63120 | 2.499391087 | cyclin p1%3B1 |
| AT5G46330 | 2.498669989 | Leucine-rich receptor-like protein kinase family protein |
| AT2G39660 | 2.498165175 | botrytis-induced kinase1 |
| AT5G62070 | 2.494864526 | IQ-domain 23 |
| AT5G13800 | 2.494548548 | pheophytinase |
| AT1G76700 | 2.493267944 | DNAJ heat shock N-terminal domain-containing protein |
| AT2G43120 | 2.492460708 | RmIC-like cupins superfamily protein |
| AT1G03730 | 2.490291106 | pyrroline-5-carboxylate reductase |
| AT4G18950 | 2.486874983 | Integrin-linked protein kinase family |
| AT5G13190 | 2.486305781 | GSH-induced LITAF domain protein |
| AT4G33060 | 2.483558288 | Cyclophilin-like peptidyl-prolyl cis-trans isomerase family protein |
| AT3G55410 | 2.476428932 | 2-oxoglutarate dehydrogenase%2C E1 component |
| AT4G01090 | 2.474405181 | hypothetical protein (DUF3133) |
| AT5G47220 | 2.473688793 | ethylene responsive element binding factor 2 |
| AT1G70520 | 2.473292145 | cysteine-rich RLK (RECEPTOR-like protein kinase) 2 |
| AT2G19710 | 2.472697355 | Regulator of Vps4 activity in the MVB pathway protein |
| AT2G38170 | 2.472465069 | cation exchanger 1 |
| AT3G26210 | 2.4714621 | cytochrome P450%2C family 71%2C subfamily B%2C polypeptide 23 |
| AT4G21830 | 2.469229407 | methionine sulfoxide reductase B7 |
| AT1G35710 | 2.468127768 | kinase family with leucine-rich repeat domain-containing protein |
| AT5G04130 | 2.468006927 | DNA GYRASE B2 |
| AT3G26100 | 2.467936378 | Regulator of chromosome condensation (RCC1) family protein |
| AT1G58807 | 2.466428691 | Disease resistance protein (CC-NBS-LRR class) family |
| AT4G03020 | 2.451074744 | transducin family protein / WD-40 repeat family protein |
| AT3G14790 | 2.449906653 | rhamnose biosynthesis 3 |
| AT1G55920 | 2.44956807 | serine acetyltransferase 2%3B1 |
| AT3G04610 | 2.448959437 | RNA-binding KH domain-containing protein |
| AT5G49830 | 2.448453755 | exocyst complex component 84B |
| AT5G61560 | 2.435508081 | U-box domain-containing protein kinase family protein |
| AT2G30500 | 2.434994034 | Kinase interacting (KIP1-like) family protein |
| AT5G40370 | 2.431795169 | Glutaredoxin family protein |
| AT2G30020 | 2.431042639 | Protein phosphatase 2C family protein |
| AT5G47730 | 2.430142053 | Sec14p-like phosphatidylinositol transfer family protein |
| AT2G03390 | 2.426828265 | uvrB/uvrC motif-containing protein |
| AT2G40000 | 2.425088496 | ortholog of sugar beet HS1 PRO-1 2 |
| AT2G32260 | 2.424237831 | phosphorylcholine cytidylyltransferase |
| AT2G28910 | 2.4231195 | CAX interacting protein 4 |
| AT3G58510 | 2.423050928 | DEA(D/H)-box RNA helicase family protein |
| AT1G72070 | 2.422541309 | Chaperone DnaJ-domain superfamily protein |
| AT5G42050 | 2.419459716 | DCD (Development and Cell Death) domain protein |
| AT5G46710 | 2.41824551 | PLATZ transcription factor family protein |
| AT4G32300 | 2.417604428 | S-domain-2 5 |
| AT2G39420 | 2.416074738 | alpha/beta-Hydrolases superfamily protein |
| AT3G59350 | 2.410025823 | Protein kinase superfamily protein |
| AT1G20350 | 2.409303363 | translocase inner membrane subunit 17-1 |
| AT1G55520 | 2.408744146 | TATA binding protein 2 |
| AT5G59550 | 2.407036855 | zinc finger (C3HC4-type RING finger) family protein |
| AT4G10970 | 2.406443046 | ribosome maturation factor |
| AT4G14680 | 2.404337568 | Pseudouridine synthase/archaeosine transglycosylase-like family protein |
| AT5G24160 | 2.403983079 | squalene monooxygenase 6 |
| AT3G46620 | 2.403546576 | zinc finger (C3HC4-type RING finger) family protein |
| AT4G12720 | 2.401806601 | MutT/nudix family protein |
| AT2G27310 | 2.400238311 | F-box family protein |
| AT2G02220 | 2.396976654 | phytosulfokin receptor 1 |
| AT1G65500 | 2.395650582 | transmembrane protein |
| AT1G30520 | 2.395146218 | acyl-activating enzyme 14 |
| AT3G22370 | 2.393625986 | alternative oxidase 1A |
| AT1G17890 | 2.391835808 | NAD(P)-binding Rossmann-fold superfamily protein |
| AT2G39400 | 2.391239962 | alpha/beta-Hydrolases superfamily protein |
| AT4G34480 | 2.384602864 | O-Glycosyl hydrolases family 17 protein |
| AT5G05850 | 2.384253933 | plant intracellular ras group-related LRR 1 |
| AT3G55470 | 2.377727018 | Calcium-dependent lipid-binding (CaLB domain) family protein |
| AT3G53610 | 2.377440455 | RAB GTPase homolog 8 |
| AT1G70530 | 2.376908706 | cysteine-rich RLK (RECEPTOR-like protein kinase) 3 |
| AT1G06110 | 2.375311772 | SKP1/ASK-interacting protein 16 |
| AT1G75020 | 2.373541145 | lysophosphatidyl acyltransferase 4 |
| AT2G42890 | 2.372124914 | MEI2-like 2 |
| AT2G34930 | 2.370925492 | disease resistance family protein / LRR family protein |
| AT4G32020 | 2.365656793 | serine/arginine repetitive matrix-like protein |
| AT2G30720 | 2.36263378 | Thioesterase/thiol ester dehydrase-isomerase superfamily protein |
| AT4G32420 | 2.36259104 | Cyclophilin-like peptidyl-prolyl cis-trans isomerase family protein |
| AT5G11650 | 2.360278142 | alpha/beta-Hydrolases superfamily protein |
| AT1G70770 | 2.358455956 | transmembrane protein (Protein of unknown function DUF2359%2C transmembrane) |
| AT1G78620 | 2.357536648 | integral membrane protein (Protein of unknown function DUF92%2C transmembrane) |
| AT4G09570 | 2.353591821 | calcium-dependent protein kinase 4 |
| AT1G17330 | 2.352277475 | Metal-dependent phosphohydrolase |
| AT2G02960 | 2.351033792 | RING/FYVE/PHD zinc finger superfamily protein |
| AT2G42330 | 2.349783865 | GC-rich sequence DNA-binding factor-like protein with Tuftelin interacting domain-containing protein |
| AT1G32928 | 2.349287268 | Avr9/Cf-9 rapidly elicited protein |
| AT1G25400 | 2.346884795 | transmembrane protein |
| AT3G05200 | 2.346746849 | RING/U-box superfamily protein |
| AT2G15000 | 2.346078334 | caspase-6 protein |
| AT1G52360 | 2.346031264 | Coatomer%2C beta’ subunit |
| AT2G41640 | 2.344640305 | Glycosyltransferase family 61 protein |
| AT1G53380 | 2.344334113 | hypothetical protein (DUF641) |
| AT1G55530 | 2.344207524 | RING/U-box superfamily protein |
| AT2G36690 | 2.343724267 | 2-oxoglutarate (2OG) and Fe(II)-dependent oxygenase superfamily protein |
| AT1G03250 | 2.343346846 | R3H domain protein |
| AT3G19580 | 2.34246147 | zinc-finger protein 2 |
| AT1G64385 | 2.341216995 | transmembrane protein |
| AT1G26440 | 2.34010477 | ureide permease 5 |
| AT3G26680 | 2.338672294 | DNA repair metallo-beta-lactamase family protein |
| AT2G32690 | 2.338364329 | glycine-rich protein 23 |
| AT1G78830 | 2.336633173 | Curculin-like (mannose-binding) lectin family protein |
| AT3G05935 | 2.336029057 | hypothetical protein |
| AT5G18490 | 2.335179552 | vacuolar sorting-associated protein (DUF946) |
| AT3G23550 | 2.327739559 | MATE efflux family protein |
| AT5G24210 | 2.325723519 | alpha/beta-Hydrolases superfamily protein |
| AT2G04040 | 2.323691257 | MATE efflux family protein |
| AT3G22930 | 2.323519771 | calmodulin-like 11 |
| AT4G38940 | 2.323367302 | Galactose oxidase/kelch repeat superfamily protein |
| AT5G67385 | 2.323154825 | Phototropic-responsive NPH3 family protein |
| AT3G14990 | 2.321530826 | Class I glutamine amidotransferase-like superfamily protein |
| AT2G30870 | 2.320586181 | glutathione S-transferase PHI 10 |
| AT3G03020 | 2.320534596 | hypothetical protein |
| AT3G29400 | 2.319989784 | exocyst subunit exo70 family protein E1 |
| AT3G44720 | 2.31788046 | arogenate dehydratase 4 |
| AT1G09970 | 2.317202379 | Leucine-rich receptor-like protein kinase family protein |
| AT5G20050 | 2.315078288 | Protein kinase superfamily protein |
| AT3G56510 | 2.314446411 | RNA-binding (RRM/RBD/RNP motifs) family protein |
| AT2G05440 | 2.310627843 | GLYCINE RICH PROTEIN 9 |
| AT1G50440 | 2.308330818 | RING/FYVE/PHD zinc finger superfamily protein |
| AT3G48090 | 2.306346595 | alpha/beta-Hydrolases superfamily protein |
| AT1G60430 | 2.296179048 | actin-related protein C3 |
| AT1G52380 | 2.29077228 | NUP50 (Nucleoporin 50 kDa) protein |
| AT2G34410 | 2.288398408 | O-acetyltransferase family protein |
| AT3G44670 | 2.285993365 | Disease resistance protein (TIR-NBS-LRR class) family |
| AT1G61820 | 2.285288651 | beta glucosidase 46 |
| AT3G45630 | 2.285264415 | RNA binding (RRM/RBD/RNP motifs) family protein |
| AT1G51270 | 2.281239283 | vesicle-associated protein 1-4 |
| AT1G34750 | 2.278335299 | Protein phosphatase 2C family protein |
| AT5G26340 | 2.275818245 | Major facilitator superfamily protein |
| AT2G42320 | 2.274245397 | nucleolar protein gar2-like protein |
| AT2G20830 | 2.273033134 | folic acid binding / transferase |
| AT4G30530 | 2.271775584 | Class I glutamine amidotransferase-like superfamily protein |
| AT4G28400 | 2.270288045 | Protein phosphatase 2C family protein |
| AT1G79670 | 2.268744685 | Wall-associated kinase family protein |
| AT3G02740 | 2.268683517 | Eukaryotic aspartyl protease family protein |
| AT5G67350 | 2.26394721 | hypothetical protein |
| AT5G45280 | 2.262177195 | Pectinacetylesterase family protein |
| AT4G33920 | 2.258790777 | Protein phosphatase 2C family protein |
| AT2G32660 | 2.258714421 | receptor like protein 22 |
| AT3G47000 | 2.257111738 | Glycosyl hydrolase family protein |
| AT5G01210 | 2.256540686 | HXXXD-type acyl-transferase family protein |
| AT2G28570 | 2.255681 | hypothetical protein |
| AT5G36700 | 2.255260431 | 2-phosphoglycolate phosphatase 1 |
| AT2G01340 | 2.254632717 | plastid movement impaired protein |
| AT5G02680 | 2.254574785 | methionine-tRNA ligase |
| AT1G79830 | 2.247460512 | golgin Putative 5 |
| AT2G25000 | 2.246137833 | WRKY DNA-binding protein 60 |
| AT4G01870 | 2.244305598 | tolB protein-like protein |
| AT5G10380 | 2.2362622 | RING/U-box superfamily protein |
| AT1G51805 | 2.235839566 | Leucine-rich repeat protein kinase family protein |
| AT3G24420 | 2.234105599 | alpha/beta-Hydrolases superfamily protein |
| AT2G44290 | 2.233694381 | Bifunctional inhibitor/lipid-transfer protein/seed storage 2S albumin superfamily protein |
| AT3G07190 | 2.233107228 | B-cell receptor-associated protein 31-like protein |
| AT4G36030 | 2.232081483 | armadillo repeat only 3 |
| AT3G17410 | 2.231271937 | Protein kinase superfamily protein |
| AT5G60270 | 2.231252205 | Concanavalin A-like lectin protein kinase family protein |
| AT1G07770 | 2.229196469 | ribosomal protein S15A |
| AT1G62790 | 2.226173722 | Bifunctional inhibitor/lipid-transfer protein/seed storage 2S albumin superfamily protein |
| AT4G01800 | 2.225434107 | Albino or Glassy Yellow 1 |
| AT3G21055 | 2.223633321 | photosystem II subunit T |
| AT5G10350 | 2.223570619 | RNA-binding (RRM/RBD/RNP motifs) family protein |
| AT5G18400 | 2.221662624 | Cytokine-induced anti-apoptosis inhibitor 1%2C Fe-S biogenesi |
| AT3G57330 | 2.219881016 | autoinhibited Ca2+-ATPase 11 |
| AT5G16880 | 2.217996438 | Target of Myb protein 1 |
| AT4G13860 | 2.21524102 | RNA-binding (RRM/RBD/RNP motifs) family protein |
| AT5G51460 | 2.215218765 | Haloacid dehalogenase-like hydrolase (HAD) superfamily protein |
| AT1G61140 | 2.21440274 | SNF2 domain-containing protein / helicase domain-containing protein / zinc finger protein-like protein |
| AT1G28280 | 2.213257169 | VQ motif-containing protein |
| AT5G44290 | 2.212222687 | Protein kinase superfamily protein |
| AT5G37370 | 2.211318798 | PRP38 family protein |
| AT2G07675 | 2.210298987 | Ribosomal protein S12/S23 family protein |
| AT5G43270 | 2.210170717 | squamosa promoter binding protein-like 2 |
| AT4G24990 | 2.208551055 | Ubiquitin family protein |
| AT2G34310 | 2.206802644 | hypothetical protein |
| AT3G12200 | 2.201051537 | NIMA-related kinase 7 |
| AT4G38520 | 2.197314977 | Protein phosphatase 2C family protein |
| AT2G03780 | 2.196352154 | Translin family protein |
| AT1G04833 | 2.195916791 | NA |
| AT3G01640 | 2.194584756 | glucuronokinase G |
| AT5G45250 | 2.193790874 | Disease resistance protein (TIR-NBS-LRR class) family |
| AT3G28450 | 2.192705007 | Leucine-rich repeat protein kinase family protein |
| AT2G43210 | 2.191919303 | Ubiquitin-like superfamily protein |
| AT4G08240 | 2.190099351 | histone-lysine N-methyltransferase |
| AT4G33300 | 2.189941442 | ADR1-like 1 |
| AT3G15760 | 2.189736852 | cytochrome P450 family protein |
| AT1G08940 | 2.188455445 | Phosphoglycerate mutase family protein |
| AT1G08450 | 2.18693876 | calreticulin 3 |
| AT4G23250 | 2.186453264 | cysteine-rich receptor-like protein kinase 17 |
| AT2G41430 | 2.185519721 | dehydration-induced protein (ERD15) |
| AT5G35370 | 2.184957898 | S-locus lectin protein kinase family protein |
| AT5G62020 | 2.183419668 | heat shock transcription factor B2A |
| AT4G36990 | 2.181453519 | heat shock factor 4 |
| AT5G63620 | 2.180458365 | GroES-like zinc-binding alcohol dehydrogenase family protein |
| AT4G16860 | 2.179668916 | Disease resistance protein (TIR-NBS-LRR class) family |
| ATCG00090 | 2.178043088 | NA |
| AT5G48630 | 2.177987093 | Cyclin family protein |
| AT2G38750 | 2.176588208 | annexin 4 |
| AT5G04550 | 2.175913502 | type-1 restriction enzyme mjaxp r protein (DUF668) |
| AT4G24340 | 2.174506064 | Phosphorylase superfamily protein |
| AT1G63860 | 2.174096658 | Disease resistance protein (TIR-NBS-LRR class) family |
| AT3G61700 | 2.171509784 | helicase with zinc finger protein |
| AT3G26720 | 2.168224826 | Glycosyl hydrolase family 38 protein |
| AT3G18830 | 2.168052387 | polyol/monosaccharide transporter 5 |
| ATMG00980 | 2.16750489 | Ribosomal protein S12/S23 family protein |
| AT3G46690 | 2.164369974 | UDP-Glycosyltransferase superfamily protein |
| AT3G07760 | 2.163693049 | Sterile alpha motif (SAM) domain-containing protein |
| AT1G60650 | 2.163022208 | RNA-binding (RRM/RBD/RNP motifs) family protein with retrovirus zinc finger-like domain-containing protein |
| AT1G08660 | 2.162308409 | MALE GAMETOPHYTE DEFECTIVE 2 |
| AT5G27760 | 2.161875231 | Hypoxia-responsive family protein |
| AT5G56850 | 2.161658702 | hypothetical protein |
| AT5G14930 | 2.160918392 | senescence-associated gene 101 |
| AT2G19620 | 2.160379113 | N-MYC downregulated-like 3 |
| AT3G57880 | 2.159145581 | Calcium-dependent lipid-binding (CaLB domain) plant phosphoribosyltransferase family protein |
| AT4G30850 | 2.159098664 | heptahelical transmembrane protein2 |
| AT3G48860 | 2.157477408 | coiled-coil protein |
| AT2G13650 | 2.156174068 | golgi nucleotide sugar transporter 1 |
| AT1G43850 | 2.15442264 | SEUSS transcriptional co-regulator |
| AT5G65920 | 2.15312372 | ARM repeat superfamily protein |
| AT4G10100 | 2.152955069 | co-factor for nitrate%2C reductase and xanthine dehydrogenase 7 |
| AT3G51660 | 2.152869414 | Tautomerase/MIF superfamily protein |
| AT2G45010 | 2.152276494 | PLAC8 family protein |
| AT2G05440 | 2.148256141 | GLYCINE RICH PROTEIN 9 |
| AT3G13080 | 2.14727191 | multidrug resistance-associated protein 3 |
| AT1G71820 | 2.145892485 | SEC6 |
| AT5G65620 | 2.144771797 | Zincin-like metalloproteases family protein |
| AT4G04960 | 2.144143114 | Concanavalin A-like lectin protein kinase family protein |
| AT3G60600 | 2.142215147 | vesicle associated protein |
| AT3G50950 | 2.137730224 | HOPZ-ACTIVATED RESISTANCE 1 |
| AT5G11000 | 2.137004241 | hypothetical protein (DUF868) |
| AT3G57280 | 2.133164381 | Transmembrane proteins 14C |
| AT1G22510 | 2.132094524 | E3 ubiquitin-protein ligase RNF170-like protein (DUF 1232) |
| AT5G43430 | 2.128882483 | electron transfer flavoprotein beta |
| AT1G07570 | 2.127889655 | Protein kinase superfamily protein |
| AT5G61820 | 2.125450187 | stress up-regulated Nod 19 protein |
| AT3G25780 | 2.123163834 | allene oxide cyclase 3 |
| AT3G01850 | 2.122146238 | Aldolase-type TIM barrel family protein |
| AT5G05210 | 2.121983292 | Surfeit locus protein 6 |
| AT3G57550 | 2.112663838 | guanylate kinase |
| AT4G21540 | 2.108493517 | sphingosine kinase 1 |
| AT3G19720 | 2.107486101 | P-loop containing nucleoside triphosphate hydrolases superfamily protein |
| AT3G01290 | 2.103300299 | SPFH/Band 7/PHB domain-containing membrane-associated protein family |
| AT3G54500 | 2.10219389 | agglutinin-like protein |
| AT2G21520 | 2.101544126 | Sec14p-like phosphatidylinositol transfer family protein |
| AT4G01960 | 2.098291563 | transmembrane protein |
| AT5G41700 | 2.092344944 | ubiquitin conjugating enzyme 8 |
| AT4G17230 | 2.091012452 | SCARECROW-like 13 |
| AT3G05520 | 2.090764503 | Subunits of heterodimeric actin filament capping protein Capz superfamily |
| AT3G01850 | 2.090092688 | Aldolase-type TIM barrel family protein |
| AT4G00420 | 2.088664626 | Double-stranded RNA-binding domain (DsRBD)-containing protein |
| AT1G79850 | 2.087681592 | ribosomal protein S17 |
| AT1G50600 | 2.08759268 | scarecrow-like 5 |
| AT2G01060 | 2.087450403 | myb-like HTH transcriptional regulator family protein |
| AT1G02145 | 2.086344118 | homolog of asparagine-linked glycosylation 12 |
| AT1G60730 | 2.08623095 | NAD(P)-linked oxidoreductase superfamily protein |
| AT5G54810 | 2.08603135 | tryptophan synthase beta-subunit 1 |
| AT2G47630 | 2.085095315 | alpha/beta-Hydrolases superfamily protein |
| AT3G10250 | 2.083185269 | histidine-tRNA ligase |
| AT4G39363 | 2.081956289 | NA |
| AT5G66900 | 2.081566239 | Disease resistance protein (CC-NBS-LRR class) family |
| AT1G19650 | 2.08007881 | Sec14p-like phosphatidylinositol transfer family protein |
| AT5G37480 | 2.078639315 | maltase-glucoamylase%2C intestinal protein |
| AT1G19870 | 2.078372397 | IQ-domain 32 |
| AT1G01100 | 2.077774887 | 60S acidic ribosomal protein family |
| AT2G22470 | 2.077479628 | arabinogalactan protein 2 |
| AT4G13510 | 2.076513478 | ammonium transporter 1%3B1 |
| AT3G55600 | 2.075805077 | Membrane fusion protein Use1 |
| AT3G14620 | 2.075374969 | cytochrome P450%2C family 72%2C subfamily A%2C polypeptide 8 |
| AT1G18200 | 2.072928154 | Rab GTPase-like A1I protein |
| AT5G41790 | 2.072333164 | COP1-interactive protein 1 |
| AT5G10030 | 2.06961125 | TGACG motif-binding factor 4 |
| AT4G11360 | 2.068806942 | RING-H2 finger A1B |
| AT4G39220 | 2.068327774 | Rer1 family protein |
| AT5G61600 | 2.065622624 | ethylene response factor 104 |
| AT3G15530 | 2.063080485 | S-adenosyl-L-methionine-dependent methyltransferases superfamily protein |
| AT1G35350 | 2.060535644 | EXS (ERD1/XPR1/SYG1) family protein |
| AT5G18630 | 2.059794106 | alpha/beta-Hydrolases superfamily protein |
| AT1G62422 | 2.058844216 | hypothetical protein |
| AT1G09340 | 2.057682632 | chloroplast RNA binding protein |
| AT5G06860 | 2.055741202 | polygalacturonase inhibiting protein 1 |
| AT4G21410 | 2.055459944 | cysteine-rich RLK (RECEPTOR-like protein kinase) 29 |
| AT3G08780 | 2.051724461 | BRISC complex subunit Abro1-like protein |
| AT2G11520 | 2.051625138 | calmodulin-binding receptor-like cytoplasmic kinase 3 |
| AT4G00330 | 2.05081565 | calmodulin-binding receptor-like cytoplasmic kinase 2 |
| AT2G23200 | 2.050720724 | Protein kinase superfamily protein |
| AT5G57000 | 2.049977702 | DEAD-box ATP-dependent RNA helicase |
| AT1G10900 | 2.048512493 | Phosphatidylinositol-4-phosphate 5-kinase family protein |
| AT2G29630 | 2.047840164 | thiaminC |
| AT5G56240 | 2.047084291 | hapless protein |
| AT3G50060 | 2.042321043 | myb domain protein 77 |
| AT1G12250 | 2.041388722 | Pentapeptide repeat-containing protein |
| AT1G65490 | 2.041086726 | transmembrane protein |
| AT2G34070 | 2.040256663 | TRICHOME BIREFRINGENCE-LIKE 37 |
| AT5G26740 | 2.040146991 | organic solute transporter ostalpha protein (DUF300) |
| AT3G15260 | 2.038517335 | Protein phosphatase 2C family protein |
| AT3G52560 | 2.038384652 | ubiquitin E2 variant 1D-4 |
| AT3G26900 | 2.037599603 | shikimate kinase like 1 |
| AT2G47510 | 2.037435408 | fumarase 1 |
| AT5G53620 | 2.035971318 | RNA polymerase II degradation factor |
| AT1G56070 | 2.031151822 | Ribosomal protein S5/Elongation factor G/III/V family protein |
| ATMG00030 | 2.030397262 | hypothetical protein |
| AT5G39785 | 2.029811853 | hypothetical protein (DUF1666) |
| AT1G69340 | 2.029698944 | appr-1-p processing enzyme family protein |
| AT1G61380 | 2.028832744 | S-domain-1 29 |
| AT4G31500 | 2.028012346 | cytochrome P450%2C family 83%2C subfamily B%2C polypeptide 1 |
| AT3G46600 | 2.024802462 | GRAS family transcription factor |
| AT5G49480 | 2.024189108 | Ca2+-binding protein 1 |
| AT1G14200 | 2.024042052 | RING/U-box superfamily protein |
| AT3G57750 | 2.023851857 | Protein kinase superfamily protein |
| AT1G26160 | 2.022391246 | Metal-dependent phosphohydrolase |
| AT1G19660 | 2.020323225 | Wound-responsive family protein |
| AT4G13350 | 2.019935243 | NSP (nuclear shuttle protein)-interacting GTPase |
| AT3G22950 | 2.019182885 | ADP-ribosylation factor C1 |
| AT4G34710 | 2.017965291 | arginine decarboxylase 2 |
| AT4G37450 | 2.014723483 | arabinogalactan protein 18 |
| AT2G23450 | 2.013441946 | Protein kinase superfamily protein |
| AT4G39850 | 2.013198342 | peroxisomal ABC transporter 1 |
| AT4G30350 | 2.012631376 | Double Clp-N motif-containing P-loop nucleoside triphosphate hydrolases superfamily protein |
| AT1G25275 | 2.011516569 | thionin-like protein |
| AT4G25810 | 2.011009042 | xyloglucan endotransglycosylase 6 |
| AT3G20510 | 2.010935324 | Transmembrane proteins 14C |
| AT3G23030 | 2.007903593 | indole-3-acetic acid inducible 2 |
| AT5G53550 | 2.004619171 | YELLOW STRIPE like 3 |
| AT2G14835 | 2.00440867 | RING/U-box superfamily protein |
| AT1G76440 | 2.004230708 | HSP20-like chaperones superfamily protein |
| AT2G38860 | 2.004183311 | Class I glutamine amidotransferase-like superfamily protein |
| AT4G26095 | 2.001652868 | NA |
| AT2G17560 | 2.000194644 | high mobility group B4 |
| AT5G53860 | 0.499858869 | embryo defective 2737 |
| AT5G58100 | 0.499362542 | transmembrane protein |
| AT2G21170 | 0.499313091 | triosephosphate isomerase |
| AT1G53570 | 0.49886353 | mitogen-activated protein kinase kinase kinase 3 |
| AT5G23280 | 0.497765537 | TCP family transcription factor |
| AT1G68010 | 0.497274465 | hydroxypyruvate reductase |
| AT1G52380 | 0.496293891 | NUP50 (Nucleoporin 50 kDa) protein |
| AT1G13880 | 0.496043202 | ELM2 domain-containing protein |
| AT3G19850 | 0.495724604 | Phototropic-responsive NPH3 family protein |
| AT4G31780 | 0.495475007 | monogalactosyl diacylglycerol synthase 1 |
| AT4G35790 | 0.495277211 | phospholipase D delta |
| AT3G16857 | 0.495143168 | response regulator 1 |
| AT5G02760 | 0.495076066 | Protein phosphatase 2C family protein |
| AT3G13060 | 0.494916225 | evolutionarily conserved C-terminal region 5 |
| AT4G27410 | 0.494705499 | NAC (No Apical Meristem) domain transcriptional regulator superfamily protein |
| AT4G08470 | 0.494330265 | MAPK/ERK kinase kinase 3 |
| AT3G17900 | 0.493680274 | heat-inducible transcription repressor |
| AT5G65770 | 0.49303301 | little nuclei4 |
| AT4G19530 | 0.492029097 | disease resistance protein (TIR-NBS-LRR class) family |
| AT4G36400 | 0.491617125 | FAD-linked oxidases family protein |
| AT5G42020 | 0.491360508 | Heat shock protein 70 (Hsp 70) family protein |
| AT5G03615 | 0.491345746 | NA |
| AT3G16260 | 0.491246061 | tRNAse Z4 |
| AT3G22120 | 0.490944693 | cell wall-plasma membrane linker protein |
| AT4G18140 | 0.490342015 | SCP1-like small phosphatase 4b |
| AT2G16700 | 0.490142237 | actin depolymerizing factor 5 |
| AT3G25530 | 0.489993259 | glyoxylate reductase 1 |
| AT1G49660 | 0.489641628 | carboxyesterase 5 |
| AT3G15570 | 0.489450188 | Phototropic-responsive NPH3 family protein |
| AT1G50600 | 0.489121008 | scarecrow-like 5 |
| AT2G19620 | 0.488590551 | N-MYC downregulated-like 3 |
| AT4G03400 | 0.488110702 | Auxin-responsive GH3 family protein |
| AT3G57050 | 0.486757442 | cystathionine beta-lyase |
| AT3G15840 | 0.486506922 | post-illumination chlorophyll fluorescence increase |
| AT1G65040 | 0.486376173 | RING/U-box superfamily protein |
| AT1G60650 | 0.485691159 | RNA-binding (RRM/RBD/RNP motifs) family protein with retrovirus zinc finger-like domain-containing protein |
| AT5G35620 | 0.485586255 | Eukaryotic initiation factor 4E protein |
| AT2G28470 | 0.48445667 | beta-galactosidase 8 |
| AT2G41600 | 0.484256264 | Mitochondrial glycoprotein family protein |
| AT1G49670 | 0.483055853 | ARP protein (REF) |
| AT5G64170 | 0.482968002 | dentin sialophosphoprotein-like protein |
| AT1G07940 | 0.482288655 | GTP binding Elongation factor Tu family protein |
| AT4G16990 | 0.482244998 | disease resistance protein (TIR-NBS class) |
| AT4G17150 | 0.481451649 | alpha/beta-Hydrolases superfamily protein |
| AT4G02640 | 0.481436328 | bZIP transcription factor family protein |
| AT4G18740 | 0.481421149 | Rho termination factor |
| AT2G30695 | 0.478144409 | bacterial trigger factor |
| AT4G20130 | 0.477423934 | plastid transcriptionally active 14 |
| AT1G70820 | 0.476620261 | phosphoglucomutase%2C putative / glucose phosphomutase |
| AT4G35770 | 0.476334299 | Rhodanese/Cell cycle control phosphatase superfamily protein |
| AT3G15880 | 0.476324264 | WUS-interacting protein 2 |
| AT2G02950 | 0.475123318 | phytochrome kinase substrate 1 |
| AT5G41340 | 0.475070749 | ubiquitin conjugating enzyme 4 |
| AT1G78290 | 0.475011922 | Protein kinase superfamily protein |
| AT2G42320 | 0.474772629 | nucleolar protein gar2-like protein |
| AT1G26218 | 0.473903143 | NA |
| AT5G11070 | 0.473491816 | hypothetical protein |
| AT3G58010 | 0.473443479 | plastoglobulin 34kD |
| AT4G17098 | 0.473264055 | NA |
| AT3G24530 | 0.473155024 | AAA-type ATPase family protein / ankyrin repeat family protein |
| AT3G13062 | 0.472989077 | Polyketide cyclase/dehydrase and lipid transport superfamily protein |
| AT3G56510 | 0.472903067 | RNA-binding (RRM/RBD/RNP motifs) family protein |
| AT1G77180 | 0.472868839 | chromatin protein family |
| AT4G19170 | 0.472270864 | nine-cis-epoxycarotenoid dioxygenase 4 |
| AT3G53460 | 0.472105639 | chloroplast RNA-binding protein 29 |
| AT4G33650 | 0.471759614 | dynamin-related protein 3A |
| AT2G21330 | 0.471626503 | fructose-bisphosphate aldolase 1 |
| AT1G30690 | 0.471360329 | Sec14p-like phosphatidylinositol transfer family protein |
| AT3G26290 | 0.47008363 | cytochrome P450%2C family 71%2C subfamily B%2C polypeptide 26 |
| AT4G24800 | 0.469889673 | MA3 domain-containing protein |
| AT5G18630 | 0.469490683 | alpha/beta-Hydrolases superfamily protein |
| AT1G08810 | 0.469164976 | myb domain protein 60 |
| AT1G49510 | 0.469036433 | embryo defective 1273 |
| AT5G18380 | 0.467312355 | Ribosomal protein S5 domain 2-like superfamily protein |
| AT5G45800 | 0.466674751 | Leucine-rich repeat protein kinase family protein |
| AT1G10155 | 0.465080633 | phloem protein 2-A10 |
| AT5G04040 | 0.464828638 | Patatin-like phospholipase family protein |
| AT1G31850 | 0.464349779 | S-adenosyl-L-methionine-dependent methyltransferases superfamily protein |
| AT5G14220 | 0.464254576 | Flavin containing amine oxidoreductase family |
| AT4G31530 | 0.464163637 | NAD(P)-binding Rossmann-fold superfamily protein |
| AT4G17830 | 0.461837855 | Peptidase M20/M25/M40 family protein |
| AT1G26930 | 0.461740922 | Galactose oxidase/kelch repeat superfamily protein |
| AT1G02280 | 0.461492438 | translocon at the outer envelope membrane of chloroplasts 33 |
| AT2G25070 | 0.461445878 | Protein phosphatase 2C family protein |
| AT4G29905 | 0.460615302 | hypothetical protein |
| AT4G00830 | 0.460490528 | RNA-binding (RRM/RBD/RNP motifs) family protein |
| AT5G16505 | 0.46044689 | NA |
| AT1G12250 | 0.459984387 | Pentapeptide repeat-containing protein |
| AT4G39860 | 0.459445676 | hematological/neurological-like protein |
| AT3G01640 | 0.45867392 | glucuronokinase G |
| AT1G12520 | 0.458630578 | copper chaperone for SOD1 |
| AT1G19350 | 0.45857684 | Brassinosteroid signaling positive regulator (BZR1) family protein |
| AT4G02990 | 0.458145766 | Mitochondrial transcription termination factor family protein |
| AT1G72770 | 0.457710705 | HYPERSENSITIVE TO ABA1 |
| AT1G56220 | 0.457659788 | Dormancy/auxin associated family protein |
| AT5G20040 | 0.456965033 | isopentenyltransferase 9 |
| AT2G43010 | 0.456371665 | phytochrome interacting factor 4 |
| AT5G20090 | 0.456332507 | Uncharacterized protein family (UPF0041) |
| AT1G54360 | 0.455890324 | TBP-ASSOCIATED FACTOR 6B |
| AT1G16180 | 0.45411076 | Serinc-domain containing serine and sphingolipid biosynthesis protein |
| AT1G68660 | 0.453450125 | Ribosomal protein L12/ ATP-dependent Clp protease adaptor protein ClpS family protein |
| AT5G27540 | 0.453307506 | MIRO-related GTP-ase 1 |
| AT5G52040 | 0.453191305 | RNA-binding (RRM/RBD/RNP motifs) family protein |
| AT5G46030 | 0.453026025 | transcription elongation factor-like protein |
| AT2G47510 | 0.45226569 | fumarase 1 |
| AT5G22920 | 0.452264853 | CHY-type/CTCHY-type/RING-type Zinc finger protein |
| AT4G29750 | 0.451990757 | CRS1 / YhbY (CRM) domain-containing protein |
| AT2G07340 | 0.451634899 | PREFOLDIN 1 |
| AT1G76990 | 0.451551606 | ACT domain repeat 3 |
| AT3G63200 | 0.451290542 | PATATIN-like protein 9 |
| AT4G01995 | 0.450639195 | beta-carotene isomerase D27 |
| AT5G49710 | 0.44986253 | RING finger protein |
| AT1G19520 | 0.448746077 | pentatricopeptide (PPR) repeat-containing protein |
| AT5G47080 | 0.44835669 | casein kinase II beta chain 1 |
| AT1G55310 | 0.448145801 | SC35-like splicing factor 33 |
| AT5G43470 | 0.447562564 | Disease resistance protein (CC-NBS-LRR class) family |
| AT4G22890 | 0.446361474 | PGR5-LIKE A |
| AT1G73170 | 0.445534576 | P-loop containing nucleoside triphosphate hydrolases superfamily protein |
| AT1G03160 | 0.44538589 | FZO-like protein |
| AT2G27710 | 0.44486904 | 60S acidic ribosomal protein family |
| AT4G38900 | 0.443415613 | Basic-leucine zipper (bZIP) transcription factor family protein |
| AT3G66654 | 0.442972732 | Cyclophilin-like peptidyl-prolyl cis-trans isomerase family protein |
| AT1G18400 | 0.442927251 | BR enhanced expression 1 |
| AT5G28840 | 0.442859926 | GDP-D-mannose 3′%2C5′-epimerase |
| AT5G27290 | 0.442444322 | stress regulated protein |
| AT1G75410 | 0.442205086 | BEL1-like homeodomain 3 |
| AT2G42130 | 0.441029578 | Plastid-lipid associated protein PAP / fibrillin family protein |
| AT4G16660 | 0.44079572 | heat shock protein 70 (Hsp 70) family protein |
| AT5G57630 | 0.4405201 | CBL-interacting protein kinase 21 |
| AT3G18140 | 0.440320608 | Transducin/WD40 repeat-like superfamily protein |
| AT1G10200 | 0.439304491 | GATA type zinc finger transcription factor family protein |
| AT3G47000 | 0.439006666 | Glycosyl hydrolase family protein |
| AT1G22530 | 0.438576524 | PATELLIN 2 |
| AT5G10470 | 0.438384412 | kinesin like protein for actin based chloroplast movement 1 |
| AT5G03900 | 0.437917652 | Iron-sulfur cluster biosynthesis family protein |
| AT5G38510 | 0.437597552 | Rhomboid-related intramembrane serine protease family protein |
| AT2G48020 | 0.437402896 | Major facilitator superfamily protein |
| AT5G63620 | 0.43677097 | GroES-like zinc-binding alcohol dehydrogenase family protein |
| AT5G28020 | 0.436350537 | cysteine synthase D2 |
| AT3G54350 | 0.436257071 | Forkhead-associated (FHA) domain-containing protein |
| AT3G03380 | 0.434504281 | DegP protease 7 |
| AT3G29160 | 0.434131076 | SNF1 kinase homolog 11 |
| AT4G34950 | 0.434120781 | Major facilitator superfamily protein |
| AT5G06980 | 0.432859581 | hypothetical protein |
| AT1G09193 | 0.432771273 | NA |
| AT5G23010 | 0.432447621 | methylthioalkylmalate synthase 1 |
| AT3G13990 | 0.432026838 | dentin sialophosphoprotein%2C putative (DUF1296) |
| AT5G45500 | 0.431670387 | RNI-like superfamily protein |
| AT1G80490 | 0.431156874 | TOPLESS-related 1 |
| AT3G17860 | 0.431063319 | jasmonate-zim-domain protein 3 |
| AT4G00710 | 0.429875838 | BR-signaling kinase 3 |
| AT5G44680 | 0.429835671 | DNA glycosylase superfamily protein |
| AT5G44190 | 0.429483751 | GOLDEN2-like 2 |
| AT3G21600 | 0.429430636 | Senescence/dehydration-associated protein-like protein |
| AT3G46590 | 0.429371348 | TRF-like 1 |
| AT3G44310 | 0.428589401 | nitrilase 1 |
| AT4G16520 | 0.427801721 | Ubiquitin-like superfamily protein |
| AT2G24270 | 0.42699064 | aldehyde dehydrogenase 11A3 |
| AT1G05850 | 0.42656833 | Chitinase family protein |
| AT2G34630 | 0.426567571 | geranyl diphosphate synthase 1 |
| AT5G37850 | 0.426556556 | pfkB-like carbohydrate kinase family protein |
| AT5G27950 | 0.425233401 | P-loop containing nucleoside triphosphate hydrolases superfamily protein |
| AT1G54920 | 0.42436435 | hypothetical protein |
| AT2G30170 | 0.423813944 | Protein phosphatase 2C family protein |
| AT2G45700 | 0.423641736 | sterile alpha motif (SAM) domain-containing protein |
| AT1G52220 | 0.423413659 | CURVATURE THYLAKOID protein |
| AT5G52040 | 0.423259078 | RNA-binding (RRM/RBD/RNP motifs) family protein |
| AT5G61220 | 0.422409416 | LYR family of Fe/S cluster biogenesis protein |
| AT3G16660 | 0.421883942 | Pollen Ole e 1 allergen and extensin family protein |
| AT4G22890 | 0.421698674 | PGR5-LIKE A |
| AT3G17609 | 0.421246277 | HY5-homolog |
| AT1G04940 | 0.421232551 | translocon at the inner envelope membrane of chloroplasts 20 |
| AT5G64330 | 0.4205585 | Phototropic-responsive NPH3 family protein |
| AT4G21980 | 0.418538831 | Ubiquitin-like superfamily protein |
| AT3G07760 | 0.417904716 | Sterile alpha motif (SAM) domain-containing protein |
| AT3G26720 | 0.417724138 | Glycosyl hydrolase family 38 protein |
| AT4G24290 | 0.417628985 | MAC/Perforin domain-containing protein |
| AT3G61070 | 0.417222304 | peroxin 11E |
| AT5G54370 | 0.414981164 | Late embryogenesis abundant (LEA) protein-like protein |
| AT2G32650 | 0.41494189 | RmIC-like cupins superfamily protein |
| AT5G02100 | 0.414458759 | Oxysterol-binding family protein |
| AT1G76990 | 0.414227298 | ACT domain repeat 3 |
| AT4G30480 | 0.413951081 | Tetratricopeptide repeat (TPR)-like superfamily protein |
| AT4G36850 | 0.413530201 | PQ-loop repeat family protein / transmembrane family protein |
| AT1G15290 | 0.413357397 | Tetratricopeptide repeat (TPR)-like superfamily protein |
| AT3G47120 | 0.412622788 | RNA recognition motif (RRM)-containing protein |
| AT3G30180 | 0.412192578 | brassinosteroid-6-oxidase 2 |
| AT5G10150 | 0.412041586 | UPSTREAM OF FLC protein (DUF966) |
| AT2G18300 | 0.411847106 | basic helix-loop-helix (bHLH) DNA-binding superfamily protein |
| AT4G32285 | 0.411480397 | ENTH/ANTH/VHS superfamily protein |
| AT4G28760 | 0.410962824 | methyl-coenzyme M reductase II subunit gamma%2C putative (DUF3741) |
| AT4G02260 | 0.410805147 | RELA/SPOT homolog 1 |
| AT5G56240 | 0.40836819 | hapless protein |
| AT2G19830 | 0.408235332 | SNF7 family protein |
| AT3G10770 | 0.407957671 | Single-stranded nucleic acid binding R3H protein |
| AT3G28100 | 0.407857507 | nodulin MtN21 /EamA-like transporter family protein |
| AT1G23900 | 0.40698404 | gamma-adaptin 1 |
| AT1G20920 | 0.406467749 | P-loop containing nucleoside triphosphate hydrolases superfamily protein |
| AT4G32551 | 0.406176984 | transcriptional corepressor LEUNIG |
| AT1G25420 | 0.406022439 | Regulator of Vps4 activity in the MVB pathway protein |
| AT5G61410 | 0.405710781 | D-ribulose-5-phosphate-3-epimerase |
| AT5G42030 | 0.405686295 | ABL interactor-like protein 4 |
| AT5G58575 | 0.405652465 | SAGA-associated factor-like protein |
| AT3G14830 | 0.404968808 | epstein-barr nuclear antigen |
| AT2G29670 | 0.404827025 | Tetratricopeptide repeat (TPR)-like superfamily protein |
| AT1G14450 | 0.403776399 | NADH dehydrogenase (ubiquinone)s |
| AT3G43740 | 0.403612334 | Leucine-rich repeat (LRR) family protein |
| AT1G19800 | 0.40320919 | trigalactosyldiacylglycerol 1 |
| AT3G13360 | 0.401877647 | WPP domain interacting protein 3 |
| AT1G65580 | 0.40119007 | Endonuclease/exonuclease/phosphatase family protein |
| AT4G30100 | 0.400833309 | P-loop containing nucleoside triphosphate hydrolases superfamily protein |
| AT2G03800 | 0.400150322 | D-aminoacyl-tRNA deacylase |
| AT1G69340 | 0.400022379 | appr-1-p processing enzyme family protein |
| AT1G56580 | 0.399960856 | plant/protein (Protein of unknown function%2C DUF538) |
| AT1G27385 | 0.399100853 | phosphoribosylformylglycinamidine synthase |
| AT4G24590 | 0.399085649 | RING finger protein |
| AT1G73430 | 0.398882069 | sec34-like family protein |
| AT5G58260 | 0.398797335 | oxidoreductases%2C acting on NADH or NADPH%2C quinone or similar compound as acceptor |
| AT1G06060 | 0.3983166 | LisH and RanBPM domains containing protein |
| AT3G58640 | 0.397607987 | Mitogen activated protein kinase kinase kinase-like protein |
| AT3G17430 | 0.395497679 | Nucleotide-sugar transporter family protein |
| AT3G63130 | 0.39543043 | RAN GTPase activating protein 1 |
| AT2G28290 | 0.394878919 | P-loop containing nucleoside triphosphate hydrolases superfamily protein |
| AT4G38470 | 0.394819916 | ACT-like protein tyrosine kinase family protein |
| AT3G05420 | 0.394771729 | acyl-CoA binding protein 4 |
| AT1G48410 | 0.39458537 | Stabilizer of iron transporter SufD / Polynucleotidyl transferase |
| AT5G21222 | 0.394007377 | protein kinase family protein |
| AT4G25080 | 0.393824453 | magnesium-protoporphyrin IX methyltransferase |
| AT5G65670 | 0.393700762 | indole-3-acetic acid inducible 9 |
| AT1G52070 | 0.39208858 | Mannose-binding lectin superfamily protein |
| AT4G32660 | 0.391858759 | Protein kinase superfamily protein |
| AT1G35580 | 0.391227921 | cytosolic invertase 1 |
| AT5G60640 | 0.390629144 | PDI-like 1-4 |
| AT5G08080 | 0.390181418 | syntaxin of plants 132 |
| AT2G27500 | 0.390109163 | Glycosyl hydrolase superfamily protein |
| AT1G54610 | 0.38732728 | Protein kinase superfamily protein |
| AT4G31120 | 0.38694585 | SHK1 binding protein 1 |
| AT4G03415 | 0.385608378 | Protein phosphatase 2C family protein |
| AT3G06510 | 0.385284816 | Glycosyl hydrolase superfamily protein |
| AT3G22121 | 0.384809518 | NA |
| AT2G02870 | 0.383725502 | Galactose oxidase/kelch repeat superfamily protein |
| AT3G57230 | 0.383649135 | AGAMOUS-like 16 |
| AT1G53780 | 0.383501122 | 26S proteasome regulatory complex ATPase |
| AT5G56900 | 0.383331654 | CwfJ-like family protein / zinc finger (CCCH-type) family protein |
| AT2G32860 | 0.382753826 | beta glucosidase 33 |
| AT5G63190 | 0.382011927 | MA3 domain-containing protein |
| AT1G31500 | 0.380745786 | DNAse I-like superfamily protein |
| AT2G03870 | 0.380190423 | Small nuclear ribonucleoprotein family protein |
| AT2G37840 | 0.378819734 | Protein kinase superfamily protein |
| AT3G06040 | 0.378382396 | Ribosomal protein L12/ ATP-dependent Clp protease adaptor protein ClpS family protein |
| AT1G55000 | 0.37825259 | peptidoglycan-binding LysM domain-containing protein |
| AT2G21385 | 0.376283372 | hypothetical protein |
| AT3G02860 | 0.375824878 | zinc ion binding protein |
| AT3G02170 | 0.375540967 | longifolia2 |
| AT5G17230 | 0.374892134 | PHYTOENE SYNTHASE |
| AT2G37130 | 0.373407932 | Peroxidase superfamily protein |
| AT4G32590 | 0.371231733 | 2Fe-2S ferredoxin-like superfamily protein |
| AT3G30390 | 0.370816807 | Transmembrane amino acid transporter family protein |
| AT4G30910 | 0.370683448 | Cytosol aminopeptidase family protein |
| AT3G13235 | 0.370613329 | ubiquitin family protein |
| AT5G61820 | 0.369785208 | stress up-regulated Nod 19 protein |
| AT1G04140 | 0.36474535 | Transducin family protein / WD-40 repeat family protein |
| AT1G45201 | 0.363982489 | triacylglycerol lipase-like 1 |
| AT2G39980 | 0.363727635 | HXXXD-type acyl-transferase family protein |
| AT5G18230 | 0.363511823 | transcription regulator NOT2/NOT3/NOT5 family protein |
| AT5G47620 | 0.362832451 | RNA-binding (RRM/RBD/RNP motifs) family protein |
| AT2G31510 | 0.36241278 | IBR domain-containing protein |
| AT4G26288 | 0.360819686 | hypothetical protein |
| AT5G14420 | 0.359580411 | RING domain ligase2 |
| AT1G17720 | 0.35857491 | Protein phosphatase 2A%2C regulatory subunit PR55 |
| AT5G66055 | 0.357914666 | ankyrin repeat protein |
| AT3G45620 | 0.357238199 | Transducin/WD40 repeat-like superfamily protein |
| AT5G43900 | 0.3549265 | myosin 2 |
| AT2G35155 | 0.354179836 | Trypsin family protein |
| AT4G31550 | 0.350871604 | WRKY DNA-binding protein 11 |
| AT5G06530 | 0.349020698 | ABC-2 type transporter family protein |
| AT1 G23090 | 0.348636165 | sulfate transporter 91 |
| AT1G01650 | 0.345648362 | SIGNAL PEPTIDE PEPTIDASE-LIKE 4 |
| AT2G26690 | 0.34548428 | Major facilitator superfamily protein |
| AT3G04810 | 0.345296465 | NIMA-related kinase 2 |
| AT2G17560 | 0.345054183 | high mobility group B4 |
| AT4G24990 | 0.342941727 | Ubiquitin family protein |
| AT4G31990 | 0.342837549 | aspartate aminotransferase 5 |
| AT5G53050 | 0.342553918 | alpha/beta-Hydrolases superfamily protein |
| AT3G19290 | 0.340860155 | ABRE binding factor 4 |
| AT5G01750 | 0.340721393 | LURP-one-like protein (DUF567) |
| AT2G27950 | 0.339252478 | Ring/U-Box superfamily protein |
| AT4G20410 | 0.338202469 | gamma-soluble NSF attachment protein |
| AT5G22090 | 0.337367112 | FAF-like protein (DUF3049) |
| AT5G30490 | 0.336969831 | craniofacial development-like protein |
| AT3G01920 | 0.336942012 | DHBP synthase RibB-like alpha/beta domain-containing protein |
| AT1 G70490 | 0.336912161 | Ras-related small GTP-binding family protein |
| AT1G15750 | 0.335884564 | Transducin family protein / WD-40 repeat family protein |
| AT1G16470 | 0.335616969 | proteasome subunit PAB1 |
| AT5G66720 | 0.330663889 | Protein phosphatase 2C family protein |
| AT4G31170 | 0.330390639 | Protein kinase superfamily protein |
| AT1G19660 | 0.329743767 | Wound-responsive family protein |
| AT5G53140 | 0.328877697 | Protein phosphatase 2C family protein |
| AT1G53910 | 0.328674273 | related to AP2 12 |
| AT2G17020 | 0.328256321 | F-box/RNI-like superfamily protein |
| AT5G53370 | 0.328168973 | pectin methylesterase PCR fragment F |
| AT2G35940 | 0.327950916 | BEL1-like homeodomain 1 |
| AT5G11200 | 0.326815198 | DEAD/DEAH box RNA helicase family protein |
| AT5G43430 | 0.325574769 | electron transfer flavoprotein beta |
| AT4G26260 | 0.325283057 | myo-inositol oxygenase 4 |
| AT3G13580 | 0.324083439 | Ribosomal protein L30/L7 family protein |
| AT3G03780 | 0.324024756 | methionine synthase 2 |
| AT4G03020 | 0.323621039 | transducin family protein / WD-40 repeat family protein |
| AT3G22640 | 0.323326633 | cupin family protein |
| AT5G47720 | 0.322747388 | Thiolase family protein |
| AT2G01350 | 0.322548848 | quinolinate phoshoribosyltransferase |
| AT4G17190 | 0.321803114 | farnesyl diphosphate synthase 2 |
| AT2G46030 | 0.320838117 | ubiquitin-conjugating enzyme 6 |
| AT1 G80940 | 0.320128927 | Snf1 kinase interactor-like protein |
| AT1 G60200 | 0.31914052 | splicing factor PWI domain-containing protein / RNA recognition motif (RRM)-containing protein |
| AT1G79810 | 0.319138435 | Pex2/Pex12 N-terminal domain-containing protein / zinc finger (C3HC4-type RING finger) family protein |
| AT5G48220 | 0.319083883 | Aldolase-type TIM barrel family protein |
| AT4G14716 | 0.318726527 | acireductone dioxygenase 1 |
| AT1G20620 | 0.318639469 | catalase 3 |
| AT5G42740 | 0.318148741 | Sugar isomerase (SIS) family protein |
| AT4G33640 | 0.317000764 | costars family protein |
| AT1G58180 | 0.316732457 | beta carbonic anhydrase 6 |
| AT1G73390 | 0.316237798 | Endosomal targeting BRO1-like domain-containing protein |
| AT1G79700 | 0.315326529 | Integrase-type DNA-binding superfamily protein |
| AT5G64570 | 0.314890723 | beta-D-xylosidase 4 |
| AT1G10900 | 0.314808415 | Phosphatidylinositol-4-phosphate 5-kinase family protein |
| AT4G37180 | 0.314505143 | Homeodomain-like superfamily protein |
| AT1G58848 | 0.313566948 | Disease resistance protein (CC-NBS-LRR class) family |
| AT2G02080 | 0.313238078 | indeterminate(ID)-domain 4 |
| AT4G36360 | 0.312980306 | beta-galactosidase 3 |
| AT5G47180 | 0.312767676 | Plant VAMP (vesicle-associated membrane protein) family protein |
| AT1G13450 | 0.311741274 | Homeodomain-like superfamily protein |
| AT3G59990 | 0.311496891 | methionine aminopeptidase 2B |
| AT5G51100 | 0.310867625 | Fe superoxide dismutase 2 |
| AT1G32070 | 0.310837619 | nuclear shuttle interacting |
| AT1G70570 | 0.310553695 | anthranilate phosphoribosyltransferase |
| AT1G73840 | 0.308659691 | hydroxyproline-rich glycoprotein family protein |
| AT3G26420 | 0.30851972 | RNA-binding (RRM/RBD/RNP motifs) family protein with retrovirus zinc finger-like domain-containing protein |
| AT3G11930 | 0.307484144 | Adenine nucleotide alpha hydrolases-like superfamily protein |
| AT3G47160 | 0.307049357 | RING/U-box superfamily protein |
| AT1G20020 | 0.306976455 | ferredoxin-NADP[+]-oxidoreductase 2 |
| AT4G02530 | 0.306601959 | chloroplast thylakoid lumen protein |
| AT4G31180 | 0.30360645 | Class II aminoacyl-tRNA and biotin synthetases superfamily protein |
| AT1G06200 | 0.303511759 | Peptidase S24/S26A/S26B/S26C family protein |
| AT3G10260 | 0.302365197 | Reticulon family protein |
| AT1G07607 | 0.302169007 | NA |
| AT5G16150 | 0.300571267 | plastidic GLC translocator |
| AT1G58180 | 0.300369656 | beta carbonic anhydrase 6 |
| AT3G47340 | 0.297724537 | glutamine-dependent asparagine synthase 1 |
| AT1G71020 | 0.297059314 | ARM repeat superfamily protein |
| AT2G04360 | 0.29690708 | transmembrane protein |
| AT3G01590 | 0.296575724 | Galactose mutarotase-like superfamily protein |
| AT5G24120 | 0.295886228 | sigma factor E |
| AT3G58040 | 0.295022576 | seven in absentia of Arabidopsis 2 |
| AT2G05100 | 0.293340663 | photosystem II light harvesting complex protein 2.1 |
| AT5G06440 | 0.291504499 | polyketide cyclase/dehydrase/lipid transport superfamily protein |
| AT2G47700 | 0.291262903 | RING/U-box superfamily protein |
| AT1G02100 | 0.290860205 | Leucine carboxyl methyltransferase |
| AT4G38860 | 0.289364668 | SAUR-like auxin-responsive protein family |
| AT4G08460 | 0.288768814 | hypothetical protein (DUF1644) |
| AT3G11880 | 0.288673203 | transmembrane protein%2C putative (Protein of unknown function DUF2359%2C transmembrane) |
| AT2G46370 | 0.287417762 | Auxin-responsive GH3 family protein |
| AT1G27450 | 0.28506754 | adenine phosphoribosyl transferase 1 |
| AT4G31820 | 0.28502882 | Phototropic-responsive NPH3 family protein |
| AT3G22121 | 0.284628859 | NA |
| AT1G34630 | 0.283798066 | transmembrane protein |
| AT5G45775 | 0.283406174 | Ribosomal L5P family protein |
| AT4G21105 | 0.282419759 | cytochrome-c oxidase/ electron carrier |
| AT2G30350 | 0.279910727 | Excinuclease ABC%2C C subunit%2C N-terminal |
| AT1G21400 | 0.279826515 | Thiamin diphosphate-binding fold (THDP-binding) superfamily protein |
| AT4G28880 | 0.278190801 | casein kinase I-like 3 |
| AT4G32330 | 0.277745651 | TPX2 (targeting protein for Xklp2) protein family |
| AT3G32930 | 0.277721025 | 6%2C7-dimethyl-8-ribityllumazine synthase |
| AT5G26740 | 0.277416903 | organic solute transporter ostalpha protein (DUF300) |
| AT1G67910 | 0.276141269 | hypothetical protein |
| AT1G31420 | 0.275272023 | Leucine-rich repeat protein kinase family protein |
| AT1G17130 | 0.274821138 | coiled-coil protein (DUF572) |
| AT2G04280 | 0.27363731 | calcium ion-binding protein |
| AT2G02710 | 0.273411162 | PAS/LOV protein B |
| AT4G18740 | 0.271258292 | Rho termination factor |
| AT2G41560 | 0.270416519 | autoinhibited Ca(2+)-ATPase%2C isoform 4 |
| AT5G41080 | 0.269733189 | PLC-like phosphodiesterases superfamily protein |
| AT3G47350 | 0.269396879 | hydroxysteroid dehydrogenase 2 |
| AT2G33310 | 0.268820368 | auxin-induced protein 13 |
| AT1G71820 | 0.268800742 | SEC6 |
| AT1G79870 | 0.26820199 | D-isomer specific 2-hydroxyacid dehydrogenase family protein |
| AT5G24160 | 0.265337619 | squalene monooxygenase 6 |
| AT4G20400 | 0.259798649 | JUMONJI 14 |
| AT3G16800 | 0.259235906 | Protein phosphatase 2C family protein |
| AT4G38520 | 0.259142897 | Protein phosphatase 2C family protein |
| AT5G58140 | 0.25802605 | phototropin 2 |
| AT3G44480 | 0.257412785 | Disease resistance protein (TIR-NBS-LRR class) family |
| AT3G44670 | 0.255087654 | Disease resistance protein (TIR-NBS-LRR class) family |
| AT3G47810 | 0.254986246 | Calcineurin-like metallo-phosphoesterase superfamily protein |
| AT4G31780 | 0.25377914 | monogalactosyl diacylglycerol synthase 1 |
| AT5G04140 | 0.252678697 | glutamate synthase 1 |
| AT3G14420 | 0.251344462 | Aldolase-type TIM barrel family protein |
| AT3G10030 | 0.25099141 | aspartate/glutamate/uridylate kinase family protein |
| AT5G05580 | 0.248455625 | fatty acid desaturase 8 |
| AT5G55450 | 0.247470121 | Bifunctional inhibitor/lipid-transfer protein/seed storage 2S albumin superfamily protein |
| AT3G61710 | 0.247141961 | AUTOPHAGY 6 |
| AT1G08727 | 0.245975908 | NA |
| AT2G37760 | 0.245695911 | NAD(P)-linked oxidoreductase superfamily protein |
| AT2G44120 | 0.242832008 | Ribosomal protein L30/L7 family protein |
| AT4G09760 | 0.242284029 | Protein kinase superfamily protein |
| AT1G60740 | 0.2416134 | Thioredoxin superfamily protein |
| AT3G29290 | 0.2402519 | Pentatricopeptide repeat (PPR) superfamily protein |
| AT2G48070 | 0.236979228 | resistance to phytophthora 1 |
| AT1G67440 | 0.23648202 | Minichromosome maintenance (MCM2/3/5) family protein |
| AT2G03730 | 0.235373585 | ACT domain repeat 5 |
| AT3G45850 | 0.231643073 | P-loop containing nucleoside triphosphate hydrolases superfamily protein |
| AT1G63680 | 0.231274182 | ALBINO OR PALE-GREEN 13 |
| AT5G57340 | 0.230179905 | ras guanine nucleotide exchange factor Q-like protein |
| AT1G23440 | 0.229084268 | Peptidase C15%2C pyroglutamyl peptidase I-like protein |
| AT1G06220 | 0.228602769 | Ribosomal protein S5/Elongation factor G/III/V family protein |
| AT1G10890 | 0.22744345 | arginine/glutamate-rich 1 protein |
| AT3G27770 | 0.224864617 | plant/protein |
| AT2G45170 | 0.224339906 | AUTOPHAGY 8E |
| AT5G19090 | 0.22356916 | Heavy metal transport/detoxification superfamily protein |
| AT4G31490 | 0.221260319 | Coatomer%2C beta subunit |
| AT1G75760 | 0.221225563 | ER lumen protein retaining receptor family protein |
| AT5G63890 | 0.219937764 | histidinol dehydrogenase |
| AT5G13710 | 0.219161106 | sterol methyltransferase 1 |
| AT5G63530 | 0.218118495 | farnesylated protein 3 |
| AT3G15450 | 0.217141989 | aluminum induced protein with YGL and LRDR motifs |
| AT2G46030 | 0.21511566 | ubiquitin-conjugating enzyme 6 |
| AT3G06380 | 0.214258383 | tubby-like protein 9 |
| AT5G66400 | 0.209809556 | Dehydrin family protein |
| AT3G47490 | 0.208455147 | HNH endonuclease |
| AT1G75180 | 0.208273553 | Erythronate-4-phosphate dehydrogenase family protein |
| AT1G70700 | 0.206908652 | TIFY domain/Divergent CCT motif family protein |
| AT5G22620 | 0.206359145 | phosphoglycerate/bisphosphoglycerate mutase family protein |
| AT1G72640 | 0.204229471 | NAD(P)-binding Rossmann-fold superfamily protein |
| AT2G22660 | 0.203828702 | DNA-binding protein%2C putative (duplicated DUF1399) |
| AT1G54390 | 0.203783108 | PHD finger protein-like protein |
| AT1G23960 | 0.200229615 | hypothetical protein (DUF626) |
| AT1G29700 | 0.198091338 | Metallo-hydrolase/oxidoreductase superfamily protein |
| AT4G01600 | 0.19767211 | GRAM domain family protein |
| AT1G79075 | 0.195666395 | NA |
| AT3G54500 | 0.195507311 | agglutinin-like protein |
| AT5G53900 | 0.194858024 | Serine/threonine-protein kinase WNK (With No Lysine)-like protein |
| AT5G65210 | 0.190543755 | bZIP transcription factor family protein |
| AT1G08660 | 0.186740836 | MALE GAMETOPHYTE DEFECTIVE 2 |
| AT1G12230 | 0.184982642 | Aldolase superfamily protein |
| AT5G03553 | 0.179951104 | hypothetical protein |
| AT3G51390 | 0.179325086 | DHHC-type zinc finger family protein |
| AT5G18630 | 0.179315409 | alpha/beta-Hydrolases superfamily protein |
| AT5G22000 | 0.177060195 | RING-H2 group F2A |
| AT5G01220 | 0.171473101 | sulfoquinovosyldiacylglycerol 2 |
| AT2G37540 | 0.16820733 | NAD(P)-binding Rossmann-fold superfamily protein |
| AT2G19730 | 0.165748235 | Ribosomal L28e protein family |
| AT1G07890 | 0.165616776 | ascorbate peroxidase 1 |
| AT4G23430 | 0.16179187 | NAD(P)-binding Rossmann-fold superfamily protein |
| AT3G53540 | 0.16049678 | afadin |
| AT1G23180 | 0.159281369 | ARM repeat superfamily protein |
| AT1G73990 | 0.157998392 | signal peptide peptidase |
| AT5G35330 | 0.155382601 | methyl-CPG-binding domain protein 02 |
| AT2G37080 | 0.155166915 | ROP interactive partner 3 |
| AT4G19120 | 0.15034778 | S-adenosyl-L-methionine-dependent methyltransferases superfamily protein |
| AT2G05520 | 0.14935394 | glycine-rich protein 3 |
| AT1G31600 | 0.148736726 | RNA-binding (RRM/RBD/RNP motifs) family protein |
| AT3G05520 | 0.146720613 | Subunits of heterodimeric actin filament capping protein Capz superfamily |
| AT5G57350 | 0.146094156 | H[+]-ATPase 3 |
| AT1G30520 | 0.144305577 | acyl-activating enzyme 14 |
| AT3G27260 | 0.143931306 | global transcription factor group E8 |
| AT1G20620 | 0.140237332 | catalase 3 |
| AT3G27960 | 0.137779747 | Tetratricopeptide repeat (TPR)-like superfamily protein |
| AT5G17300 | 0.132446704 | Homeodomain-like superfamily protein |
| AT1G63770 | 0.130075807 | Peptidase M1 family protein |
| AT1G04300 | 0.129007725 | TRAF-like superfamily protein |
| AT5G36790 | 0.128779157 | Haloacid dehalogenase-like hydrolase (HAD) superfamily protein |
| AT4G10120 | 0.12820203 | Sucrose-phosphate synthase family protein |
| AT5G48630 | 0.125263263 | Cyclin family protein |
| AT1G72130 | 0.120038383 | Major facilitator superfamily protein |
| AT2G38750 | 0.115819256 | annexin 4 |
| AT1G58180 | 0.115429172 | beta carbonic anhydrase 6 |
| AT5G57940 | 0.1145948 | cyclic nucleotide gated channel 5 |
| AT1G21350 | 0.114548717 | Thioredoxin superfamily protein |
| AT1G75830 | 0.113746979 | low-molecular-weight cysteine-rich 67 |
| AT2G35630 | 0.11324781 | ARM repeat superfamily protein |
| AT5G50915 | 0.113090031 | basic helix-loop-helix (bHLH) DNA-binding superfamily protein |
| AT2G46830 | 0.111832129 | circadian clock associated 1 |
| AT4G17330 | 0.108595503 | G2484-1 protein |
| AT3G54140 | 0.107713503 | peptide transporter 1 |
| AT5G05740 | 0.100925571 | ethylene-dependent gravitropism-deficient and yellow-green-like 2 |
| AT1G75380 | 0.09923015 | bifunctional nuclease in basal defense response 1 |
| AT3G54500 | 0.09898808 | agglutinin-like protein |
| AT1G10070 | 0.095534359 | branched-chain amino acid transaminase 2 |
| AT2G03680 | 0.093326021 | spiral1 |
| AT4G20110 | 0.091788644 | VACUOLAR SORTING RECEPTOR 7 |
| AT5G47435 | 0.085373144 | formyltetrahydrofolate deformylase |
| AT3G06400 | 0.075232037 | chromatin-remodeling protein 11 |
| AT5G27850 | 0.064298442 | Ribosomal protein L18e/L15 superfamily protein |
| AT4G29160 | 0.064263099 | SNF7 family protein |
| AT5G09670 | 0.063992389 | loricrin-like protein |
| AT3G51850 | 0.062097587 | calcium-dependent protein kinase 13 |
| AT5G63840 | 0.061582126 | Glycosyl hydrolases family 31 protein |
| AT2G41560 | 0.058832521 | autoinhibited Ca(2+)-ATPase%2C isoform 4 |
| AT1G12900 | 0.057879428 | glyceraldehyde 3-phosphate dehydrogenase A subunit 2 |
| AT2G28930 | 0.05525074 | protein kinase 1B |
| AT1G18210 | 0.054689998 | Calcium-binding EF-hand family protein |
| AT4G16950 | 0.051191152 | Disease resistance protein (TIR-NBS-LRR class) family |
| AT4G34240 | 0.051025801 | aldehyde dehydrogenase 3l1 |
| AT3G58030 | 0.049802675 | RING/U-box superfamily protein |
| AT5G67480 | 0.044368152 | BTB and TAZ domain protein 4 |
| AT1G61150 | 0.043363485 | LisH and RanBPM domains containing protein |
| AT3G23400 | 0.042606088 | Plastid-lipid associated protein PAP / fibrillin family protein |
| AT3G06770 | 0.041861877 | Pectin lyase-like superfamily protein |
| AT4G27040 | 0.038588996 | EAP30/Vps36 family protein |
| AT4G15530 | 0.035152798 | pyruvate orthophosphate dikinase |
| AT1G01060 | 0.033887768 | Homeodomain-like superfamily protein |
| AT5G14740 | 0.033309204 | carbonic anhydrase 2 |
| AT2G34310 | 0.031157173 | hypothetical protein |
| AT5G22090 | 0.027755229 | FAF-like protein (DUF3049) |
| AT2G06025 | 0.026233833 | Acyl-CoA N-acyltransferases (NAT) superfamily protein |
| AT1G58025 | 0.02509295 | DNA-binding bromodomain-containing protein |
| AT2G38170 | 0.024247824 | cation exchanger 1 |
| AT3G45190 | 0.020929097 | SIT4 phosphatase-associated family protein |
| AT5G06220 | 0.020146837 | LETM1-like protein |
| AT2G29650 | 0.019051061 | phosphate transporter 4%3B1 |
| AT2G14260 | 0.01884275 | proline iminopeptidase |
| AT2G30520 | 0.017292577 | Phototropic-responsive NPH3 family protein |
| AT3G16460 | 0.017127125 | Mannose-binding lectin superfamily protein |
| AT2G20900 | 0.0153296 | diacylglycerol kinase 5 |
| AT1G75380 | 0.014716908 | bifunctional nuclease in basal defense response 1 |
| AT5G60920 | 0.013884012 | COBRA-like extracellular glycosyl-phosphatidyl inositol-anchored protein family |
| AT1G79830 | 0.012209361 | golgin Putative 5 |
| AT5G27640 | 0.011988432 | translation initiation factor 3B1 |
| AT4G33580 | 0.008626414 | beta carbonic anhydrase 5 |
| AT3G15353 | 0.007933041 | metallothionein 3 |
| AT1G43890 | 0.006679695 | RAB GTPASE HOMOLOG B18 |
| AT1G19400 | 0.006496809 | Erythronate-4-phosphate dehydrogenase family protein |
| AT2G37340 | 0.006144925 | arginine/serine-rich zinc knuckle-containing protein 33 |
| AT1G79940 | 0.005726375 | DnaJ / Sec63 Brl domains-containing protein |
| AT2G25900 | 0.005117589 | Zinc finger C-x8-C-x5-C-x3-H type family protein |
| AT5G45350 | 0.004972773 | proline-rich family protein |
| AT3G08730 | 0.004834632 | protein-serine kinase 1 |
| AT3G19820 | 0.004537763 | cell elongation protein / DWARF1 / DIMINUTO (DIM) |
| AT5G06600 | 0.00418875 | ubiquitin-specific protease 12 |
| AT3G11910 | 0.002950478 | ubiquitin-specific protease 13 |
| AT1G80160 | 0.002679655 | Lactoylglutathione lyase / glyoxalase I family protein |
| AT4G27170 | 0.001204303 | seed storage albumin 4 |
| AT2G26980 | 0.000679989 | CBL-interacting protein kinase 3 |
| AT1G07940 | 0.000591472 | GTP binding Elongation factor Tu family protein |
| AT5G54740 | 0.000560259 | seed storage albumin 5 |
| AT5G49460 | 0.000433431 | ATP citrate lyase subunit B 2 |
| AT2G28910 | 0.000410137 | CAX interacting protein 4 |
| AT2G21300 | 0.000401286 | ATP binding microtubule motor family protein |
| AT4G35570 | 0.00038767 | high mobility group B5 |
| AT5G35630 | 0.000346428 | glutamine synthetase 2 |
| AT1G09570 | 0.000282361 | phytochrome A |
| AT1G04400 | 0.000233744 | cryptochrome 2 |
| AT5G59732 | 0.000182225 | NA |
| AT4G28040 | 0.000128421 | nodulin MtN21 /EamA-like transporter family protein |
| AT1G24160 | 5.05935E-05 | triadin |
| AT5G54940 | 1.70658E-05 | Translation initiation factor SUI1 family protein |
| AT1G02080 | 0 | transcription regulator |
| AT1G02840 | 0 | RNA-binding (RRM/RBD/RNP motifs) family protein |
| AT1G03290 | 0 | ELKS/Rab6-interacting/CAST family protein |
| AT1G04170 | 0 | eukaryotic translation initiation factor 2 gamma subunit |
| AT1G04970 | 0 | lipid-binding serum glycoprotein family protein |
| AT1G06410 | 0 | trehalose-phosphatase/synthase 7 |
| AT1G06430 | 0 | FTSH protease 8 |
| AT1G07170 | 0 | PHF5-like protein |
| AT1G07570 | 0 | Protein kinase superfamily protein |
| AT1G07770 | 0 | ribosomal protein S15A |
| AT1G10590 | 0 | Nucleic acid-binding%2C OB-fold-like protein |
| AT1G10590 | 0 | Nucleic acid-binding%2C OB-fold-like protein |
| AT1G11910 | 0 | aspartic proteinase A1 |
| AT1G13060 | 0 | 20S proteasome beta subunit E1 |
| AT1G13700 | 0 | 6-phosphogluconolactonase 1 |
| AT1G14685 | 0 | basic pentacysteine 2 |
| AT1G15410 | 0 | aspartate-glutamate racemase family |
| AT1G17890 | 0 | NAD(P)-binding Rossmann-fold superfamily protein |
| AT1G21410 | 0 | F-box/RNI-like superfamily protein |
| AT1G29400 | 0 | MEI2-like protein 5 |
| AT1G32410 | 0 | Vacuolar protein sorting 55 (VPS55) family protein |
| AT1G33050 | 0 | hypothetical protein |
| AT1G33240 | 0 | GT-2-like 1 |
| AT1G43190 | 0 | polypyrimidine tract-binding protein 3 |
| AT1G43850 | 0 | SEUSS transcriptional co-regulator |
| AT1G51160 | 0 | SNARE-like superfamily protein |
| AT1G55530 | 0 | RING/U-box superfamily protein |
| AT1G56070 | 0 | Ribosomal protein S5/Elongation factor G/III/V family protein |
| AT1G57680 | 0 | plasminogen activator inhibitor |
| AT1G57720 | 0 | Translation elongation factor EF1B%2C gamma chain |
| AT1G60140 | 0 | trehalose phosphate synthase |
| AT1G62660 | 0 | Glycosyl hydrolases family 32 protein |
| AT1G64230 | 0 | ubiquitin-conjugating enzyme 28 |
| AT1G66270 | 0 | Glycosyl hydrolase superfamily protein |
| AT1G70490 | 0 | Ras-related small GTP-binding family protein |
| AT1G70580 | 0 | alanine-2-oxoglutarate aminotransferase 2 |
| AT1G70850 | 0 | MLP-like protein 34 |
| AT1G74510 | 0 | Galactose oxidase/kelch repeat superfamily protein |
| AT1G77490 | 0 | thylakoidal ascorbate peroxidase |
| AT1G78900 | 0 | vacuolar ATP synthase subunit A |
| AT1G79245 | 0 | NA |
| AT1G80360 | 0 | Pyridoxal phosphate (PLP)-dependent transferases superfamily protein |
| AT1G80360 | 0 | Pyridoxal phosphate (PLP)-dependent transferases superfamily protein |
| AT2G03470 | 0 | ELM2 domain-containing protein |
| AT2G03780 | 0 | Translin family protein |
| AT2G05440 | 0 | GLYCINE RICH PROTEIN 9 |
| AT2G05440 | 0 | GLYCINE RICH PROTEIN 9 |
| AT2G05620 | 0 | proton gradient regulation 5 |
| AT2G14835 | 0 | RING/U-box superfamily protein |
| AT2G16640 | 0 | multimeric translocon complex in the outer envelope membrane 132 |
| AT2G16860 | 0 | GCIP-interacting family protein |
| AT2G17033 | 0 | pentatricopeptide (PPR) repeat-containing protein |
| AT2G17540 | 0 | hypothetical protein |
| AT2G19180 | 0 | hypothetical protein |
| AT2G21270 | 0 | ubiquitin fusion degradation 1 |
| AT2G22990 | 0 | sinapoylglucose 1 |
| AT2G28810 | 0 | Dof-type zinc finger DNA-binding family protein |
| AT2G30600 | 0 | BTB/POZ domain-containing protein |
| AT2G31010 | 0 | Protein kinase superfamily protein |
| AT2G32230 | 0 | proteinaceous RNase P 1 |
| AT2G34300 | 0 | S-adenosyl-L-methionine-dependent methyltransferases superfamily protein |
| AT2G42810 | 0 | protein phosphatase 5.2 |
| AT2G43810 | 0 | Small nuclear ribonucleoprotein family protein |
| AT2G46800 | 0 | zinc transporter |
| AT2G47510 | 0 | fumarase 1 |
| AT2G48100 | 0 | Exonuclease family protein |
| AT3G01390 | 0 | vacuolar membrane ATPase 10 |
| AT3G04610 | 0 | RNA-binding KH domain-containing protein |
| AT3G04870 | 0 | zeta-carotene desaturase |
| AT3G05840 | 0 | Protein kinase superfamily protein |
| AT3G02565 | 0 | NA |
| AT3G13460 | 0 | evolutionarily conserved C-terminal region 2 |
| AT3G14790 | 0 | rhamnose biosynthesis 3 |
| AT3G16420 | 0 | PYK10-binding protein 1 |
| AT3G17040 | 0 | high chlorophyll fluorescent 107 |
| AT3G23830 | 0 | glycine-rich RNA-binding protein 4 |
| AT3G25900 | 0 | Homocysteine S-methyltransferase family protein |
| AT3G26510 | 0 | Octicosapeptide/Phox/Bem1 p family protein |
| AT3G26570 | 0 | phosphate transporter 2%3B1 |
| AT3G45630 | 0 | RNA binding (RRM/RBD/RNP motifs) family protein |
| AT3G49010 | 0 | breast basic conserved 1 |
| AT3G52340 | 0 | sucrose-6F-phosphate phosphohydrolase 2 |
| AT3G55020 | 0 | Ypt/Rab-GAP domain of gyp1 p superfamily protein |
| AT3G55630 | 0 | DHFS-FPGS homolog D |
| AT3G56130 | 0 | biotin/lipoyl attachment domain-containing protein |
| AT3G58510 | 0 | DEA(D/H)-box RNA helicase family protein |
| AT4G01290 | 0 | chorismate synthase |
| AT4G02890 | 0 | Ubiquitin family protein |
| AT4G05050 | 0 | ubiquitin 11 |
| AT4G05050 | 0 | ubiquitin 11 |
| AT4G05320 | 0 | polyubiquitin 10 |
| AT4G08390 | 0 | stromal ascorbate peroxidase |
| AT4G12790 | 0 | P-loop containing nucleoside triphosphate hydrolases superfamily protein |
| AT4G14360 | 0 | S-adenosyl-L-methionine-dependent methyltransferases superfamily protein |
| AT4G18975 | 0 | Pentatricopeptide repeat (PPR) superfamily protein |
| AT4G19410 | 0 | Pectinacetylesterase family protein |
| AT4G20260 | 0 | plasma-membrane associated cation-binding protein 1 |
| AT4G20260 | 0 | plasma-membrane associated cation-binding protein 1 |
| AT4G21160 | 0 | Calcium-dependent ARF-type GTPase activating protein family |
| AT4G22540 | 0 | OSBP(oxysterol binding protein)-related protein 2A |
| AT4G24550 | 0 | Clathrin adaptor complexes medium subunit family protein |
| AT4G24730 | 0 | manganese-dependent ADP-ribose/CDP-alcohol diphosphatase-like protein |
| AT4G27160 | 0 | seed storage albumin 3 |
| AT4G28520 | 0 | cruciferin 3 |
| AT4G35450 | 0 | ankyrin repeat-containing protein 2 |
| AT4G38930 | 0 | Ubiquitin fusion degradation UFD1 family protein |
| AT4G40030 | 0 | Histone superfamily protein |
| AT5G01215 | 0 | NA |
| AT5G04550 | 0 | type-1 restriction enzyme mjaxp r protein (DUF668) |
| AT5G09600 | 0 | succinate dehydrogenase 3-1 |
| AT5G10290 | 0 | leucine-rich repeat transmembrane protein kinase family protein |
| AT5G11860 | 0 | SCP1-like small phosphatase 5 |
| AT5G13800 | 0 | pheophytinase |
| AT5G20180 | 0 | Ribosomal protein L36 |
| AT5G22210 | 0 | aspartyl/glutamyl-tRNA (Asn/Gln) amidotransferase subunit B |
| AT5G22440 | 0 | Ribosomal protein L1p/L10e family |
| AT5G23210 | 0 | serine carboxypeptidase-like 34 |
| AT5G24210 | 0 | alpha/beta-Hydrolases superfamily protein |
| AT5G25280 | 0 | serine-rich protein-like protein |
| AT5G37370 | 0 | PRP38 family protein |
| AT5G40580 | 0 | 20S proteasome beta subunit PBB2 |
| AT5G43270 | 0 | squamosa promoter binding protein-like 2 |
| AT5G44120 | 0 | RmlC-like cupins superfamily protein |
| AT5G49030 | 0 | tRNA synthetase class I (1%2C L%2C M and V) family protein |
| AT5G49830 | 0 | exocyst complex component 84B |
| AT5G52190 | 0 | Sugar isomerase (SIS) family protein |
| AT5G52580 | 0 | RabGAP/TBC domain-containing protein |
| AT5G53620 | 0 | RNA polymerase II degradation factor |
| AT5G55530 | 0 | Calcium-dependent lipid-binding (CaLB domain) family protein |
| AT5G62980 | 0 | Dihydroneopterin aldolase |
| AT5G65620 | 0 | Zincin-like metalloproteases family protein |

The foregoing is illustrative of the present invention, and is not to be construed as limiting thereof. The invention is defined by the following claims, with equivalents of the claims to be included therein.

What is claimed is:

1. A composition for increasing a growth characteristic of a plant or part thereof, increasing nutrient use efficiency of a plant or part thereof, and/or increasing abiotic and/or biotic stress tolerance of a plant or part thereof, comprising an effective amount/rate of mixed linked β-1,3/β-1,4 glucans (MLGs).

2. The composition of claim 1, wherein the composition further comprises a surfactant, a humectant, an adjuvant, an antioxidant, a preservative, a plant macronutrient, a plant micronutrient, a plant growth regulator, a plant biostimulant, a pesticide, a fungicide, an antiviral, an anti-bacterial, a herbicide, or any combination thereof.

3. The composition of claim 1, wherein the composition is in the form of an aqueous solution, a non-aqueous solution, a suspension, a gel, a foam, a paste, a powder, a dust, a solid, and/or an emulsion.

4. The composition of claim 1, wherein the mixed linked β-1,3/β-1,4 glucans (MLGs) comprise a degree of polymerization from 2 to >100.

5. The composition of claim 1, wherein the mixed linked β-1,3/β-1,4 glucans (MLGs) is in the composition in an amount from about 0.1 mg/l to > 100 g/1.

6. A method for increasing a growth characteristic and/or increasing the nutrient efficiency of a plant or part thereof, the method comprising applying the composition of claim 1 to a plant or plant part thereof, or to the soil, hydroponic solution or growth media in which a target plant is growing.

7. (canceled)

8. The method of claim 6, wherein applying comprises contacting the plant with the composition at least two times.

9. The method of claim 6, wherein the composition further comprises a surfactant, a humectant, an adjuvant, an antioxidant, a preservative, a plant macronutrient, a plant micronutrient, a plant growth regulator, a plant biostimulant, a pesticide, a fungicide, an antiviral, an anti-bacterial, a herbicide, or any combination thereof.

10. The method of claim 6, wherein the mixed linked β-1,3/β-1,4 glucans (MLGs) is in the composition in an amount from about 0.1 mg/l to > 100 g/l.

11. The method of claim 6, wherein the increased growth characteristic is increased fruit production, increased inflorescence production, increased fruit quality, and/or an increased biomass as compared to a control plant or plant part thereof.

12. The method of claim 6, wherein the mixed linked β-1,3/β-1,4 glucans (MLGs) is in the composition in an amount from 0.5 mg/l to 5 g/l of the composition.

13. The method of claim 6, wherein said plant part is a seed.

14. A method for increasing abiotic stress tolerance and/or increasing disease tolerance/resistance of a plant or part thereof, the method comprising applying the composition of claim 1 to a plant or plant part thereof, or to the soil, hydroponic solution or growth media in which a target plant is growing.

15. (canceled)

16. The method of claim 14, wherein applying comprises contacting the plant with the composition at least two times.

17. The method of claim 14, wherein the composition further comprises a surfactant, a humectant, an adjuvant, an antioxidant, a stabilizer, a plant macronutrient, a plant micronutrient, a plant growth regulator, a plant biostimulant, a pesticide, a fungicide, an antiviral, an anti-bacterial, a herbicide, or any combination thereof.

18. The method of claim 14, wherein the mixed linked β-1,3/β-1,4 glucans (MLGs) is in the composition in an amount from about 0.1 mg/l to > 100 g/l.

19. The method of claim 14, wherein the disease to which the plant or part thereof has increased tolerance is a fungal disease, a bacterial disease, an insect disease and/or a viral disease.

20. The method of claim 14, wherein the abiotic stress is due to salinity, drought, flooding, freezing, cold temperature, and/or high temperature.

21. (canceled)

22. The method of claim 1, wherein the mixed linked β-1,3/β-1,4 glucans (MLGs) is in the composition in an amount from 0.5 mg/l to 5 g/l of the composition.

23. The method of claim 1, wherein the mixed linked β-1,3/β-1,4 glucans (MLGs) comprise a degree of polymerization from 2 to >100.
